(19) United States
(12) Patent Application Publication
(10) Pub. No.: US 2025/0173749 A1
(43) Pub. Date: May 29, 2025

(54) METHODS TO ESTIMATE FIELD-LEVEL CARBON, WATER AND NUTRIENT IMPLICATIONS FOR AGRICULTURE

(71) Applicant: The Board of Trustees of the University of Illinois, Urbana, IL (US)

(72) Inventors: Kaiyu Guan, Urbana, IL (US); Bin Peng, Urbana, IL (US); Chongya Jiang, Urbana, IL (US); Sheng Wang, Urbana, IL (US); Wang Zhou, Urbana, IL (US); Qu Zhou, Urbana, IL (US); Ziqi Qin, Champaign, IL (US)

(21) Appl. No.: 19/033,792

(22) Filed: Jan. 22, 2025

Related U.S. Application Data
(63) Continuation of application No. PCT/US2023/070696, filed on Jul. 21, 2023.
(60) Provisional application No. 63/369,198, filed on Jul. 22, 2022.

(51) Int. Cl. G06Q 30/0202; G06V 20/10

(52) U.S. Cl. CPC G06Q 30/0202; G06V 20/188

(57) ABSTRACT

A methodology is used to quantify implications and/or footprints of carbon, water, and/or nutrients of a particular crop in a region on a large scale and at field-level. A methodology is used to quantify, calculate, and/or visualize cover crop traits, tillage practices, and/or their outcomes at large scale. A methodology is used to accurately derive, estimate, and/or predict large-scale, long-term, and field-level cover crop adoption and biomass information using remote sensing time series.

### CROSS REFERENCE TO RELATED APPLICATIONS

This application is a Continuation Application of PCT Application No. PCT/US2023/070696, filed Jul. 21, 2023, which claims priority to provisional patent application U.S. Ser. No. 63/369,198 filed Jul. 22, 2022. The provisional patent application is herein incorporated by reference in its entirety, including without limitation, the specification, claims, and abstract, as well as any figures, tables, appendices, or drawings thereof.

### STATEMENT REGARDING FEDERALLY SPONSORED RESEARCH OR DEVELOPMENT

This invention was made with government support under DE-AR0001382 awarded by the Department of Energy. The government has certain rights in the invention.

### FIELD OF THE INVENTION

The invention relates generally to an apparatus, system, and/or corresponding method of use in at least the agricultural, environmental, and/or conservation industries. More particularly, but not exclusively, the invention relates to method(s) and/or corresponding apparatus(es) and/or system(s) to scalably quantify carbon, water, and/or nutrient implications and/or footprints for a particular crop in a large region at field level. Even more particularly, but not exclusively, the invention relates to a method(s) and/corresponding apparatus(es) and/or system(s) to quantify cover crop traits, tillage practices, and/or their outcomes on a large scale. Even more particularly, but not exclusively, the invention relates to a method(s) and/corresponding apparatus(es) and/or system(s) to determine and/or quantify cover crop adoption and/or cover crop biomass on a large scale.

### BACKGROUND OF THE INVENTION

As the world population grows, pollution increases, and resources become scarcer. Thus, it is important to be able to quantify particular characteristics of pollution and resource depletion. The agriculture industry is one of many industries that is a significant contributor to pollution and resource depletion. Therefore, it is important to be able to quantify, on a large-scale, implications and footprints related to carbon, water, and nutrients for particular agricultural crops and/or practices. It is also important to be able to quantify, on a large-scale, implications and footprints related to carbon, water, and nutrients on a large scale.

The most effective existing techniques in the agriculture industry to quantify characteristics such as these, including carbon footprint (greenhouse gas emissions and carbon sequestration), water footprint (crop water use and water use efficiency), and nitrogen footprint (e.g., nitrogen leaching, reactive nitrogen emission), involves using flux measurements which typically rely on eddy-covariance (EC), chamber flux sensors, or other technologies. One issue with existing techniques such as flux measurements is that the equipment used to make the measurements are usually fixed at a specific site and are costly to install and maintain. Additionally, existing flux measurement sites are sparsely distributed and are only available for a relatively small number of crop types and/or farming systems. Therefore, there is currently very little EC and/or flux data available beyond a few major crop types and crop regions.

Thus, there exists a need in the art for an apparatus, method, and/or system which has the ability to efficiently and cost-effectively quantify implications and/or footprints of carbon, water, and/or nutrients of a particular crop on a large scale, across an entire region, and at field-level.

Still further, conservation of resources is urgently needed in many global industries. The agricultural industry is a major area around the world in which conservation is paramount in protecting the earth and its resources. With a limited supply of land and soil globally, it is important that the agricultural community seeks to reduce and/or eliminate wasteful use of resources such as land, soil, and crops. Agricultural practices are a major contributor worldwide to pollution as well as resource consumption. Therefore, in order to maximize conservation efforts, it is important to be able to measure the effects that particular agricultural practices have on soil, crops, and/or the entire agroecosystem. Cover cropping is one approach in the agricultural industry that can improve conservation outcomes. The use of particular tillage practices is another approach in the agricultural industry that can improve conservation outcomes. Similar needs apply to other conservation practices, such as edge-of-field practices and in-field practices (such as grass waterway).

From a global perspective, it is important that the effects of agricultural practices can be monitored and measured on a large scale. Existing techniques used to estimate the outcomes and effects of conservation practices in the agricultural industry lack scientific accuracy and are difficult and expensive to implement, perform, and maintain.

Additionally, it will be helpful to the conservation movement if individuals in the agricultural industry, such as farmers, are able to easily predict and/or quantify outcomes that will result from the use of cover crops having particular traits and/or the use of particular tillage practices. Currently, there is not a quick and easy way for an individual, such as a farmer, to predict and/or quantify outcomes resulting from cover crop usage and/or tillage practices.

Thus, there exists a need in the art for an apparatus, method, and/or system which has the ability to quickly, effectively, efficiently, and cost-effectively quantify cover crop traits, tillage practices, and/or their outcomes on a large scale. These practices can include the use of particular cover crops and/or tillage practices. There also exists a need in the art for an apparatus, method, and/or system in which an individual, such as a farmer, can quickly and easily predict and/or quantify outcomes based on cover crops and/or tillage practices.

In order to conserve precious resources, many industries have engaged in conservation efforts in recent years. The agricultural industry in particular has made a push in recent years to improve conservation techniques. One such conservation practice is the use of cover crops. Cover crops are grown after harvest of cash crops to improve soil health, prevent soil erosion, reduce nitrogen leaching, and to suppress weeds and pests as well as providing other benefits. The use of cover crops is considered to be one solution to environmental issues within the modern row crop production system.

In order to accurately measure the beneficial environmental effects provided by cover cropping, it is important to be able to assess cover crop adoption and cover crop biomass. The practice of cover cropping has traditionally been assessed via field surveys. Field surveys are expensive and inefficient. Remote sensing is a technique that is more cost-effective and efficient than traditional field surveys. However, while remote sensing mapping of cover crop adoption exists, such an approach is in the early stages of development, and it has only been applied to limited areas and timescales. Additionally, existing remote sensing techniques related to assessing cover crop adoption lack accuracy. Thus, highly-accurate, large-scale, and long-term cover crop assessment, at the field-level and beyond, is needed in the agricultural industry. Such assessment will benefit farmers, commercial companies, researchers, and governments world-wide. Cover crop assessment can include measuring both cover crop adoption as well as cover crop biomass, which is highly correlated with cover crop growth.

Remote sensing is a technique that has been used to monitor cash crop growth and classify cash crop types. As mentioned above, existing remote sensing related to cover crops is very limited, lacks accuracy, and is in the early stages of development at large spatial and temporal scales. One reason for the limited and ineffective nature of existing remote sensing related to cover crop assessment is that remote sensing related to cover crop assessment poses difficulties including intermixed signals in remote sensing time series such as bare soil, crop residues, and cash crops. It is difficult to distinguish cover crop signals from soil signals, crop residue signals, and cash crop signals. For example, the soil background signal is dominant in the non-growing season and the cash crop signal is dominant in the peak growing season. Additionally, cover crop growth is affected by environmental factors such as temperature, precipitation, vapor pressure deficit (VPD), clay, sand, and soil organic carbon (SOC). These environmental factors also contribute to the difficulty of cover crop assessment via remote sensing. Furthermore, cover crop signals vary dynamically at large spatial and temporal scales, which also contributes to the difficulty of cover crop assessment at field-level.

Thus, there exists a need in the art for an apparatus, method, and/or system that has the ability to accurately, cost-effectively, and efficiently assess cover crop adoption and/or biomass on a large scale, over a long term, and at field-level. There also exists a need in the art for an apparatus, method, and/or system wherein a cover crop signal can be extracted and/or distinguished from other signals in a remote sensing time in order to accurately assess cover crop adoption and/or cover crop biomass.

### SUMMARY OF THE INVENTION

The following objects, features, advantages, aspects, and/or embodiments, are not exhaustive and do not limit the overall disclosure. No single embodiment needs to provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of the disclosure to provide a system, method, and/or apparatus for quantifying implications and/or footprints of carbon, water, and/or nutrients of a particular crop in a region on a large scale.

It is a further object, feature, and/or advantage of the disclosure to quantify implications and/or footprints of carbon, water, and/or nutrients of a particular crop and/or utilization of a particular farming practice in a region on a large scale in an efficient, effective, speedy, and cost-effective manner.

It is a further object, feature, and/or advantage of the disclosure to quantify implications and/or footprints of carbon, water, and/or nutrients of a particular crop in a region on a large scale and at field-level.

It is a further object, feature, and/or advantage of the disclosure to develop one or more models to quantify implications and/or footprints of carbon, water, and/or nutrients of a particular crop in a region.

It is a further object, feature, and/or advantage of the disclosure to provide a model-data fusion framework to quantify carbon, water, and/or nutrient outcomes at field-level for each individual targeted field within a region.

It is a further object, feature, and/or advantage of the disclosure to provide life-cycle analysis techniques and/or tools to quantify carbon, water, and/or nutrient outcomes at field-level for each individual targeted field within a region throughout an entire supply chain.

It is a further object, feature, and/or advantage of the disclosure to provide a cyberinfrastructure capable of performing a method for quantifying implications and/or footprints of carbon, water, and/or nutrients of a particular crop in a region on a large scale and at field-level.

It is a further object, feature, and/or advantage of the disclosure to enable hypothetical scenario assessment of the impacts of different field management practices and/or climate change scenarios on crop production and/or environmental sustainability.

It is still yet a further object, feature, and/or advantage of the disclosure to be able to up-scale the one or more models to be applied to a selection of or all agricultural fields within a region.

The apparatus(es), method(s), and/or system(s) disclosed herein can be used in a wide variety of applications. For example, the methods disclosed herein can be used with any variety of crops and can be used in any region worldwide. Further, methods disclosed herein are adaptable to be able to quantify implications and/or footprints of carbon, water, and/or nutrients of a single agricultural field, a selection of agricultural fields, and/or all agricultural fields within a particular region at field-level.

It is preferred the apparatus(es), method(s), and/or system(s) be safe, effective, cost-effective, efficient, and speedy. For example, a major object, feature, and/or advantage of the disclosure is the ability to up-scale it and apply its modeling capabilities to many agricultural fields in an effective, efficient, cost-effective, and speedy manner.

Methods can be practiced which facilitate use, manufacture, assembly, maintenance, and repair of the cyberinfrastructure which accomplish some or all of the previously stated objectives.

The apparatus(es), method(s), and/or system(s) disclosed herein can be incorporated into larger apparatus(es), method(s), system(s) and/or design(s) which accomplish some or all of the previously stated objectives.

According to at least some of the embodiments and/or aspects disclosed herein, methodology is used to quantify implications and/or footprints of carbon, water, and/or nutrients of a particular crop in a region on a large scale and at field-level. The methodology can include collecting data using a variety of approaches including ground sampling, remote sensing via airborne vehicles, and/or satellite sensing. The methodology can further include developing one or more models based on the collected data. The methodology can further include fusing model data to quantify implications and/or footprints of carbon, water, and/or nutrients of a particular crop in a region on a large scale and at field-level. The methodology can also include performing life cycle analysis to quantify implications and/or footprints of carbon, water, and/or nutrients of a particular crop in a region on a large scale and at field-level throughout an entire supply chain.

According to some aspects of the present disclosure, a method to scalably quantify one or more carbon, water, and/or nutrient outcomes of a crop and/or of utilization of a farming practice in a region of interest at field-level, comprises collecting ground truth data of a ground sampling portion of target fields within the region of interest; collecting intermediate remotely sensed data related to a remote sensing portion of the target fields wherein the remote sensing portion includes at least a fraction of the ground sampling portion and other portion(s) of the target fields of a region of interest not included in the ground sampling portion; collecting satellite data related to any and/or all of the target fields within the region of interest; developing one or more models by linking the ground truth data, intermediate remotely sensed data, and satellite data; quantifying carbon, water, and/or nutrient outcome(s) for at least a portion of the target fields on a field-level basis using the one or more models.

According to at least some aspects of some embodiments disclosed herein, the one or more models quantify the carbon, water, and/or nutrient outcome(s) using the ground truth data, intermediate remotely sensed data, and/or satellite data as inputs.

According to at least some aspects of some embodiments disclosed herein, the farming practice is use of a conservation practice.

According to at least some aspects of some embodiments disclosed herein, the conservation practice is cover cropping, no-till practices, and/or reduced tillage practices.

According to at least some aspects of some embodiments disclosed herein, quantifying the carbon, water, and/or nutrient outcome(s) further comprises applying the one or more models to any and/or all of the target fields within the region of interest.

According to at least some aspects of some embodiments disclosed herein, quantifying the carbon, water, and/or nutrient outcome(s) further comprises using model-data fusion to quantify the carbon, water, and/or nutrient outcome(s) for each individual field of the target fields.

According to at least some aspects of some embodiments disclosed herein, the method further comprises designing sampling strategies to determine a region of interest, target fields, the ground sampling portion, and/or the remote sensing portion.

According to at least some aspects of some embodiments disclosed herein, the method further comprises designing sampling strategies to determine a time of year and/or a duration of time in which the collection of ground truth data, the collection of intermediate remotely sensed data, and/or the collection of satellite data is conducted.

According to at least some aspects of some embodiments disclosed herein, designing sampling strategies is based on environmental factors including climate factors and soil types, locations, remote sensing data, crop varieties, and/or farming management practices.

According to at least some aspects of some embodiments disclosed herein, the one or more carbon, water, and/or nutrient outcomes includes carbon implications and/or footprints, water implications and/or footprints, and/or nutrient implications and/or footprints.

According to at least some aspects of some embodiments disclosed herein, collecting ground truth data further comprises ground sampling.

According to at least some aspects of some embodiments disclosed herein, the ground truth data is collected using mobile flux measurements.

According to at least some aspects of some embodiments disclosed herein, the ground truth data can be collected via eddy-covariance (EC) flux towers, chamber flux sensors, ground cameras, ground sensors, vehicular cameras, Internet of Things (IoT) sensors, and/or soil samples.

According to at least some aspects of some embodiments disclosed herein, collecting intermediate remotely sensed data comprises the use of sensing systems on aircraft, vehicle systems, drones, helicopters, and/or satellite sensors.

According to at least some aspects of some embodiments disclosed herein, collecting satellite data comprises using satellite(s) to collect multi-source data including optical, thermal, and/or microwave data.

According to at least some aspects of some embodiments disclosed herein, developing the one or more models comprises developing one or more mobile system data based models by overlapping the ground truth data and the remotely sensed data such that the one or more mobile system data based models uses the remotely sensed data as model inputs and uses the ground truth data for labeling.

According to at least some aspects of some embodiments disclosed herein, developing the one or more models further comprises applying the one or more mobile system data based models to all the intermediate remotely sensed data and/or remotely sensed data to produce quasi-ground truth data.

According to at least some aspects of some embodiments disclosed herein, developing the one or more models further comprises developing one or more satellite data based models by overlapping the satellite data and the quasi-ground truth data such that the one or more satellite based models uses the satellite data as inputs and quasi-ground truth data for labeling.

According to at least some aspects of some embodiments disclosed herein, developing the one or more models further comprises applying the satellite data based models to all the satellite data to obtain large-scale quantification of carbon, water, and/or nutrient outcomes for the entire region of interest.

According to at least some aspects of some embodiments disclosed herein, the carbon, water, and/or nutrient outcome(s) for each individual field are quantified at field-level.

According to at least some aspects of some embodiments disclosed herein, using model-data fusion includes the use of statistical regression or classification, artificial neural networks, and/or threshold-based models with manually set parameters.

According to at least some aspects of some embodiments disclosed herein, the method further comprises using life-cycle analysis tools to holistically quantify the carbon, water, and/or nutrient outcome(s) for each individual field throughout an entire supply chain.

According to at least some aspects of some embodiments disclosed herein, the use of life-cycle analysis includes the use of statistical regression or classification, artificial neural networks, and/or threshold-based models with manually set parameters.

According to at least some aspects of some embodiments disclosed herein, the method is applied to row crops, specialty crops, and/or pastureland.

According to at least some aspects of some embodiments disclosed herein, the satellite data is synthesized from multiple satellite data sources, wherein spatial and/or temporal gaps in a dataset are filled and/or inferred using a multi-sensor satellite data fusion model.

According to at least some aspects of some embodiments disclosed herein, the spatial and/or temporal gaps are due to cloud obstruction, instrumental failure, and/or lack of flyover.

According to at least some aspects of some embodiments disclosed herein, a method of training a model for quantifying one or more carbon, water, and/or nutrient outcomes of a crop type in a region of interest at field-level, comprises collecting ground truth data of a ground sampling portion of target fields within the region of interest; collecting remotely sensed data related to a remote sensing portion of the target fields wherein the remote sensing portion includes at least a fraction of the ground sampling portion and other portion(s) of the target fields of a region of interest not included in the ground sampling portion; collecting satellite data related to any and/or all of the target fields within the region of interest; developing one or more models by linking ground truth data, remotely sensed data, and satellite data.

According to at least some aspects of some embodiments disclosed herein, a method of applying one or more trained models to quantify one or more carbon, water, and/or nutrient outcomes of a crop type in a region of interest at field-level, comprises quantifying carbon, water, and/or nutrient outcome(s) for at least a portion of a set of target fields within the region of interest on a field-level basis using the one or more trained models; wherein the one or more trained models are trained using steps comprising: collecting ground truth data of a ground sampling portion of target fields within the region of interest; collecting remotely sensed data related to a remote sensing portion of the target fields wherein the remote sensing portion includes at least a fraction of the ground sampling portion and other portion(s) of the target fields of a region of interest not included in the ground sampling portion; collecting satellite data related to all of the target fields within the region of interest; and developing one or more models by linking ground truth data, remotely sensed data, and satellite data.

According to at least some aspects of some embodiments disclosed herein, a device for quantifying one or more carbon, water, and/or nutrient outcomes of a crop type in a region of interest at field-level, comprises a processing system; a memory unit and/or non-transitory computer-readable medium that stores executable instructions that, when executed by the processing system, perform operations, the operations comprising: collecting ground truth data of a ground sampling portion of target fields within the region of interest; collecting remotely sensed data related to a remote sensing portion of the target fields wherein the remote sensing portion includes at least a fraction of the ground sampling portion and other portion(s) of the target fields of a region of interest not included in the ground sampling portion; collecting satellite data related to all of the target fields within the region of interest; developing one or more models by linking ground truth data, remotely sensed data, and satellite data; and quantifying carbon, water, and/or nutrient outcome(s) for at least a portion of the target fields on a field-level basis using the one or more models.

According to at least some aspects of some embodiments disclosed herein, the device further comprises a pipeline for a model-data fusion (MDF) framework and/or life-cycle analysis (LCA) wherein the pipeline can operate as a one-stop solution to perform a workflow related to MDF and/or LCA.

According to at least some aspects of some embodiments disclosed herein, the device further comprises a database wherein the database is adapted to be able to store and/or archive data or information and/or data related to, obtained via, and/or generated via ground sampling, remote sensing, and/or satellite sensing; input data of the MDF framework; output of the MDF framework; outcomes; and/or environmental factors.

According to at least some aspects of some embodiments disclosed herein, the stored and/or archived data can be used by the device to help quantify the carbon, water, and/or nutrient outcome(s) for each individual field of the target fields.

According to at least some aspects of some embodiments disclosed herein, the device further comprises a visualization portal wherein the visualization portal is adapted to allow a user to enter inputs and/or is adapted to communicate inputs and/or outputs to a user.

According to at least some aspects of some embodiments disclosed herein, the inputs include identifying information of the user and/or the user's organization and/or company, ROI location and/or name, location and/or name(s) of targeted field(s) within the ROI, observation data with and/or without corresponding GPS information, ground sampling data with and/or without corresponding GPS information, remote sensing data with and/or without corresponding GPS information, satellite sensing data with and/or without corresponding GPS information, and/or information related to carbon, water, and/or nutrient outcomes with and/or without corresponding GPS information.

According to at least some aspects of some embodiments disclosed herein, the outputs include intermediate results, final results, and/or the carbon, water, and/or nutrient outcome(s) for each individual field of the target fields.

According to at least some aspects of some embodiments disclosed herein, the carbon, water, and/or nutrient outcome(s) for each individual field of the target fields are based on the inputs.

According to at least some aspects of some embodiments disclosed herein, the satellite data is synthesized from multiple satellite data sources, wherein spatial and/or temporal gaps in a dataset are filled and/or inferred using a multi-sensor satellite data fusion method.

According to at least some aspects of some embodiments disclosed herein, the spatial and/or temporal gaps are due to cloud obstruction, instrumental failure, and/or lack of flyover.

According to at least some aspects of some embodiments disclosed herein, a non-transitory computer-readable medium comprising executable instructions that, when executed, perform operations, the operations comprises collecting ground truth data of a ground sampling portion of target fields within the region of interest; collecting remotely sensed data related to a remote sensing portion of the target fields wherein the remote sensing portion includes at least a fraction of the ground sampling portion and other portion(s) of the target fields of a region of interest not included in the ground sampling portion; collecting satellite data related to all of the target fields within the region of interest; developing one or more models by linking ground truth data, remotely sensed data, and satellite data; and quantifying carbon, water, and/or nutrient outcome(s) for at least a portion of the target fields on a field-level basis using the one or more models

It is a further object, feature, and/or advantage of the disclosure to provide a system, method, and/or apparatus to quantify cover crop traits, tillage practices, and/or their outcomes.

It is a further object, feature, and/or advantage of the disclosure to quantify cover crop traits, tillage practices, and/or their outcomes on a large scale in an efficient, effective, speedy, and cost-effective manner.

It is a further object, feature, and/or advantage of the disclosure to quantify cover crop traits, tillage practices, and their outcomes at large scale and in an efficient, effective, speedy, and cost-effective manner.

It is a further object, feature, and/or advantage of the disclosure to develop one or more models to quantify cover crop traits, tillage practices, and/or their outcomes.

It is a further object, feature, and/or advantage of the disclosure to provide data collection techniques for various agricultural, management, and/or conservation techniques.

It is a further object, feature, and/or advantage of the disclosure to efficiently monitor, measure, and/or evaluate cover crop traits, tillage practices, and/or their outcomes.

It is a further object, feature, and/or advantage of the disclosure to provide monitoring and/or verification of agricultural, management, and/or conservation practice adoption.

It is a further object, feature, and/or advantage of the disclosure to provide a cyberinfrastructure capable of performing a method for quantifying cover crop traits, tillage practices, and/or their outcomes.

It is a further object, feature, and/or advantage of the disclosure to provide a user the ability to quickly and easily quantify cover crop traits, tillage practices, and their outcomes at large scale and in an on-the-fly manner.

It is still yet a further object, feature, and/or advantage of the disclosure to be able to up-scale the one or more models to be applied to a selection of and/or all agricultural fields within an agricultural region on a large scale.

The apparatus(es), method(s), and/or system(s) disclosed herein can be used in a wide variety of applications. For example, the methods can be used with any variety of crops and can be used in any region worldwide. Further, the methods are adaptable to be able to quantify cover crop traits, tillage practices, and/or their outcomes as applied to a single agricultural field, a selection of agricultural fields, and/or all agricultural fields within a particular region.

It is preferred the apparatus(es), method(s), and/or system(s) be safe, effective, cost-effective, efficient, and speedy.

Methods can be practiced which facilitate use, manufacture, assembly, maintenance, and repair of the cyberinfrastructure which accomplish some or all of the previously stated objectives.

The apparatus(es), method(s), and/or system(s) disclosed herein can be incorporated into larger apparatus(es), method(s), system(s) and/or design(s) which accomplish some or all of the previously stated objectives.

Additionally, another major object, feature, and/or advantage of the disclosure is to provide the ability for a user, such as a farmer, to quickly and easily apply the methods described herein in an on-the-fly manner.

According to at least some aspects and/or embodiments of the present disclosure, a methodology is used to quantify, calculate, and/or visualize cover crop traits, tillage practices, and/or their outcomes at large scale. The methodology can include obtaining image and/or video data of an agricultural field via multiple sources such as ground sampling, airborne vehicular remote sensing, and/or satellite sensing. The methodology can further include processing the image and/or video data to estimate cover crop traits and/or tillage practices using computer vision and/or other means. The methodology can further include developing and/or applying one or more models to quantify, calculate, and/or visualize outcomes. The methodology can further include providing a software application and/or cyberinfrastructure wherein a user can quickly and easily apply the methodology described herein in an on-the-fly manner to quantify, calculate, and/or visualize cover crop traits, tillage practices, and/or their outcomes at large scale.

According to at least some aspects of some embodiments disclosed herein, a method to calculate and/or visualize one or more outcomes associated with an agricultural field and/or region, comprises capturing field imagery of an agricultural field; processing the field imagery to produce processed field imagery; estimating one or more intermediate attributes via the processed field imagery; and calculating, quantifying, and/or visualizing one or more outcomes based on the one or more intermediate attributes.

According to at least some aspects of some embodiments disclosed herein, the field imagery is one or more images and/or one or more videos.

According to at least some aspects of some embodiments disclosed herein, the field imagery is geographically tagged.

According to at least some aspects of some embodiments disclosed herein, a device is used to capture the field imagery, and further wherein the device comprises a handheld camera, a camera included as part of a smart device such as a smartphone camera, an Internet-of-Things (IoT) camera, an in-situ installed camera, an optical sensor, a camera housed within and/or attached to a vehicle, a drone, an airplane, a helicopter, and/or a satellite.

According to at least some aspects of some embodiments disclosed herein, the device used to capture the field imagery is tilted.

According to at least some aspects of some embodiments disclosed herein, processing the field imagery includes the use of CropEyes, computer vision, artificial intelligence, machine learning, deep learning, empirically estimated relationships, and/or any combination thereof.

According to at least some aspects of some embodiments disclosed herein, processing the field imagery further includes deriving crop residue fraction.

According to at least some aspects of some embodiments disclosed herein, deriving the crop residue fraction comprises using a segmentation algorithm to partition pixels of the field imagery into superpixels; calculating mean red, green, and blue (RGB) values of each superpixel; and/or selecting a boundary threshold to separate the mean RGB values of background and foreground superpixels.

According to at least some aspects of some embodiments disclosed herein, processing the field imagery further includes estimating intermediate attributes.

According to at least some aspects of some embodiments disclosed herein, the intermediate attributes comprise cover crop traits and/or tillage conditions.

According to at least some aspects of some embodiments disclosed herein, the cover crop traits comprise cover crop biomass, cover crop height, cover crop density, and/or cover crop leaf-area-index.

According to at least some aspects of some embodiments disclosed herein, the tillage conditions comprise crop residue coverage and/or crop tillage types.

According to at least some aspects of some embodiments disclosed herein, calculating, quantifying, and/or visualizing one or more outcomes comprises using a process-based model, a machine learning model, and/or a combination thereof.

According to at least some aspects of some embodiments disclosed herein, calculating, quantifying, and/or visualizing the one or more outcomes comprises accounting for environmental factors and/or agricultural, management, and/or conservation practices.

According to at least some aspects of some embodiments disclosed herein, the environmental factors and/or agricultural, management, and/or conservation practices comprise cover crop types, cover crop growth period, weather information, soil conditions, and/or a combination thereof.

According to at least some aspects of some embodiments disclosed herein, the outcomes comprise soil outcomes, crop outcomes, and/or agroecosystem outcomes.

According to at least some aspects of some embodiments disclosed herein, the outcomes comprise soil carbon sequestration based on a particular cover crop or tillage condition, nitrogen uptake by a cover crop, nutrient loss reduction, cash crop yield, and/or other attributes related to carbon, nutrient, and/or water variables.

According to at least some aspects of some embodiments disclosed herein, a method of training a model to calculate, quantify, and/or visualize one or more outcomes associated with an agricultural field and/or region, comprises capturing field imagery of an agricultural field and/or region; processing the field imagery to estimate one or more attributes; generating a model to develop a relationship between the one or more attributes and the one or more outcomes.

According to at least some aspects of some embodiments disclosed herein, the model is a process-based model and/or an empirical, statistical, and/or machine learning model.

According to at least some aspects of some embodiments disclosed herein, the one or more attributes comprises cover crop attributes and/or tillage attributes.

According to at least some aspects of some embodiments disclosed herein, the cover crop attributes comprise cover crop biomass, cover crop height, cover crop density, and/or cover crop leaf-area-index.

According to at least some aspects of some embodiments disclosed herein, the tillage attributes comprise tillage intensity and/or tillage time.

According to at least some aspects of some embodiments disclosed herein, the method further comprises inputting variables into the model that affect the relationship between the one or more attributes and the one or more outcomes.

According to at least some aspects of some embodiments disclosed herein, the variables comprise, soil properties, weather data, and/or agricultural, management, and/or conservation practices.

According to at least some aspects of some embodiments disclosed herein, the method further comprises validating the model.

According to at least some aspects of some embodiments disclosed herein, validating the model comprises simulating outcomes based on the variables.

According to at least some aspects of some embodiments disclosed herein, validating the model comprises using the cover crop attributes by calibrating cover crop plant function types.

According to at least some aspects of some embodiments disclosed herein, cover crop plant function types comprise maturity group and/or photosynthetic capacity.

According to at least some aspects of some embodiments disclosed herein, the method further comprises comparing the model and/or aspects thereof with a baseline scenario.

According to at least some aspects of some embodiments disclosed herein, comparing the model and/or aspects thereof with a baseline scenario comprises using the calibrated cover crop plant function types.

According to at least some aspects of some embodiments disclosed herein, the method further comprises using a machine learning model.

According to at least some aspects of some embodiments disclosed herein, environmental factors and/or agricultural, management, and/or conservation practices are input into the machine learning model.

According to at least some aspects of some embodiments disclosed herein, the environmental factors and/or agricultural, management, and/or conservation practices comprise cover crop types, cover crop biomass, cover crop growth period, tillage intensity, tillage time, weather information, soil conditions, and/or a combination thereof.

According to at least some aspects of some embodiments disclosed herein, the machine learning model is validated using the one or more attributes and/or the model.

According to at least some aspects of some embodiments disclosed herein, using the one or more attributes and/or the model includes using simulations performed by the model on the one or more attributes in different locations, with various soil conditions, with various weather conditions, and/or with various agricultural, management, and/or conservation practices.

According to at least some aspects of some embodiments disclosed herein, the method further comprises assessing outcomes based on the one or more attributes, the model, the machine learning model, and/or a combination thereof to calculate, quantify, and/or visualize outcomes.

According to at least some aspects of some embodiments disclosed herein, the outcomes comprise soil organic carbon, soil carbon content, soil nutrient content, soil carbon sequestration, nitrogen uptake by cover crop, nutrient loss reduction at a field, cash crop yield, soil organic carbon vertical distribution and/or dynamics, soil erosion, nitrogen leaching, and/or phosphorous leaching.

According to at least some aspects of some embodiments disclosed herein, a method of training a model to calculate, quantify, and/or visualize one or more outcomes associated an agricultural field and/or region, comprises capturing field imagery of an agricultural field and/or region; processing the field imagery to estimate one or more attributes; inputting the one/or more attributes into a model; and using the model to build a relationship between the one or more attributes and the one or more outcomes.

According to at least some aspects of some embodiments disclosed herein, the model is a process-based model and/or an empirical, statistical, and/or machine learning model.

According to at least some aspects of some embodiments disclosed herein, the one or more attributes comprises cover crop attributes and/or tillage attributes.

According to at least some aspects of some embodiments disclosed herein, the cover crop attributes comprise cover crop biomass, cover crop height, cover crop density, and/or cover crop leaf-area-index.

According to at least some aspects of some embodiments disclosed herein, the tillage attributes comprise tillage intensity and/or tillage time.

According to at least some aspects of some embodiments disclosed herein, the method further comprises using a machine learning model.

According to at least some aspects of some embodiments disclosed herein, environmental factors and/or agricultural, management, and/or conservation practices are input into the machine learning model.

According to at least some aspects of some embodiments disclosed herein, the environmental factors and/or agricultural, management, and/or conservation practices comprise cover crop types, cover crop biomass, cover crop growth period, tillage intensity, tillage time, weather information, soil conditions, and/or a combination thereof.

According to at least some aspects of some embodiments disclosed herein, the relationship between the one or more attributes and the one or more outcomes is improved based on the environmental factors and/or agricultural, management, and/or conservation practices being input into the machine learning model.

According to at least some aspects of some embodiments disclosed herein, the machine learning model is validated using the one or more attributes and/or the model.

According to at least some aspects of some embodiments disclosed herein, the method further comprises calculating, quantifying, and/or visualizing the one or more outcomes based on one or more attributes, the model, the machine learning model, and/or a combination thereof.

According to at least some aspects of some embodiments disclosed herein, the one or more outcomes comprise soil organic carbon, soil carbon content, soil nutrient content, soil carbon sequestration, nitrogen uptake by cover crop, nutrient loss reduction at a field, cash crop yield, soil organic carbon vertical distribution and/or dynamics, soil erosion, nitrogen leaching, and/or phosphorous leaching.

According to at least some aspects of some embodiments disclosed herein, a method of applying one or more trained models for quantifying and/or visualizing one or more soil, crop, and/or agroecosystem outcomes, comprises calculating, quantifying, and/or visualizing one or more outcomes based on the one or more trained models; wherein the one or more trained models are trained using steps comprising: capturing field imagery of an agricultural field and/or region; processing the field imagery to estimate one or more attributes; generating a model to develop a relationship between the one or more attributes and the one or more outcomes.

According to at least some aspects of some embodiments disclosed herein, a method of applying one or more trained models for quantifying and/or visualizing one or more soil, crop, and/or agroecosystem outcomes, comprising calculating, quantifying, and/or visualizing one or more outcomes based on the one or more trained models; wherein the one or more trained models are trained using steps comprising: capturing field imagery of an agricultural field and/or region; processing the field imagery to estimate one or more attributes; inputting the one/or more attributes into a model; and using the model to build a relationship between the one or more attributes and the one or more outcomes.

According to at least some aspects of some embodiments disclosed herein, a device for quantifying and/or visualizing one or more soil, crop, and/or agroecosystem outcomes, comprises a processing system; a memory unit and/or non-transitory computer-readable medium that stores executable instructions that, when executed by the processing system, perform operations, the operations comprising: capturing field imagery of an agricultural field; processing the field imagery to produce processed field imagery; estimating one or more intermediate attributes via the processed field imagery; and calculating, quantifying, and/or visualizing one or more outcomes based on the one or more intermediate attributes.

According to at least some aspects of some embodiments disclosed herein, the device further comprising a database wherein the database is adapted to be able to store and/or archive data or information related to, obtained via, and/or generated via captured images(s) and/or video(s); soil, crop, and/or agroecosystem outcomes; environmental factors; and/or agricultural, management, and/or conservation practices.

According to at least some aspects of some embodiments disclosed herein, the stored and/or archived data can be used by the device to help calculate, quantify, and/or visualize the one or more outcomes.

According to at least some aspects of some embodiments disclosed herein, the device further comprises a visualization portal wherein the visualization portal is adapted to allow a user to enter inputs and/or is adapted to communicate inputs and/or outputs to a user.

According to at least some aspects of some embodiments disclosed herein, the inputs include identifying information of the user and/or the user's organization and/or company, location and/or name of an agricultural field, observational data with and/or without corresponding GPS information, captured image(s) and/or video(s) of an agricultural field with and/or without corresponding GPS information, and/or information related to soil, crop, and/or agroecosystem outcomes with and/or without corresponding GPS information.

According to at least some aspects of some embodiments disclosed herein, the outputs include intermediate results, final results, and/or the one or more outcomes.

According to at least some aspects of some embodiments disclosed herein, the one or more outcomes are soil, crop, and/or agroecosystem outcomes.

According to at least some aspects of some embodiments disclosed herein, the one or more outcomes are based on the inputs.

According to at least some aspects of some embodiments disclosed herein, a non-transitory computer-readable medium comprising executable instructions that, when executed, perform operations, the operations comprises capturing field imagery of an agricultural field; processing the field imagery to produce processed field imagery; estimating one or more intermediate attributes via the processed field imagery; and calculating, quantifying, and/or visualizing one or more outcomes based on the one or more intermediate attributes.

According to at least some aspects of at least some embodiments disclosed herein, a method to calculate, quantify, and/or visualize one or more outcomes and/or predicted outcomes associated with an agricultural field, rangeland, or pastureland, comprises capturing field imagery using a mobile device; processing the field imagery to produce processed field imagery; and calculating, quantifying, and/or visualizing one or more outcomes and/or predicted outcomes based on the processed field imagery.

According to at least some aspects of at least some embodiments disclosed herein, the outcomes and/or predicted outcomes include sustainability metrics.

According to at least some aspects of at least some embodiments disclosed herein, the sustainability metrics comprise information related to greenhouse gas emissions, soil carbon sequestration, water use, and/or resource use efficiency.

According to at least some aspects of at least some embodiments disclosed herein, the outcomes and/or predicted outcomes include economic metrics.

According to at least some aspects of at least some embodiments disclosed herein, wherein the economic metrics comprise projected revenue from crop(s) and/or livestock.

According to at least some aspects of at least some embodiments disclosed herein, the economic metrics comprise projected revenue or compensation from ecosystem service market(s), such as carbon credit market(s).

According to at least some aspects of at least some embodiments disclosed herein, the economic metrics comprise a market-driven premium, such as gains from sustainable labeling.

According to at least some aspects of at least some embodiments disclosed herein, the calculating, quantifying, and/or visualizing one or more outcomes and/or predicted outcomes comprises using a process-based model.

According to at least some aspects of at least some embodiments disclosed herein, the calculating, quantifying, and/or visualizing one or more outcomes and/or predicted outcomes comprises using a statistical or machine learning model.

According to at least some aspects of at least some embodiments disclosed herein, the calculating, quantifying, and/or visualizing one or more outcomes and/or predicted outcomes is based on a model that has been optimized based on field image data.

According to at least some aspects of at least some embodiments disclosed herein, the mobile device used to capture the field imagery comprises a handheld camera, a camera included as part of a smart device such as a smartphone camera, an Internet-of-Things (IoT) camera, an optical sensor, a sport camera, and/or a camera housed within and/or attached to a vehicle.

According to at least some aspects of at least some embodiments disclosed herein, a device for calculating, quantifying, and/or visualizing one or more soil, crop, and/or agroecosystem outcomes and/or predicted outcomes, comprises a processing system; a memory unit and/or non-transitory computer-readable medium that stores executable instructions that, when executed by the processing system, perform operations, the operations comprising: obtaining field imagery captured using a mobile device; processing the field imagery to produce processed field imagery; and calculating, quantifying, and/or visualizing one or more outcomes and/or predicted outcomes based on the processed field imagery.

According to at least some aspects of at least some embodiments disclosed herein, the outcomes and/or predicted outcomes include sustainability metrics.

According to at least some aspects of at least some embodiments disclosed herein, the sustainability metrics comprise information related to greenhouse gas emissions, soil carbon sequestration, water use, and/or resource use efficiency.

According to at least some aspects of at least some embodiments disclosed herein, the outcomes and/or predicted outcomes include economic metrics.

According to at least some aspects of at least some embodiments disclosed herein, the economic metrics comprise projected revenue from crop(s) and/or livestock.

According to at least some aspects of at least some embodiments disclosed herein, the economic metrics comprise projected revenue or compensation from ecosystem service market(s), such as carbon credit market(s).

According to at least some aspects of at least some embodiments disclosed herein, the economic metrics comprise a market-driven premium, such as gains from sustainable labeling.

According to at least some aspects of at least some embodiments disclosed herein, the calculating, quantifying, and/or visualizing one or more outcomes and/or predicted outcomes comprises using a process-based model.

According to at least some aspects of at least some embodiments disclosed herein, the calculating, quantifying, and/or visualizing one or more outcomes and/or predicted outcomes comprises using a statistical or machine learning model.

According to at least some aspects of at least some embodiments disclosed herein, the calculating, quantifying, and/or visualizing one or more outcomes and/or predicted outcomes is based on a model that has been optimized based on field image data.

According to at least some aspects of at least some embodiments disclosed herein, the mobile device used to capture the field imagery comprises a handheld camera, a camera included as part of a smart device such as a smartphone camera, an Internet-of-Things (IoT) camera, an optical sensor, a sport camera, and/or a camera housed within and/or attached to a vehicle.

According to at least some aspects of at least some embodiments disclosed herein, a non-transitory computer readable medium comprising executable instructions that, when executed, perform operations, the operations comprise obtaining field imagery captured using a mobile device; processing the field imagery to produce processed field imagery; and calculating, quantifying, and/or visualizing one or more outcomes and/or predicted outcomes based on the processed field imagery.

According to at least some aspects of at least some embodiments disclosed herein, the outcomes and/or predicted outcomes include sustainability metrics.

According to at least some aspects of at least some embodiments disclosed herein, the sustainability metrics comprise information related to greenhouse gas emissions, soil carbon sequestration, water use, and/or resource use efficiency.

According to at least some aspects of at least some embodiments disclosed herein, the outcomes and/or predicted outcomes include economic metrics.

According to at least some aspects of at least some embodiments disclosed herein, the economic metrics comprise projected revenue from crop(s) and/or livestock.

According to at least some aspects of at least some embodiments disclosed herein, the economic metrics comprise projected revenue or compensation from ecosystem service market(s), such as carbon credit market(s).

According to at least some aspects of at least some embodiments disclosed herein, the economic metrics comprise a market-driven premium, such as gains from sustainable labeling.

According to at least some aspects of at least some embodiments disclosed herein, the calculating, quantifying, and/or visualizing one or more outcomes and/or predicted outcomes comprises using a process-based model.

According to at least some aspects of at least some embodiments disclosed herein, the calculating, quantifying, and/or visualizing one or more outcomes and/or predicted outcomes comprises using a statistical or machine learning model.

According to at least some aspects of at least some embodiments disclosed herein, the calculating, quantifying, and/or visualizing one or more outcomes and/or predicted outcomes is based on a model that has been optimized based on field image data.

According to at least some aspects of at least some embodiments disclosed herein, the mobile device used to capture the field imagery comprises a handheld camera, a camera included as part of a smart device such as a smartphone camera, an Internet-of-Things (IoT) camera, an optical sensor, a sport camera, and/or a camera housed within and/or attached to a vehicle.

It is a further object, feature, and/or advantage of the disclosure to provide a system, method, and/or apparatus for assessing cover crop adoption and/or cover crop biomass.

It is a further object, feature, and/or advantage of the disclosure to provide a system, method, and/or apparatus for assessing cover crop adoption and/or cover crop biomass accurately, cost-effectively, and efficiently.

It is a further object, feature, and/or advantage of the disclosure to provide a system, method, and/or apparatus for assessing cover crop adoption and/or cover crop biomass on a large scale, over a long time period, and at field-level.

It is a further object, feature, and/or advantage of the disclosure to provide a system, method, and/or apparatus for assessing cover crop adoption and/or cover crop biomass via remote sensing time series.

It is a further object, feature, and/or advantage of the disclosure to provide monitoring and verification of cover crop adoption and/or cover crop biomass.

It is a further object, feature, and/or advantage of the disclosure to develop one or more models for assessing cover crop adoption and/or cover crop biomass.

It is a further object, feature, and/or advantage of the disclosure to provide the ability to distinguish between soil signal(s), main/cash crop signal(s), and cover crop signal(s) in a remote sensing time series such that the cover crop signal(s) can be extracted and/or isolated such that the cover crop signal(s) can be used to accurately measure and/or quantify cover crop adoption and/or cover crop biomass.

It is still yet a further object, feature, and/or advantage of the disclosure to be able to up-scale the one or more models to be applied on a large scale including pixel-level, field-level, county-level, state-level, and/or nation-level.

The apparatus(es), method(s), and/or system(s) disclosed herein can be used in a wide variety of applications. For example, the methods can be used with different varieties of cover crops and can be used in any region worldwide. Further, the disclosed apparatus(es), method(s), and/or system(s) are adaptable to be able to assess cover crop adoption and/or cover crop biomass of a single agricultural field, a selection of agricultural fields, and/or all agricultural fields within a particular region. Additionally, the disclosed apparatus(es), method(s), and/or system(s) can account for varying environmental factors.

It is preferred the apparatus(es), method(s), and/or system(s) be safe, accurate, cost-effective, efficient, and speedy. For example, a major object, feature, and/or advantage of the disclosure is the ability to assess cover crop adoption and/or cover crop biomass on a large scale, over a long period of time, and at field-level precision in an accurate, efficient, cost-effective, and speedy manner.

Methods can be practiced which facilitate the use, manufacture, assembly, maintenance, and repair of the cyberinfrastructure which accomplish some or all of the previously stated objectives.

The apparatus(es), method(s), and/or system(s) disclosed herein can be incorporated into larger apparatus(es), method(s), system(s) and/or design(s) which accomplish some or all of the previously stated objectives.

According to at least some of the aspects and/or embodiments provided in the present disclosure, a methodology is used to accurately derive, estimate, and/or predict large-scale, long-term, and field-level cover crop adoption and biomass information using a remote sensing time series. The methodology comprises four major steps: (1) generating a high-quality remote sensing time series; (2) extracting cover crop information from the remote sensing time series; (3) modeling thresholds of cover crop information as well as biomass information based on environmental factors and/or ground truth data; and (4) applying the one or more models developed in the third step to derive, estimate, and/or predict cover crop adoption and/or cover crop biomass at large-scale, long-term, and/or field-level. The methodology can include the use of artificial intelligence and/or machine learning to train one or more models. The methodology can also include mapping cover crop information and/or biomass information at pixel-level, field-level, county-level, state-level, region-level, nation-level, and beyond.

According to at least some aspects of some embodiments disclosed herein, a method for scalably determining cover crop adoption and/or cover crop biomass, comprising: obtaining remote sensing information of an agricultural field and/or region; preprocessing the remote sensing information to generate a remote sensing time series; extracting one or more features from the remote sensing time series; determining one or more criteria indicating cover crop adoption and/or growth condition under diverse environmental conditions, wherein the one or more features can be compared to the one or more criteria; and determining if the agricultural field and/or region has adopted cover crop and/or determining a cover crop biomass of the agricultural field and/or region based, at least in part, on the one or more criteria and/or the one or more features.

According to at least some aspects of some embodiments disclosed herein, the remote sensing time series is generated from parameters comprising electromagnetic spectral signal(s) including visible, near-infrared, thermal, and/or microwave signals; microwave brightness temperature; microwave backscatter; and/or LIDAR point cloud signal(s).

According to at least some aspects of some embodiments disclosed herein, the parameters used to generate the remote sensing time series are collected from a proximal platform, a drone including an unmanned aerial vehicle (UAV), an airborne vehicle and/or device, and/or a spaceborne vehicle and/or device including a satellite.

According to at least some aspects of some embodiments disclosed herein, the preprocessing comprises cloud and snow removal, outlier removal, gap filling, and non-agricultural field removal.

According to at least some aspects of some embodiments disclosed herein, extracting the one or more features from the remote sensing time series comprises removing soil signal(s) based on a minimum value of the remote sensing time series during a non-growing season.

According to at least some aspects of some embodiments disclosed herein, extracting the one or more features from the remote sensing time series comprises removing cash crop signal(s) based on a cash crop curve during peak growing season.

According to at least some aspects of some embodiments disclosed herein, the one or more features includes a cover crop feature.

According to at least some aspects of some embodiments disclosed herein, the cover crop feature is defined as a value and/or characteristic to represent a difference of a remote sensing time series with and without cover crop.

According to at least some aspects of some embodiments disclosed herein, determining one or more criteria comprises developing one or more cover crop models.

According to at least some aspects of some embodiments disclosed herein, determining one or more criteria comprises using environmental factors and/or ground truth data to develop and/or train the one or more cover crop models.

According to at least some aspects of some embodiments disclosed herein, the environmental factors include temperature, humidity, precipitation, VPD, clay, sand, silt, soil organic carbon (SOC), soil type, latitude, longitude, and/or any combination thereof.

According to at least some aspects of some embodiments disclosed herein, the one or more cover crop models can be a machine learning model and/or can be developed using a machine learning model.

According to at least some aspects of some embodiments disclosed herein, determining whether the agricultural field and/or region has adopted cover crop comprises comparing the cover crop feature to the one or more criteria.

According to at least some aspects of some embodiments disclosed herein, the method further comprises validating a determination of cover crop adoption with pixel-level, field-level, county-level, state-level data, region-level data, and/or nation-level data.

According to at least some aspects of some embodiments disclosed herein, the method further comprises continuously calculating the one or more criteria, which are subject to change, and determining whether a second agricultural field has adopted cover crop based on a second cover crop feature derived from a second remote sensing time series for the second agricultural field.

According to at least some aspects of some embodiments disclosed herein, re-determining the one or more criteria on an annual basis.

According to at least some aspects of some embodiments disclosed herein, determining the cover crop biomass comprises developing one or more biomass models wherein the one or more biomass models are used to derive, estimate, and/or predict the cover crop biomass.

According to at least some aspects of some embodiments disclosed herein, determining the cover crop biomass comprises developing one or more biomass models wherein the one or more biomass models are used to derive, estimate, and/or predict the cover crop biomass.

According to at least some aspects of some embodiments disclosed herein, the one or more biomass models use the one or more features, at least in part, to derive, estimate, and/or predict the cover crop biomass.

According to at least some aspects of some embodiments disclosed herein, the one or more biomass models are developed and/or trained using data related to environmental factors.

According to at least some aspects of some embodiments disclosed herein, the environmental factors include temperature, humidity, precipitation, VPD, clay, sand, silt, soil organic carbon (SOC), soil type, latitude, longitude, and/or any combination thereof are accounted for when developing the biomass model.

According to at least some aspects of some embodiments disclosed herein, a method of training a model for deriving, estimating, and/or predicting cover crop adoption and or growth condition, comprising: obtaining remote sensing information of an agricultural field and/or region; preprocessing the remote sensing information to generate a remote sensing time series; extracting one or more features from the remote sensing time series; and determining one or more criteria indicating cover crop adoption and/or growth condition under diverse environmental conditions, wherein the one or more features can be compared to the one or more criteria.

According to at least some aspects of at least some embodiments disclosed herein, a method of applying one or more trained models for deriving, estimating, and/or predicting cover crop adoption and/or growth condition, comprises determining if an agricultural field and/or region has adopted cover crop and/or determining a growth condition of cover crop in the agricultural field and/or region using the one or more trained models; wherein the one or more trained models are trained using steps comprising: obtaining remote sensing data of an agricultural field; preprocessing the remote sensing data to generate a remote sensing time series; extracting one or more features from the remote sensing time series; determining one or more criteria indicating cover crop adoption and/or growth condition under diverse environmental conditions, wherein the one or more features can be compared to the one or more criteria.

According to at least some aspects of at least some embodiments disclosed herein, a method of training a model for deriving, estimating, and/or predicting cover crop biomass, comprises obtaining remote sensing information of an agricultural field and/or region; preprocessing the remote sensing information to generate a remote sensing time series; extracting one or more features from the remote sensing time series; and determining one or more criteria indicating cover crop adoption and/or growth condition under diverse environmental conditions, wherein the one or more features can be compared to the one or more criteria.

According to at least some aspects of at least some embodiments disclosed herein, a method of applying one or more trained models for deriving, estimating, and/or predicting cover crop biomass, comprises determining a cover crop biomass of an agricultural field and/or region using the one or more trained models; wherein the one or more trained models are trained using steps comprising: obtaining remote sensing data of an agricultural field; preprocessing the remote sensing data to generate a remote sensing time series; extracting one or more features from the remote sensing time series; and determining one or more criteria indicating cover crop adoption and/or growth condition under diverse environmental conditions, wherein the one or more features can be compared to the one or more criteria.

According to at least some aspects of at least some embodiments disclosed herein, a device for scalably determining cover crop adoption and/or cover crop biomass, comprises a processing system; a memory unit and/or non-transitory computer-readable medium that stores executable instructions that, when executed by the processing system, perform operations, the operations comprising: obtaining remote sensing information of an agricultural field and/or region; preprocessing the remote sensing information to generate a remote sensing time series; extracting a cover crop feature from the remote sensing time series; determining one or more criteria indicating cover crop adoption and/or growth condition under diverse environmental conditions, wherein the one or more features can be compared to the one or more criteria; and determining if the agricultural field and/or region has adopted cover crop and/or determining a cover crop biomass of the agricultural field and/or region based, at least in part, on the one or more criteria and/or the one or more features.

According to at least some aspects of at least some embodiments disclosed herein, the device further comprising a database wherein the database is adapted to be able to store and/or archive data or information related to, obtained via, and/or generated via the remote sensing time series, one or more models related to cover crop adoption, one or more models related to cover crop biomass, environmental factors, ground truth data, and/or biomass data.

According to at least some aspects of at least some embodiments disclosed herein, the stored and/or archived data can be used by the device to help determine cover crop adoption and/or cover crop biomass.

According to at least some aspects of at least some embodiments disclosed herein, the device further comprises a visualization portal wherein the visualization portal is adapted to allow a user to enter inputs and/or is adapted to communicate inputs and/or outputs to a user.

According to at least some aspects of at least some embodiments disclosed herein, the inputs include identifying information of a user or the user's organization and/or company, location and/or name of an agricultural field, observational data with and/or without corresponding GPS information, data related to environmental factors with and/or without corresponding GPS information, ground truth data with and/or without corresponding GPS information, farmer reports with and/or without corresponding GPS information, airborne and/or satellite imaging and/or video with and/or without corresponding GPS information, remote sensing data corresponding to one or more agricultural fields with and/or without corresponding GPS information, the cover crop feature with and/or without corresponding GPS information, the one or more thresholds with and/or without corresponding GPS information, and/or information related to cover crop adoption and/or cover crop biomass with and/or without corresponding GPS information.

According to at least some aspects of at least some embodiments disclosed herein, the outputs include cover crop adoption information, cover crop biomass information, and/or mapping data related to the cover crop adoption information and/or to the cover crop biomass information.

According to at least some aspects of at least some embodiments disclosed herein, a non-transitory computer-readable medium comprising executable instructions that, when executed, perform operations, the operations comprises obtaining remote sensing information of an agricultural field and/or region; preprocessing the remote sensing information to generate a remote sensing time series; extracting a one or more features from the remote sensing time series; determining one or more criteria indicating cover crop adoption and/or growth condition under diverse environmental conditions, wherein the one or more features can be compared to the one or more criteria; and determining if the agricultural field and/or region has adopted cover crop and/or determining a cover crop biomass of the agricultural field and/or region based, at least in part, on the one or more criteria and/or the one or more features.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

### BRIEF DESCRIPTION OF THE DRAWINGS

Several embodiments in which the invention can be practiced are illustrated and described in detail, wherein like reference characters represent like components throughout the several views. The drawings are presented for exemplary purposes and may not be to scale unless otherwise indicated.

FIG. 1 shows a flow chart of a method to quantify and/or predict carbon, water, and/or nutrient outcomes according to at least aspect and/or embodiment described herein.

FIG. 2 shows a depiction of a portion of the method of FIG. 1 according to at least one aspect and/or embodiment described herein.

FIG. 3 shows a depiction of an example of a carbon budget framework according to at least one aspect and/or embodiment described herein.

FIG. 4 shows a depiction of an example implementation of the method of FIG. 1 according to at least one aspect and/or embodiment described herein.

FIG. 5 shows a block diagram of an example of a cyberinfrastructure according to at least one aspect and/or embodiment described herein.

FIG. 6 shows a flow chart of a method to predict and/or quantify cover crop traits, tillage practices, and/or their effects according to at least one aspect and/or embodiment disclosed herein.

FIG. 7A shows an example of image acquisition according to at least one aspect and/or embodiment disclosed herein.

FIG. 7B shows an example of image acquisition according to at least one aspect and/or embodiment disclosed herein.

FIG. 7C shows an example of a vegetation index image according to at least one aspect and/or embodiment disclosed herein.

FIG. 7D shows an example of a binary image of vegetation according to at least one aspect and/or embodiment disclosed herein.

FIG. 7E shows an example of a graphical depiction of a histogram and/or threshold segmentation procedure according to at least one aspect and/or embodiment disclosed herein.

FIG. 8 shows a flow chart of an example of an image segmentation algorithm according to at least one aspect and/or embodiment disclosed herein.

FIG. 9A shows a flow chart of an example of an approach to derive a crop residue fraction and/or to derive tillage condition, traits, and/or practices according to at least one aspect and/or embodiment disclosed herein.

FIG. 9B shows a group of images illustrating at least a portion of the approach of FIG. 9A according to at least one aspect and/or embodiment disclosed herein.

FIG. 10 shows an example of a graphical representation of a relationship between cover crop biomass and soil organic carbon benefits from cover crops according to at least one aspect and/or embodiment disclosed herein.

FIG. 11A shows a graphical representation of simulated soil organic carbon based on various tillage depths and mixing rates according to at least one aspect and/or embodiment disclosed herein.

FIG. 11B shows another graphical representation of simulated soil organic carbon based on various tillage depths and mixing rates according to at least one aspect and/or embodiment disclosed herein.

FIG. 12 shows a block diagram of an example of cyberinfrastructure according to at least one aspect and/or embodiment disclosed herein.

FIG. 13 shows a flow chart of an example of a method for assessing and/or quantifying cover crop adoption and/or cover crop biomass according to at least one aspect and/or embodiment disclosed herein.

FIG. 14 shows a graphical representation of an example of remote sensing signals over time according to at least one aspect and/or embodiment disclosed herein.

FIG. 15A shows several graphical representations that serve as examples of the effects of environmental factors on cover crops according to at least one aspect and/or embodiment disclosed herein.

FIG. 15B shows a graphical representation of an example of a relationship between threshold values derived from a cover crop model that accounts for environmental factors and threshold values based on ground truth cover crop information.

FIG. 16A shows a perspective view of an example of measuring cover crop biomass according to at least one aspect and/or embodiment disclosed herein.

FIG. 16B shows a graphical representation of an example of a relationship between cover crop biomass and Normalized Difference Vegetation Index (NDVI) according to at least one aspect and/or embodiment disclosed herein.

FIG. 17 shows examples of mapping data related to cover cropping at the field-level and county-level according to at least one aspect and/or embodiment disclosed herein.

FIG. 18 shows a block diagram of an example of a cyberinfrastructure according to at least one aspect and/or embodiment described herein.

An artisan of ordinary skill need not view, within isolated figure(s), the nearly infinite number of distinct permutations of features described in the following detailed description to facilitate an understanding of the invention according to at least one aspect and/or embodiment disclosed herein.

### DETAILED DESCRIPTION OF THE INVENTION

The present disclosure is not to be limited to that described herein. Mechanical, electrical, chemical, procedural, and/or other changes can be made without departing from the spirit and scope of the invention. No features shown or described are essential to permit basic operation of the invention unless otherwise indicated.

Unless defined otherwise, all technical and scientific terms used above have the same meaning as commonly understood by one of ordinary skill in the art to which embodiments of the invention pertain.

The terms “a,” “an,” and “the” include both singular and plural referents.

The term “or” is synonymous with “and/or” and means any one member or combination of members of a particular list.

The terms “invention” or “present invention” are not intended to refer to any single embodiment of the particular invention but encompass all possible embodiments as described and/or envisioned based upon that disclosed in the present specification and the figures.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variable, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

The terms “main crop” and “cash crop” can be used interchangeably throughout the present disclosure.

The terms “remote sensing signal(s) related to soil” and “remote sensing signal(s)” can be used interchangeably throughout the present disclosure.

The terms “remote sensing signal(s) related to main crops and/or cash crops”, “remote sensing signal(s) related to main crops”, “remote sensing signal(s) related to cash crops”, “main crop and/or cash crop signal(s)”, “main crop signal(s)”, and “cash crop signal(s)” can all be used interchangeably throughout the present disclosure.

The terms “remote sensing signal(s) related to cover crops” and “cover crop signal(s)” can be used interchangeably throughout the disclosure.

The terms “quantify”, “predict”, “estimate”, “derive”, “visualize”, “calculate”, and/or “assess” can generally be used interchangeably throughout the entirety of the present disclosure.

Terms characterizing sequential order, a position, and/or an orientation are not limiting and are only referenced according to the views presented.

The “scope” of the invention is defined by the appended claims, along with the full scope of equivalents to which such claims are entitled. The scope of the invention is further qualified as including any possible modification to any of the aspects and/or embodiments disclosed herein which would result in other embodiments, combinations, subcombinations, or the like that would be obvious to those skilled in the art.

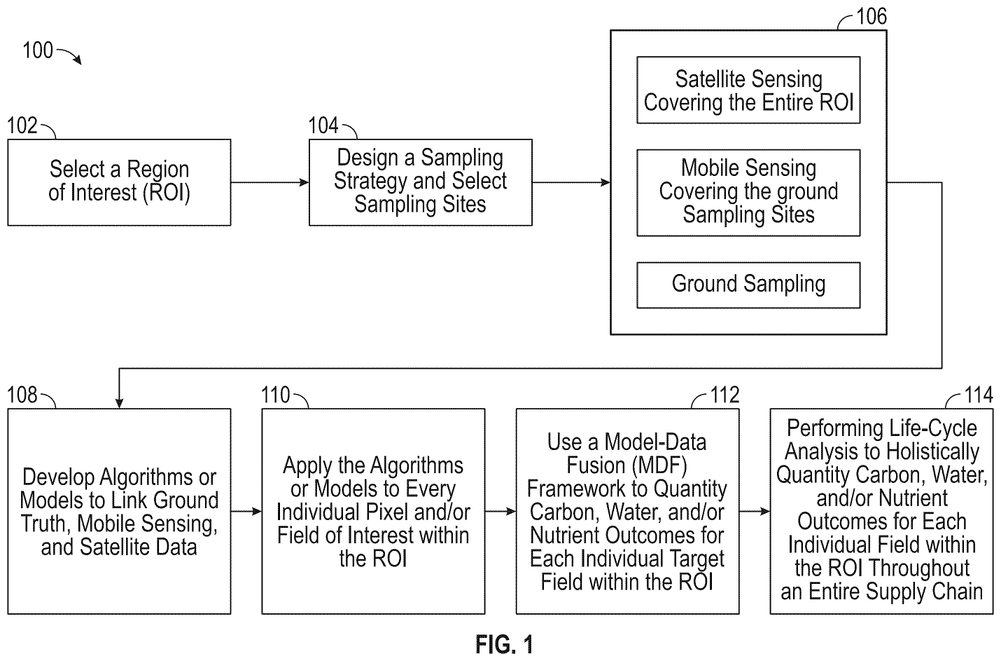

FIG. 1 shows an example of a method 100 for quantifying implications and/or footprints of carbon, water, and/or nutrients of a particular crop and/or utilization of a particular farming practice in an agricultural region on a large scale and at field-level according to at least one embodiment. A farming practice could include a conservation practice, such as but not limited to cover cropping, no-till tillage practices, and/or reduced tillage tillage practices. A conservation practice could comprise and/or be related to cover crop use, tillage practice, water use, and/or nutrient use. The “implications and/or footprints” can be referred to as “outcomes” throughout the present disclosure. While the example embodiment of the method disclosed in FIG. 1 shows a finite number of steps, any number of steps could be added to this method and/or any of the steps shown could be removed from the method. The first step 102 of the method shown in FIG. 1 is to select a region of interest (ROI). The ROI can also be referred to as the target region. The ROI can be any region worldwide. For example, it could be a particular county within a state of the United States of America (USA), a state within the USA, a portion of a state within the USA, a country, and/or any geographic region worldwide. The ROI does not have to be a formal territory such as a county, state, or country, but rather can be any arbitrary geographical zone of which the boundaries could be based on a formal territory such as a county, state, and/or country; a geographical feature such as a body of water, river, mountain, mountain range, canyon, and/or any other type of geographical feature; a particular latitude and or longitude; and/or wherein the boundaries have no basis.

The second step 104 of the example embodiment of the method 100 shown in FIG. 1 is to design a sampling strategy and select sampling sites. This step 104 involves strategic sampling design over space and time. This step 104 can include selecting target fields and/or a target region (e.g., the ROI). Target fields refers to the fields of which quantification of implications and/or footprints related to carbon, water, and/or nutrients is desired. The target fields can include all of the agricultural fields within the target region and/or a portion of the agricultural fields within the target region. This step 104 can include selecting which portion(s) of the target region to collect ground truth data from, selecting which portion(s) of the target region from which to collect remotely sensed data, and/or selecting which portion(s) of the target region from which to collect satellite data. This step 104 can also include determining a time of year and a duration of time in which ground truth data collection, remote sensing, and/or satellite sensing will occur. This step 104 can include selecting which agricultural fields to use for data collection and/or sampling.

Sampling strategies can be designed based on data such as climate factors, soil types, locations, remote sensing data, crop varieties, farming management practices, and/or any other suitable factors. The sampling design can be based on probability-based stratified sampling and/or any other suitable sampling design including but not limited to randomly selecting sampling sites. A probability-based stratified sampling design can include dividing all target fields into groups with characteristic similarities. A probability-based stratified sampling design can include supervised and/or unsupervised classifications such as k-means clustering and t-distributed stochastic neighborhood embedding. Additionally, implementation of a probability-based stratified sampling design allows for only a fraction and/or portion of agricultural fields from all targeted agricultural fields of the same crop type to be sampled in order to obtain representative data of carbon, water, and/or nutrient outcomes. A stratified sampling design can be more efficient and/or cost-effective to obtain carbon, water, and/or nutrient outcomes for a region than other approaches in the art. The sampling design can be based on climate, soil, crop growth stages, and/or management conditions among other characteristics. Accurate and precise results can be obtained for an ROI based on a relatively small portion of that ROI being sampled. For example, a sample of only 1% or less of an ROI can lead to accurate and precise results.

The third step 106 of the example embodiment of the method 100 shown in FIG. 1 includes a multi-tiered approach to data collection. While the example embodiment in FIG. 1 shows a three-tiered approach, any suitable approach to data collection can be used. The first tier of data collected in the example embodiment of FIG. 1 is ground truth data obtained via ground sampling. Ground sampling can occur at sampling sites/sampling portions of an ROI, wherein said sampling sites and/or sampling portions may be selected via the strategic sampling design. Ground sampling can be accomplished via stationary and/or mobile eddy-covariance (EC) flux towers, chamber flux sensors, ground cameras and/or sensors, Internet-of-Things (IoT) sensors and/or cameras, cameras and/or sensors mounted on and/or attached to vehicles, soil sampling, aboveground biomass sampling, and/or any other approach. Each of these apparatuses and/or approaches to ground sampling can be mobile and can be fully reusable. Data and/or information collected via ground sampling is highly accurate and can serve as ground truth data for carbon, water, and/or nutrients. Ground sampling can occur over space and/or time.

The second tier of the three-tiered approach to data collection shown in the third step 106 of the method 100 of FIG. 1 includes remote/mobile sensing covering the sampling sites/sampling portions of the ROI upon which ground sampling occurs. Additionally, remote/mobile sensing can cover additional areas of the ROI wherein ground sampling does not occur. To collect remote/mobile sensing data (also referred to as remotely sensed data), any suitable type of vehicle and/or system could be used including but not limited to sensing systems of aircraft, airborne hyperspectral system(s), vehicle system(s), airborne vehicle(s), drone(s), unmanned aerial vehicle(s) (UAV(s)), airplane(s), helicopter(s), and/or satellite sensors. Remote sensing can occur over space and/or time. Data collected via remote/mobile sensing using airborne data collection can be referred to as “intermediate remotely sensed data”. This “intermediate remotely sensed data” may or may not include satellite data.

The third tier of the three-tiered approach to data collection shown in the third step 106 of the method 100 of FIG. 1 includes satellite sensing to obtain satellite data. Satellite sensing can occur over sampling sites/sampling portions of the ROI wherein ground sampling and/or remote sensing occurred, over other portions of the ROI, and/or over the entire ROT. Satellite data obtained via satellite sensing can include single-source and/or multi-source satellite data that can include but is not limited to optical, thermal, and/or microwave data. Satellite sensing can occur over space and/or time. Satellite data can be obtained as a dataset that is synthesized from multiple satellite data sources, wherein spatial and/or temporal gaps in the dataset can be filled and/or inferred using a multi-sensor satellite data fusion model. The spatial and/or temporal gaps can be due to cloud obstruction, instrumental failure, and/or lack of flyover as well as other factors.

The next step 108 of the example embodiment of the method 100 shown in FIG. 1 includes developing algorithm(s) and/or model(s) to link ground truth data, remote/mobile sensing data, and/or satellite data. This step of the example embodiment can include apparatus(es), system(s), and/or method(s) such as that disclosed in U.S. Patent Application No. 63/180,811 and International Application No. PCT/US2021/041051 which are both hereby incorporated by reference in their entirety. This step 108 includes developing one or more mobile system data based models by overlapping ground truth data and remote/mobile sensing data. This overlap can occur at sampling sites in which ground sampling and remote sensing occurred such that ground truth data and remote/mobile sensing data exists for the site and/or in which ground sampling and remote sensing were conducted in a similar and/or the same temporal range. The one or more mobile system data based models are developed and/or trained wherein remote/mobile sensing data is used as inputs and ground truth data is used for labeling. The one or more mobile system data based models can be statistical, artificial intelligence (AI), machine learning, and/or physics-based models.

This step 108 can also include applying the one or more mobile system data based models to additional remote/mobile sensing data that was collected from areas of the ROI in which ground sampling was not conducted. It is appreciated that remote/mobile sensing can occur for a geographical area that is larger, smaller, and/or the same as that of the geographical area in which ground sampling is conducted. By applying the one or more mobile system data based models to additional areas wherein remote/mobile sensing was conducted but ground sampling was not, large-volume, highly accurate quasi-ground truth data is obtained from those additional areas.

The fourth step 108 can also include developing one or more satellite data based models. The one or more satellite data based models can be developed by overlapping the quasi-ground truth data (obtained by applying the one or more mobile data based models) and the satellite data (obtained by satellite sensing). This overlap can occur at sampling sites in which remote sensing and satellite sensing occurred such that quasi-ground truth data and satellite data exists for the site and/or in which remote sensing and satellite sensing was conducted in a similar and/or the same temporal range. The one or more satellite data based models are developed and/or trained wherein the satellite data is used as inputs and the quasi-ground truth data is used for labeling. The one or more satellite data based models can be statistical, AI, machine-learning, and/or physics-based models.

The fifth step 110 of the example embodiment of the method shown in FIG. 1 includes applying the algorithms and/or models to every individual pixel or target field within the ROI. The fifth step 110 can include applying the one or more satellite data based models to the entirety of the ROI or to any specific target portions and/or target fields therein. This step 110 can also include applying the one or more satellite data based models to any and/or all satellite data obtained for any portion of the ROI and/or for the entirety of the ROI. It is appreciated that satellite sensing can occur for a geographical area that is larger, smaller, and/or the same as that of the geographical area in which ground sampling and/or remote sensing is conducted. It is also appreciated that satellite sensing can occur for the entirety of the ROI covering each individual field within the ROT. In this way, the method can quantify carbon, water, and/or nutrient outcomes such as implications and/or footprints on a large-scale (such as the entirety of the ROI) in a speedy, efficient, and cost-effective manner.

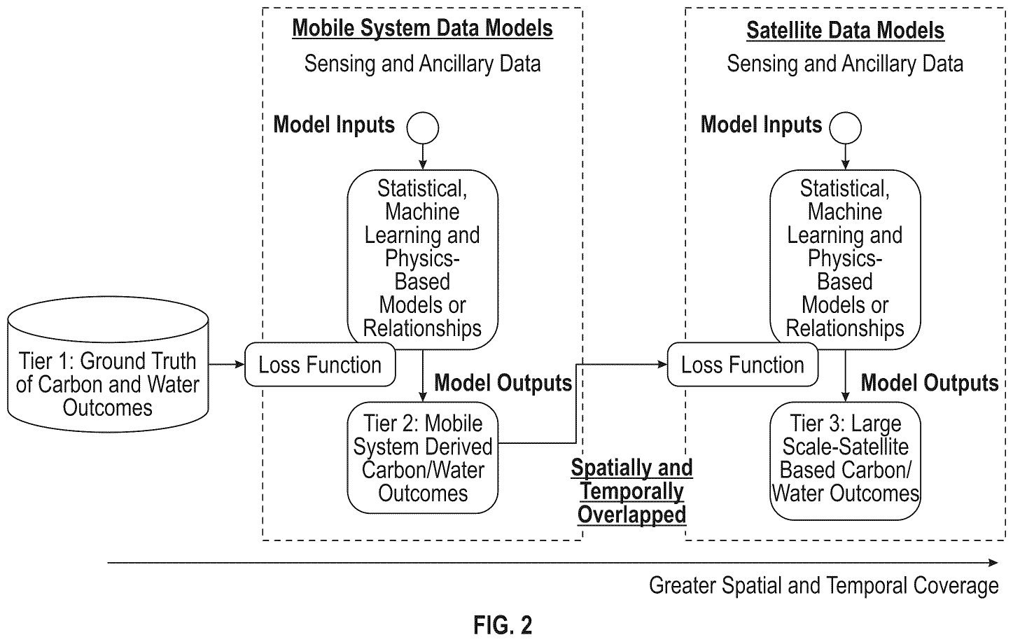

FIG. 2 provides additional disclosure regarding the fourth and fifth steps 108, 110 of the example embodiment of the method 100 shown in FIG. 1. FIG. 2 shows a depiction of a portion of the method disclosed in FIG. 1. The depiction of FIG. 2 illustrates aspects of the fourth step 108 of the method of FIG. 1 wherein algorithms and/or models are developed to link ground truth, mobile sensing, and/or satellite data. The depiction of FIG. 2 illustrates inputs and outputs for each aspect of the fourth step 108 of the method of FIG. 1. The depiction of FIG. 2 illustrates how ground truth data obtained via ground sampling, remote sensing data, and satellite data are linked and/or integrated to quantify carbon, water, and/or nutrient outcomes. The term “quantify” can mean, predict, estimate, derive, visualize, calculate, and/or assess throughout the entirety of the present disclosure.

As shown in FIG. 2, and as discussed above, the methodology used to develop algorithms and/or models can include a three-tiered approach. As shown in FIG. 2, Tier 1 data refers to ground truth data obtained via ground sampling that can include carbon, water, and/or nutrient outcomes. Ground truth data can then be spatially and/or temporally overlapped with remote sensing data wherein one or more mobile system data based models can be developed wherein inputs include remote/mobile sensing data as well as ancillary data such as but not limited to field management practices, soil conditions, climate factors, soil types, locations, and/or crop varieties. The spatial overlaps can refer to data collected covering the same geographical area, agricultural field, territory, region, and the like. The temporal overlaps can refer to data collected at a common window of time, such as in a week, a month, and/or a year depending on the targeted variables of interest. According to some aspects and/or embodiments, it is advantageous to collect different sources of data within a common week. According to some aspects and/or embodiments, it is advantageous to collect different pieces of data at the exact same moment in time, such as collecting ground truth data and remote sensing data at the same time. The one or more mobile system data based models can be statistical, AI, machine learning, and/or physics-based models and/or relationships. The one or more mobile system data based models can predict and/or quantify carbon, water, and/or nutrient outcomes. Through benchmarking with Tier 1 data, the parameters of the one or more mobile system data based models can be updated to minimize loss function. As such, the one or more mobile system data based models can derive and/or output highly accurate Tier 2 carbon, water, and/or nutrient outcomes that can cover a larger geographical area than the Tier 1 outcomes.

Further as shown in FIG. 2, the derived Tier 2 carbon, water, and/or nutrient outcomes output by the one or more mobile system data based models can be spatially and/or temporally overlapped with the satellite sensing data to develop one or more satellite data based models in a similar manner as the ground truth data and the remote sensing data were overlapped to develop the one or more mobile system data based models. Inputs to the one or more satellite data based models can include satellite sensing data as well as ancillary data such as but not limited to field management practices, soil conditions, climate factors, soil types, locations, and/or crop varieties, and/or any other suitable environmental variables. The one or more satellite data based models can be statistical, AI, machine learning, and/or physics-based models and/or relationships. The one or more mobile system data based models can predict and/or quantify carbon, water, and/or nutrient outcomes. Through benchmarking with the Tier 2 highly-accurate carbon, water, and/or nutrient outcomes derived from the one or more mobile system data based models (quasi-ground truth data), the parameters of the one or more satellite data based models can be updated to minimize the loss function. As such, the one or more satellite data based models can quantify, derive, and/or output large-scale highly accurate satellite-based carbon, water, and/or nutrient outcomes (referred to as Tier 3) that can cover a larger geographical area than either of Tier 1 or Tier 2 outcomes. These large-scale satellite-based outcomes can cover the entirety of the ROI and/or target portions within the ROI. In this way, high-quality data can be obtained for the entirety of the ROI and/or target portions within the ROI.

Referring back to FIG. 1, The sixth step 112 of the example embodiment of the method shown in FIG. 1 includes using a model-data fusion (MDF) framework to quantify carbon, water, and/or nutrient outcomes for each individual target field within the ROI at field-level, or, in other words, on a field-by-field basis. The MDF framework enables ingesting multi-source observation data to constrain any process-based models. Process-based models include but are not limited to any model using mechanistic understanding to simulate carbon, water, and/or nutrient dynamics and/or outcomes of an ecosystem and/or agroecosystem. Examples of process-based models include but are not limited to ecosys, Daycent, EPIC, Noah, Noah-MP, DNDC, CLM, and/or VIC. The multi-source observation data can come from observations such as but not limited to satellite observations, airborne observations, proximal observations, satellite sensing, remote/mobile sensing, ground sampling, wireless sensor network (WSN), Internet-of-Things (IoT), EC flux towers, chamber flux sensors, ground surveys, in-situ field experiments, soil sampling, standard streamflow gauges, and/or governmental statistical data. Additionally, the one or more mobile system data based models and/or the one or more satellite data based models could be integrated into a process-based model to serve as multi-source observation data. The MDF framework can include using such observation data as model inputs, can include model parameter calibration with the observation data, and/or can include data assimilation of the observation data for model state and/or parameter updating. Model-data fusion can include the use of statistical regression or classification, artificial neural networks, threshold-based models with set parameters, artificial intelligence, machine learning, and/or deep learning.

Ensuring that there is a local constraint is critical to achieving high accuracy and realistic simulation at the field level in process-based modeling. This is due to large spatial heterogeneity caused by factors including but not limited to soil types, management practices, weather conditions, and/or crop conditions. The use of high-resolution local constraints for modeling landscapes is limited and/or lacking in the prior art for a couple of reasons. First, techniques in the prior art lack high-resolution field-level observation data on a large scale. Also, techniques in the prior art lack the computation capability to fuse local observation data with models such as process-based models. Without a local constraint, model simulations can vary significantly from reality. Thus, the sixth step 112, includes the ability to calibrate location-specific model parameters with available observation data in order to ensure accurate quantification at the field level. These location-specific model parameters can include but are not limited to plant physiological parameters and local soil properties. These plant physiological parameters can include plant physiological parameters that vary across time and space and also vary genetically but are generally not dynamically modeled. These physiological parameters can include but are not limited to plant photosynthetic capacity and/or grain-filling rate. The local soil properties can include but are not limited to soil hydrological properties, tile drainage efficiency, and/or biogeochemical properties. Various soil databases are available to obtain data related to local soil properties. However, these publicly available soil databases often contain significant errors at specific locations. Therefore, using observation data to further constrain these soil related parameters can critically reduce uncertainties regarding soil properties.

Before using observation data to constrain model parameters, the sensitive model parameters can be screened by conducting model parameter sensitivity analysis. Only the most sensitive model parameters are calibrated using observation data as constraints.

The MDF framework can be used to quantify carbon, water, and/or nutrient outcomes for an individual agricultural field. The sixth step 112 can also include scaling up the MDF framework such that carbon, water, and/or nutrient outcomes can be quantified for many fields such as each individual agricultural field within the ROL. To scale up the MDF framework such that it is capable of operating on a large scale, AI, machine learning, supercomputing and/or any other suitable computing methodologies can be used. These methodologies can improve computation efficiency of the MDF framework. These methodologies can include building AI-based surrogate model(s) that can be applied to process-based model(s) to improve the efficiency of running the process-based model(s). Improving the efficiency of process-based model(s) can speed up and/or increase efficiency of parameter calibration achieved via the MDF framework. AI, machine learning, and/or deep learning techniques and/or methodologies can be used to build the AI-based surrogate model(s). Inputs to the AI-based surrogate model(s) can include but are not limited to weather data, weather forcing data, climate forcing data, management practices of an agricultural field, soil conditions, and/or plant conditions. The outputs of the AI-based surrogate model(s) can include but are not limited to target variables that can be observed. These target variables can include any kind of data that can be included as observation data. This includes but is not limited to satellite observations, airborne observations, proximal observations, satellite sensing, remote/mobile sensing, ground sampling, wireless sensor network (WSN), Internet-of-Things (IoT), EC flux towers, chamber flux sensors, ground surveys, in-situ field experiments, soil sampling, standard streamflow gauges, governmental statistical data, and/or any data included as part of the one or more mobile system data based models and/or the one or more satellite data based models.

Additionally, parallel computing and/or GPU-based computing can be used to speed up the process of training the AI-based surrogate model(s) and/or applying the MDF framework to accurately quantify carbon, water, and/or nutrient outcomes for each individual target field within the ROL. The outputs of the MDF framework include carbon, water, and/or nutrient fluxes and/or outcomes from each individual target field within the ROL. Additionally, the method 100 of FIG. 1, can quantify carbon, water, and/or nutrient outcomes at any particular targeted field for a particular growing season, any particular year, and/or over multiple years.

The seventh step 114 of the example embodiment of the method 100 shown in FIG. 1 includes performing life-cycle analysis (LCA) to holistically quantify carbon, water, and/or nutrient outcomes of each individual agricultural field within the ROI throughout an entire supply chain. The life-cycle assessment tools that are used can include but are not limited to cradle-to-farm-gate, cradle-to-factory-gate, cradle-to-grave, and/or other suitable variants. Holistic quantification of carbon, water, and/or nutrient outcomes from a life-cycle perspective allows for quantification across space and time and provides greater detail and analysis of such outcomes. By performing LCA, researchers and scientists can better understand carbon, water, and/or nutrient flux, which will allow them to better understand local and/or global impacts on the soil, vegetation, and/or climate. LCA can be performed using, or with the assistance of, AI, machine learning, and/or supercomputing. LCA can include the use of statistical regression or classification, artificial neural networks, threshold-based models with set parameters, artificial intelligence, machine learning, and/or deep learning.

The disclosed methods and/or techniques, which include an observation-constrained modeling platform, also enable hypothetical scenario assessment of the impacts of different field management practices and/or climate change scenarios on crop production and/or environmental sustainability. Examples of scenarios that could be assessed using the disclosed methods and/or techniques, including the method 100 of FIG. 1 include but are not limited to conservation practices such as cover cropping, crop rotation and change in varieties such as continuous corn and soybean, corn-soybean rotation, and/or change in crop varieties; tillage practices such as no-till, reduced tillage, and/or conventional tillage; cover crop usage and type such as cover crop adoption, non-use of cover crops, and/or varied cover crop types; nitrogen fertilizer application such as application time (conventional fall application, conventional spring application, and/or spring application with side dressing) and/or differing nitrogen fertilizer application amounts; tile drainage practices such as free tile drainage and/or controlled tile drainage; other changes in field management practices; differing projected climate change scenarios, and/or any combination thereof.

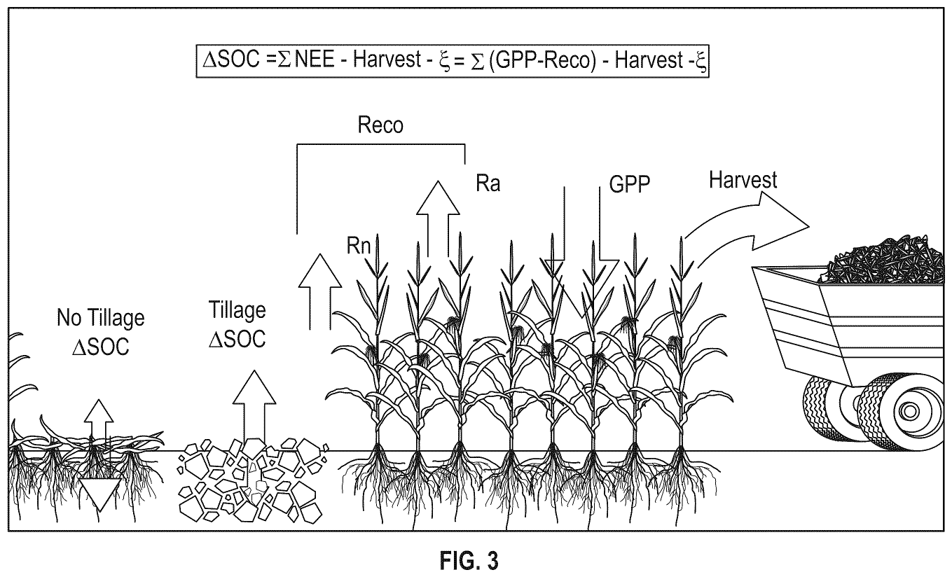

FIG. 3 shows a depiction of a carbon budget framework. The depiction of FIG. 3 is a conceptual illustration of a comprehensive carbon budget framework for farmland to enable quantification of annual changes in soil organic carbon (SOC). The change of SOC is holistically related to the carbon budget and is described by the following equation:

$$Δ S O C = \sum NEE - Harvest - ξ = \sum ( GPP - Reco ) - Harvest - ξ$$

The above equation used to describe the change in SOC can be referred to as Equation 1. In Equation 1, ΔSOC is the change of SOC and NEE is net ecosystem exchange. In Equation 1, NEE=GPP−Reco, wherein GPP represents gross primary productivity and Reco represents ecosystem respiration. More specifically, Reco=Ra+Rh, wherein Ra and Rh are autotrophic respiration (i.e., respiration from a crop itself) and heterotrophic respiration (i.e., respiration from soil), respectively. Gross primary product can generally be understood to measure the amount of carbon dioxide converted into organic compounds per unit of time. Terrestrial plants typically perform primary production via photosynthesis. In Equation 1, “Harvest” represents carbon removed from a field via harvesting (e.g., crop yield or other crop biomass). In Equation 1, represents carbon loss from leaching, which is typically very small (usually less than 0.5%) and thus can be neglected in most cases. Therefore, Equation 1 can be simplified to remove carbon loss from leaching. Thus, the symbol can be removed from Equation 1.

NEE, GPP, Reco, and “Harvest” are all terms of Equation 1 that can be fully verified, and therefore audited, on an annual scale using existing technology in a cost-effective manner. Particularly, NEE can be directly measured using eddy-covariance (EC) techniques such as EC towers, which is a method known and used in the art to measure terrestrial carbon budget. Additionally, EC measurement techniques, such as the use of EC towers can provide accurate and robust measurements of GPP and Reco. By using mobile EC towers, verification of terrestrial carbon budget can be scalable for tracking field-level carbon budget. In addition to using EC towers, GPP can also be estimated at high spatial resolution (10-30 meters) and with high accuracy through integrating remote sensing techniques such as but not limited to satellite-based solar-induced chlorophyll fluorescence (SIF), near-infrared radiance of vegetation, and/or multi-satellite data fusion. In Equation 1, “Harvest”, which represents harvested carbon, can be derived from farmer-reported and/or machine-reported yield at field-level. Additionally, harvested carbon and/or harvested crop yield can also be estimated with high accuracy on a large scale via satellite remote sensing.

These observations include but are not limited to net ecosystem exchange (NEE), gross primary productivity (GPP), ecosystem respiration (Reco) (including autotrophic respiration (Ra) and/or heterotrophic respiration Rh), and/or harvested carbon (Harvest) removed from a field, can be used to constrain the entirety of and/or portion(s) thereof of the plant carbon cycle and/or soil carbon cycle including a residue fraction going back to the soil. A model can be developed using these constraints wherein high performance in simulating heterotrophic respiration (soil respiration) and changes in soil organic carbon can be achieved. These parameters can be constrained by comparing a derived value to a simulated value. For instance, by constraining the parameters by comparing the derived GPP to the simulated GPP, cultivar specific crop parameters, such as photosynthetic capacity (Vcmax) and/or maturity group, can be calibrated in a process-based model. This can ensure that magnitude and seasonal cycle of plant carbon fixation is modeled accurately. Additionally, the performance of modeling the carbon output produced by autotrophic respiration (plant respiration) will also be improved by constraining crop parameters with GPP observations since autotrophic respiration is mostly related to crop biomass and/or environmental conditions.

Furthermore, the one or more mobile system data based models and/or the one or more satellite data based models can be constrained using the observations, values, and/or variables described in Equation 1. For example, parameters of the one or more mobile system data based models and/or the one or more satellite data based models can be constrained by comparing derived GPP and simulated GPP such that cultivar specific crop parameters can be calibrated in the one or more mobile system data based models and/or the one or more satellite data based models to ensure that the magnitude and seasonal cycle of plant carbon fixation and/or plant carbon flux is modeled accurately. Examples of cultivar specific crop parameters that can be calibrated in the one or more mobile system data based models and/or in the one or more satellite-based models includes but is not limited to photosynthetic capacity (Vcmax) and/or maturity group.

In addition to carbon, the present disclosure can also measure water flux and or nutrient flux such as nitrogen flux. Other types of observations can be used to constrain process-based models, machine learning models, the one or more of the mobile system data based models, and/or the one or more satellite data based models. For example, EC towers can measure parameters including but not limited to water flux, nitrous oxide flux, and/or methane flux. Derived data from remote-sensing based models such as the one or more mobile system data based models and/or the one or more satellite data based models, such as water flux as well as others, can be used similarly to GPP, as described above, to constrain models for better, more efficient, more effective, faster, and/or more accurate quantification of plant and/or soil carbon budget, nutrient and/or nitrogen budget, and/or water budget.

As shown in FIG. 3, soil organic carbon can vary depending on differences in tillage practices of the field in question such as no tillage and/or tillage. Additionally, FIG. 3 provides an illustrative depiction of Reco, Rh, Ra, GPP, and harvested carbon and how each parameter enters and/or exits the ecosystem.

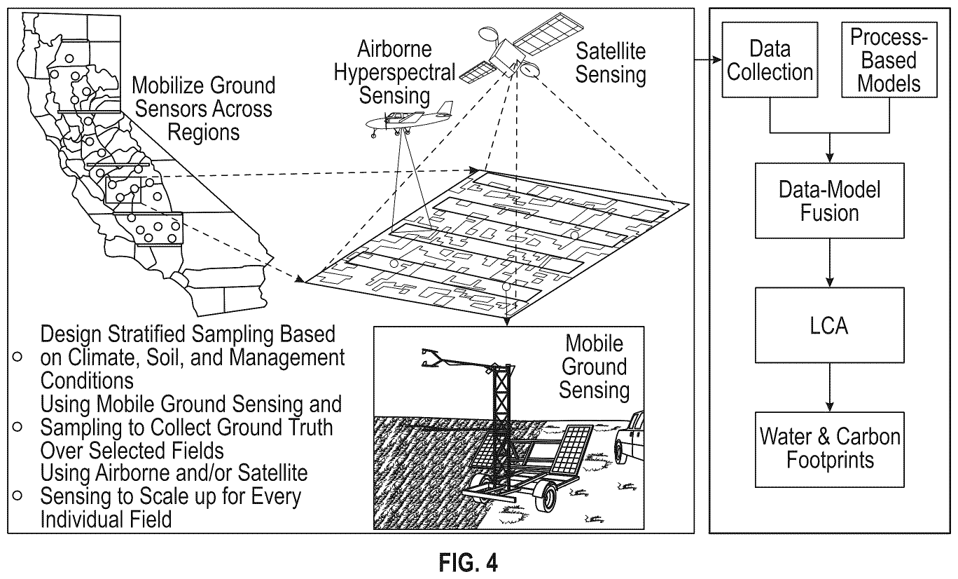

FIG. 4 shows a depiction of an example implementation of aspects and/or embodiments of the disclosed methodology. As an example, the depiction of FIG. 4 assumes that there are 5000 strawberry fields in the state of California. The goal in the example of FIG. 4 is to quantify carbon and water footprints for each of these 5000 fields. The first step is to design a sampling strategy in space and time, based on environmental factors (such as climate, soil types), management practices, crop growth stages, and the like. Ground sampling will only occur at 1% or about 50 of the 5000 fields. EC towers and/or any other ground sampling approaches described herein such as ground cameras and/or soil samples will be used to measure carbon, water, and/or nutrient flux and/or outcomes as well as other parameters such as soil conditions and crop biomass. In the example of FIG. 4, eight EC towers can be used to measure carbon, water, and/or nutrient flux and/or outcomes at eight different fields for one month. Each month, these eight EC towers will be moved to eight new fields of the 50 fields that will undergo ground sampling. Ground sampling will be conducted for 6 to 7 months during the strawberry growing season in California. Over the 6 to 7 month period, carbon, water, and/or nutrient outcomes and/or flux data will be collected via EC towers or other means, as well as other data such as soil conditions and/or crop biomass, for each of the 50 fields that were identified as part of the sampling strategy.

During, before, and/or after conducting ground sampling at each of the 50 fields identified as part of the sampling strategy, remote/mobile data is collected via airborne vehicles and/or any other suitable manner described herein. This remote/mobile sensing data can include hyperspectral and/or multispectral imaging. This remote/mobile sensing data can cover a larger area and/or a larger number of fields than the 50 fields at which ground sampling was conducted. One or more models can be developed to link ground truth data obtained via ground sampling data and the remote/mobile sensing data obtained via remote/mobile sensing. These one or more models can be applied such that quasi-ground truth data is derived for fields wherein ground sampling did not occur, but remote sensing did occur. Additionally, during, before, and/or after conducting ground sampling and/or remote/mobile sensing, satellite sensing can occur. Satellite sensing is conducted over the entirety of the region of interest and/or at each of the 5000 strawberry fields to obtain satellite sensing data. The satellite sensing data can be linked with derived quasi-ground truth data to develop one or more satellite-based models. These one or more satellite-based models can be applied to each of the 5000 strawberry fields in California in order to quantify carbon, water, and/or nutrient outcomes such as carbon, water, and/or nutrient footprint for the entire region of interest, which includes the 5000 total strawberry fields. MDF techniques can be used to quickly, effectively, efficiently, and accurately quantify carbon, water, and/or nutrient outcomes including footprints for each individual field of the 5000 targeted strawberry fields at field-level. LCA techniques can then be used to holistically quantify carbon, water, and/or nutrient outcomes, including footprints, for each individual agricultural field within the region of interest throughout an entire supply chain.

As shown in FIG. 4, a flow chart of a quantification method is included with the depiction of the example implementation. The example method shown as part of FIG. 4 is similar to that shown in FIG. 1. The method of FIG. 4 includes data collection, development and/or use of process-based models, development and/or use of MDF, development and/or use of LCA, and ultimately quantification of carbon, water, and/or nutrient outcomes and/or footprints of each individual field of the 5000 strawberry fields within the region of interest throughout an entire supply chain.

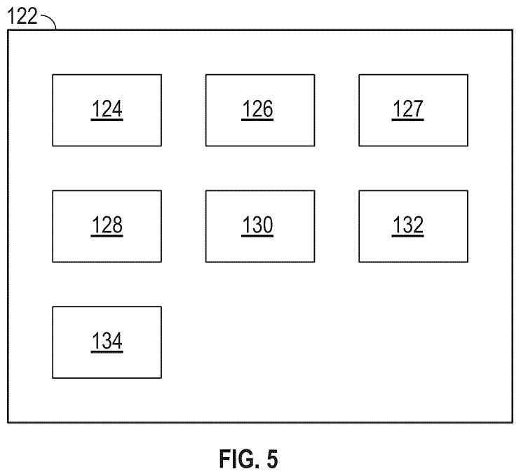

Various embodiments of the disclosure described herein include a cyberinfrastructure. FIG. 5 shows an example of a cyberinfrastructure 122 according to some aspects and/or some embodiments. The cyberinfrastructure 122 may comprise a database 124, a pipeline 126 for MDF and LCA, a processing system 127, a visualization portal 128, a memory unit 130, and/or a tangible computer-readable storage medium 132. The database 124 may be a comprehensive computer database. The cyberinfrastructure 122 may include a set of instructions 134 that, when executed, may cause the cyberinfrastructure 122 to perform any of the methods and/or methodologies discussed above.

According to some embodiments, the cyberinfrastructure 122 can also include an intelligent control. The intelligent control can control and/or manipulate data stored in the database 124 such that a one processing unit can operate quickly, efficiently, and/or effectively. Additionally, the intelligent control can perform and/or execute the instructions 134 to cause the cyberinfrastructure 122 to perform any of the methods and/or methodologies discussed above. Examples of such an intelligent control may be processing units alone or other subcomponents of computing devices. The intelligent control can also include other components and can be implemented partially or entirely on a semiconductor (e.g., a field-programmable gate array (“FPGA”)) chip, such as a chip developed through a register transfer level (“RTL”) design process.

The database 124 may be a comprehensive database. The database 124 may be used to store and/or archive all observations and/or data or information obtained via ground sampling, remote sensing, and/or satellite sensing; input data of the MDF framework; output of the MDF framework; outcomes; environmental factors; and/or any other suitable information and/or data.

The database 124 can include any type of data storage cache and/or server and can refer to any kind of memory components, any kind of entities embodied in a memory component, and/or any kind of components comprising memory. It is appreciated that the database 124 can include volatile memory and/or nonvolatile memory. The database 124 can be a structured set of data typically held in a computer. The database 124, as well as data and information contained therein, need not reside in a single physical or electronic location. For example, the database 124 may reside, at least in part, on a local storage device, in an external hard drive, on a database server connected to a network, on a cloud-based storage system, in a distributed ledger (such as those commonly used with blockchain technology), or the like.

The database 124 can include the use of read-only memory (“ROM”, an example of non-volatile memory, meaning it does not lose data when it is not connected to a power source) or random access memory (“RAM”, an example of volatile memory, meaning it will lose its data when not connected to a power source). Nonlimiting examples of volatile memory include static RAM (“SRAM”), dynamic RAM (“DRAM”), synchronous DRAM (“SDRAM”), etc. Examples of non-volatile memory include electrically erasable programmable read only memory (“EEPROM”), flash memory, hard disks, SD cards, etc. In some embodiments, the processing unit, such as a processor, a microprocessor, or a microcontroller, is connected to the memory and executes software instructions that are capable of being stored in a RAM of the memory (e.g., during execution), a ROM of the memory (e.g., on a generally permanent basis), or another non-transitory computer readable medium such as another memory or a disc.

The pipeline 126 for MDF and LCA can include an intelligent control and components for establishing communications as well as any number of processing units ranging from zero to N where N is any number greater than zero. The intelligent control can control and/or manipulate data stored in the database 124 such that the pipeline 126 for MDF and LCA can operate quickly, efficiently, and/or effectively. Examples of such an intelligent control may be processing units alone or other subcomponents of computing devices. The intelligent control can also include other components and can be implemented partially or entirely on a semiconductor (e.g., a field-programmable gate array (“FPGA”)) chip, such as a chip developed through a register transfer level (“RTL”) design process.

The processors that can be included as part of the pipeline 126 for MDF and LCA can include any number of processing units such as one or more CPUs and/or GPUs and can utilize parallel computing and/or GPU-based computing as described above. With proper configurations, the pipeline 126 for MDF and LCA can operate as a one-stop solution to perform the entire MDF and/or LCA workflow. By utilizing the architecture and/or computing techniques described herein, the pipeline 126 for MDF and LCA allows for speedy, effective, and/or efficient data processing and computation.

The processing system 127 can include an intelligent control and components for establishing communications as well as any number of processing units ranging from zero to N where N is any number greater than zero. The intelligent control can control and/or manipulate data stored in the database 124 such that the processing system 127 can operate quickly, efficiently, and/or effectively. Examples of such an intelligent control may be processing units alone or other subcomponents of computing devices. The intelligent control can also include other components and can be implemented partially or entirely on a semiconductor (e.g., a field-programmable gate array (“FPGA”)) chip, such as a chip developed through a register transfer level (“RTL”) design process.

The processors that can be included as part of the processing system 127 can include any number of processing units such as one or more CPUs and/or GPUs and can utilize parallel computing and/or GPU-based computing as described above. By utilizing the architecture and/or computing techniques described herein, the processing system 127 allows for speedy, effective, and/or efficient data processing and computation.

A processing unit, also called a processor, is an electronic circuit which performs operations on some external data source, usually memory or some other data stream. Non-limiting examples of processors include a microprocessor, a microcontroller, an arithmetic logic unit (“ALU”), and most notably, a graphics processing unit (GPU), a central processing unit (“CPU”). A CPU, also called a central processor or main processor, is the electronic circuitry within a computer that carries out the instructions of a computer program by performing the basic arithmetic, logic, controlling, and input/output (“I/O”) operations specified by the instructions. Processing units are common in tablets, telephones, handheld devices, laptops, user displays, smart devices (TV, speaker, watch, etc.), and other computing devices.

The visualization portal 128 allows a user to enter inputs and/or can communicate inputs and/or outputs to a user. According to some embodiments, a user can enter inputs which can include but are not limited to identifying information of the user and/or the user's organization and/or company, ROI location and/or name, location and/or name(s) of targeted field(s) within the ROI, observation data with and/or without corresponding GPS information, ground sampling data with and/or without corresponding GPS information, remote sensing data with and/or without corresponding GPS information, satellite sensing data with and/or without corresponding GPS information, and/or information related to carbon, water, and/or nutrient outcomes with and/or without corresponding GPS information. According to other embodiments, this information and/or data can be input to the visualization portal 128 and/or other aspects of the cyberinfrastructure 122 automatically upon sensing, acquiring, and/or obtaining the data.

According to some aspects and/or embodiments, the visualization portal 128 can be physically manifested, be viewable, and/or be accessible in any suitable manner including as a smart device including but not limited to a mobile phone, tablet, computer, and the like. The visualization portal 128, physically manifested as a smart device, can include a user interface wherein a user can enter inputs and/or the visualization portal can display and/or communicate outputs including but not limited to intermediate and/or final results as well as carbon, water, and/or nutrient outcomes that are based on the inputs. According to some embodiments, the visualization portal 128 can be implemented as a computer program and/or as a software program wherein it can be accessible by any means mentioned in this paragraph and/or by any other suitable means.

In accordance with various aspects of the embodiments of the disclosure, aspects of the methods described herein are intended for operation as software programs running on a computer processor. Furthermore, software implementations can include, but are not limited to, distributed processing and/or component/object distributed processing, parallel processing, and/or virtual machine processing can also be constructed to implement aspects of the methods described herein.

A user interface is how the user interacts with a machine. The user interface can be a digital interface, a command-line interface, a graphical user interface (“GUI”), an oral interface, a virtual reality interface, or any other way a user can interact with a machine (user-machine interface). For example, the user interface (“UI”) can include a combination of digital and analog input and/or output devices or any other type of UI input/output device required to achieve a desired level of control and monitoring for a device. Nonlimiting examples of input and/or output devices include computer mice, keyboards, touchscreens, knobs, dials, switches, buttons, speakers, microphones, printers, LIDAR, RADAR, etc. Input(s) received by the UI can then be sent to a microcontroller and/or any type of controller to control operational aspects of a device and/or method such as the disclosed methods.

The user interface of the visualization portal 128 can include any of the above-described input/output devices and/or methods to input data and/or information into the visualization portal and/or any other aspect of the cyberinfrastructure 122. For example, methods of inputting data and/or information can include entering the data and/or information via touchscreen, via keyboard typing, via click of a computer mouse, via voice command, and/or any other suitable method disclosed herein and/or known in the prior art. Furthermore, the user interface of the visualization portal 128 can include any of the above-described input/output devices and/or methods to communicate outputs, data, and/or information such as intermediate and/or final results to the user. For example, methods of communicating output to a user can include displaying via a screen, producing audio communication, printing, and/or any other suitable method disclosed herein and/or known in the prior art.

Output data and/or information could be communicated in any form such as but not limited to text, numerical, graphical, mapping, illustrative, audio, and/or any other suitable form disclosed herein and/or known in the prior art.

The user interface can include a display, which can act as an input and/or output device. More particularly, the display can be a liquid crystal display (“LCD”), a light-emitting diode (“LED”) display, an organic LED (“OLED”) display, an electroluminescent display (“ELD”), a surface-conduction electron emitter display (“SED”), a field-emission display (“FED”), a thin-film transistor (“TFT”) LCD, a bistable cholesteric reflective display (i.e., e-paper), etc. The user interface also can be configured with a microcontroller to display conditions or data associated with the main device in real-time or substantially real-time.

According to some embodiments, the visualization portal 128 can be an online web-based portal. According to some embodiments, the portal can function as a mobile website capable of being accessed via a mobile device such as a smartphone, tablet, smart device, and the like. According to other embodiments, the visualization portal 128 can function as a traditional and/or desktop website capable of being accessed via a desktop computer, laptop computer, and the like.

The visualization portal 128 can include cloud computing. Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. A cloud computing environment is service oriented with a focus on statelessness, low coupling, modularity, and semantic interoperability. At the heart of cloud computing is an infrastructure comprising a network of interconnected nodes.

Some common characteristics of cloud computing include its on-demand self-service nature, its broad network access, resource pooling, rapid elasticity, and the ability to measure service. For example, the on-demand self-service nature of cloud computing allows a cloud consumer to unilaterally provision computing capabilities, such as server time and network storage, as needed automatically without requiring human interaction with the service's provider.

The broad network access allows for capabilities to be available over a network and accessed through standard mechanisms that promote use by heterogeneous thin or thick client platforms (e.g., mobile phones, laptops, and PDAs).

Resource pooling allows the provider's computing resources to be pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity allows for capabilities to be rapidly and elastically provisioned, in some cases automatically, to quickly scale out and rapidly released to quickly scale in. To the consumer, the capabilities available for provisioning often appear to be unlimited and can be purchased in any quantity at any time.

The measured service nature of cloud computing systems allows cloud systems to automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Additionally, according to embodiments wherein the visualization portal and/or other aspects of the cyberinfrastructure include cloud computing, those aspects may utilize cloud computing in any suitable model such as but not limited to Software as a Service (SaaS), Platform as a Service (PaaS), and/or Infrastructure as a Service (IaaS).

When utilizing the SaaS model, the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

When utilizing the PaaS model, the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

When utilizing the IaaS model, the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Additionally, according to embodiments wherein the visualization portal and/or other aspects of the cyberinfrastructure include cloud computing, any suitable deployment model may be used including but not limited to a private cloud, a community cloud, a public cloud, and/or a hybrid cloud.

For embodiments using a private cloud, the cloud infrastructure is operated solely for an organization. It may be managed by the organization or a third party and may exist on-premises or off-premises.

For embodiments using a community cloud, the cloud infrastructure is shared by several organizations and supports a specific community that has shared concerns (e.g., mission, security requirements, policy, and compliance considerations). It may be managed by the organizations or a third party and may exist on-premises or off-premises.

For embodiments using a public cloud, the cloud infrastructure is made available to the general public or a large industry group and is owned by an organization selling cloud services.

For embodiments using a hybrid cloud, the cloud infrastructure is a composition of two or more clouds (private, community, or public) that remain unique entities but are bound together by standardized or proprietary technology (e.g., Technology produced or supported only by a single vendor, or operated only within a proprietary operating platform or environment) that enables data and application portability (e.g., cloud bursting for load balancing between clouds).

Additionally, according to other embodiments, the visualization portal 128 can be a mobile application and/or a desktop application that is installed and/or downloaded on a computing device such as a smartphone, desktop computer, laptop computer, smart device, and the like.

The cyberinfrastructure 122 may also include a memory unit 130. According to some embodiments, the memory unit 130 can store the instructions 134 that, when executed, may cause the cyberinfrastructure 122 to perform any of the methods and/or methodologies discussed above. The instructions 134 can also be stored, completely or at least partially, within the tangible computer-readable medium 132 and/or any other aspect of the cyberinfrastructure 122. The pipeline 126, processing system 127, and/or other aspects of the cyberinfrastructure 122 may be operationally connected to the memory unit 130 and/or to the tangible computer-readable storage medium 132 so that the pipeline 126, processing system 127, and/or other aspects of the cyberinfrastructure 122 can execute and/or perform the instructions 134.

The memory unit 130 includes, in some embodiments, a program storage area and/or data storage area. The memory unit 130 can comprise read-only memory (“ROM”, an example of non-volatile memory, meaning it does not lose data when it is not connected to a power source) or random access memory (“RAM”, an example of volatile memory, meaning it will lose its data when not connected to a power source). Nonlimiting examples of volatile memory include static RAM (“SRAM”), dynamic RAM (“DRAM”), synchronous DRAM (“SDRAM”), etc. Examples of non-volatile memory include electrically erasable programmable read only memory (“EEPROM”), flash memory, hard disks, SD cards, etc. In some embodiments, a processing unit, such as a processor, a microprocessor, or a microcontroller, is connected to the memory unit 234 and executes software instructions that are capable of being stored in a RAM of the memory unit 234 (e.g., during execution), a ROM of the memory unit 234 (e.g., on a generally permanent basis), or another non-transitory computer readable medium such as another memory or a disc.

The cyberinfrastructure 122 may also include a tangible computer-readable storage medium 132. According to some embodiments, the tangible computer-readable storage medium 132 can store the instructions 134 that, when executed, may cause the cyberinfrastructure 122 to perform any of the methods and/or methodologies discussed above. The instructions 134 can also be stored, completely or at least partially, within the memory unit 130 and/or any other aspect of the cyberinfrastructure 122. The pipeline 126, processing system 127, and/or other aspects of the cyberinfrastructure 122 may be operationally connected to the tangible computer-readable storage medium 132 so that the pipeline 126, processing system 127, and/or other aspects of the cyberinfrastructure 122 can execute and/or perform the instructions 134. The memory unit 130, pipeline 126, and/or processing system 127 can also constitute tangible computer-readable storage media.

In communications and computing, a computer readable medium is a medium capable of storing data in a format readable by a mechanical device. The term “non-transitory” is used herein to refer to computer readable media (“CRM”) that store data for short periods or in the presence of power such as a memory device.

One or more embodiments described herein can be implemented using programmatic modules, engines, or components. A programmatic module, engine, or component can include a program, a sub-routine, a portion of a program, or a software component or a hardware component capable of performing one or more stated tasks or functions. A module or component can exist on a hardware component independently of other modules or components. Alternatively, a module or component can be a shared element or process of other modules, programs, or machines.

Generally, a non-transitory computer readable medium operates under control of an operating system stored in memory. The non-transitory computer readable medium implements a compiler which allows a software application written in a programming language such as COBOL, C++, FORTRAN, or any other known programming language to be translated into code readable by the central processing unit. After completion, the central processing unit accesses and manipulates data stored in the memory of the non-transitory computer readable medium using the relationships and logic dictated by the software application and generated using a compiler.

In at least one embodiment, the software application and the compiler are tangibly embodied in the computer-readable medium 132. When the instructions are read and executed by the non-transitory computer readable medium, the non-transitory computer readable medium performs the steps necessary to implement and/or use the present disclosure. A software application, operating instructions, and/or firmware (semi-permanent software programmed into read-only memory) may also be tangibly embodied in the memory unit 132 and/or data communication devices, thereby making the software application a product or article of manufacture according to the present disclosure.

Dedicated hardware implementations including, but not limited to, application specific integrated circuits, programmable logic arrays, and/or other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

While the tangible computer-readable storage medium 132 is shown in the embodiment of FIG. 5 to be a single medium, the term “tangible computer-readable storage medium” should be taken to include a single medium or multiple media (e.g., a centralized or distributed database, and/or associated caches and servers) that can store the one or more sets of instructions 134. The term “tangible computer-readable storage medium” shall also be taken to include any non-transitory medium that is capable of storing or encoding a set of instructions for execution by the cyberinfrastructure 122 and that causes the cyberinfrastructure 122 to perform any one or more of the methods of the present disclosure.

In some embodiments, artificial intelligence can be used in one or more aspects. The one or more mobile system data based model, the one or more satellite data based model, aspects of the MDF framework, and/or aspects of LCA can include and/or be trained using artificial intelligence (AI). AI is intelligence embodied by machines, such as computers and/or processors. While AI has many definitions, AI can be defined as utilizing machines and/or systems to mimic human cognitive ability such as decision-making and/or problem solving. AI has additionally been described as machines and/or systems that are capable of acting rationally such that they can discern their environment and efficiently and effectively take the necessary steps to maximize the opportunity to achieve a desired outcome. Goals of AI can include but are not limited to reasoning, problem-solving, knowledge representation, planning, learning, natural language processing, perception, motion and manipulation, social intelligence, and general intelligence. AI tools used to achieve these goals can include but are not limited to searching and optimization, logic, probabilistic methods, classification, statistical learning methods, artificial neural networks, machine learning, and deep learning.

In some embodiments, machine learning can be used in one or more aspects. The one or more mobile system data based model, the one or more satellite data based model, aspects of the MDF framework, and/or aspects of LCA can include and/or be trained using machine learning. Machine learning is a subset of artificial intelligence. Machine learning aims to learn or train via training data in order to improve performance of a task or set of tasks. A machine learning algorithm and/or model can be developed such that it can be trained using training data to ultimately make predictions and/or decisions. Machine learning can include different approaches such as supervised learning, unsupervised learning, semi-supervised learning, reinforcement learning, and dimensionality reduction as well as other types. Supervised learning models are trained using a training data that includes inputs and the desired output. This type of training data can be referred to as labeled data wherein the output provides a label for the input. The supervised learning model will be able to develop, through optimization or other techniques, a method and/or function that is used to predict the outcome of new inputs. Unsupervised learning models take in data that only includes inputs and engage in finding commonalities in the inputs such as grouping or clustering of aspects of the inputs. Thus, the training data for unsupervised learning does not include labeling and/or classification. Unsupervised learning models can make decisions for new data based on how alike or similar it is to existing data and/or to a desired goal. Examples of machine learning models include but are not limited to artificial neural networks, decision trees, support-vector machines, regression analysis, Bayesian networks, and genetic algorithms. Examples of potential applications of machine learning include but are not limited to image segmentation and classification, ranking, recommendation systems, visual identity tracking, face verification, and speaker verification.

In some embodiments, deep learning can be used in one or more aspects. The one or more mobile system data based model, the one or more satellite data based model, aspects of the MDF framework, and/or aspects of LCA can include and/or be trained using deep learning. Deep learning is a subset of machine learning that utilizes a multi-layered approach. Examples of deep learning architectures include but are not limited to deep neural networks, deep belief networks, deep reinforcement learning, recurrent neural networks, and convolutional neural networks. Examples of fields wherein deep learning can be successfully applied include but are not limited to computer vision, speech recognition, natural language processing, machine translation, bioinformatics, medical image analysis, and climate science. Deep learning models are commonly implemented as multi-layered artificial neural networks wherein each layer can be trained and/or can learn to transform particular aspects of input data into some sort of desired output.

In some embodiments, parallel computing can be used in one or more aspects. The MDF framework and/or LCA can include the use of parallel computing. Parallel computing (or “parallelism”) refers to the practice of executing multiple computations, calculations, processes, applications, and/or processors simultaneously. Parallel computing can increase the speed and efficiency of performing computational tasks and can increase the power efficiency of computers and/or systems. Examples of forms of parallel computing include but are not limited to bit-level parallelism, instruction-level parallelism, data parallelism, and task parallelism.

In some embodiments, GPU-based computing can be used in one or more aspects. The MDF framework and/or LCA can include the use of GPU-based computing. GPU-based computing refers to the practice of using a graphics processing unit (GPU) simultaneously with one or more central processing units (CPUs) and/or GPUs. GPU-based computing allows for a sort of parallel processing between the GPU and the one or more CPUs and/or GPUs such that the GPU can take on some of the computational load to increase speed and efficiency. Additionally, GPUs commonly have a much higher number of processing cores that a traditional CPU, which allows a GPU to be able to process pictures, images, and/or graphical data faster than a traditional CPU.

Therefore, as understood from the present disclosure, the methodology disclosed herein provides for the ability to quickly, effectively, efficiently, and cost-effectively quantify implications and/or footprints of carbon, water, and/or nutrients of a particular crop in an agricultural region on a large scale and at field-level. These types of derived quantifications can be used by scientists, governments, heads of industry, and others to better understand the impact that particular crops and/or management practices can have on the environment. Additionally, the disclosed methods and/or techniques, which include an observation-constrained modeling platform, also enable hypothetical scenario assessment of the impacts of different field management practices and/or climate change scenarios on crop production and/or environmental sustainability.

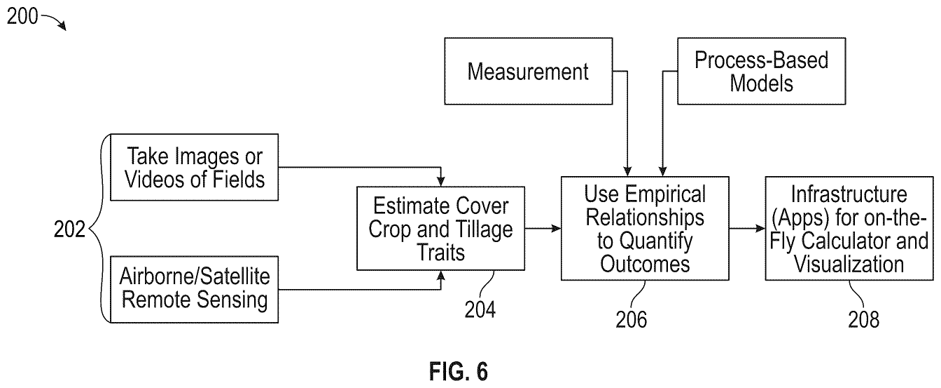

FIG. 6 shows a flow chart of a method 200 used to predict, calculate, quantify, and/or visualize cover crop traits, tillage practices, their outcomes, and/or their predicted outcomes. The term “outcomes”, as used herein, can refer to actual and/or predicted outcomes. The method 200 of FIG. 6 can be used for any suitable area and/or region such as an agricultural field, rangeland, pastureland, and the like. The first step 202 of the method of FIG. 6 includes acquiring one or more images and/or one or more videos/video clips/seconds of video footage of an agricultural field. The terms “video” and/or “videos” can be used throughout this disclosure to refer to video clips, video footage, seconds of video footage, and/or any other terms and/or phrases used to refer to video.

In some embodiments, this first step 202 can include acquiring one or more images and/or one or more videos via a handheld device. Any type of handheld device capable of capturing an image and/or a video such as a camera and/or optical sensor can be used. This includes but is not limited to the use of any kind of optical sensor, a mobile phone, a laptop, a camera (digital or otherwise), an Internet-of-Things (IoT) camera, a video camera and/or camcorder, an in-situ installed camera, and/or any kind of device that includes a camera. In some aspects and/or embodiments, this first step 202 of acquiring one or more images and/or one or more videos can also include capturing the one or more images and/or one or more videos via a mobile vehicle which can include ground vehicles such as but not limited to an automobile, a truck, a tractor, an all-terrain vehicle (ATV), an agricultural vehicle, and/or an agricultural implement just to name a few examples. The one or more images and/or one or more videos can also be captured via remote sensing using airborne vehicle(s) such as but not limited to a drone, an airplane, a helicopter, a hot-air balloon, and/or a hang-glider just to name a few examples. Additionally, the one or more images and/or one or more videos can be captured via remote and/or satellite sensing using a satellite.

If a handheld and/or stationary device is used to capture the one or more images and/or one or more videos, the handheld and/or stationary device can be oriented straight up, tilted, or oriented in any other manner with relation to an agricultural field when capturing the one or more images and/or one or more videos of said agricultural field.

The captured one or more images and/or one or more videos can include a global positioning system (GPS) tag such that aspects of the disclosed system(s), method(s), and/or apparatus(es) can recognize and know the exact location where the one or more images and/or one or more videos were captured.

The second step 204 of the method shown in FIG. 6 includes estimating cover crop traits and/or tillage practices. According to some embodiments, this step 204 includes using a geometric calibration procedure to obtain view zenith angle (the angle between viewing direction and nadir direction) for one or more pixels of the one or more images and/or one or more videos. By obtaining the view zenith angle for the one or more pixels, multi-angular information can be obtained for each image and/or video of the one or more images and/or one or more videos.

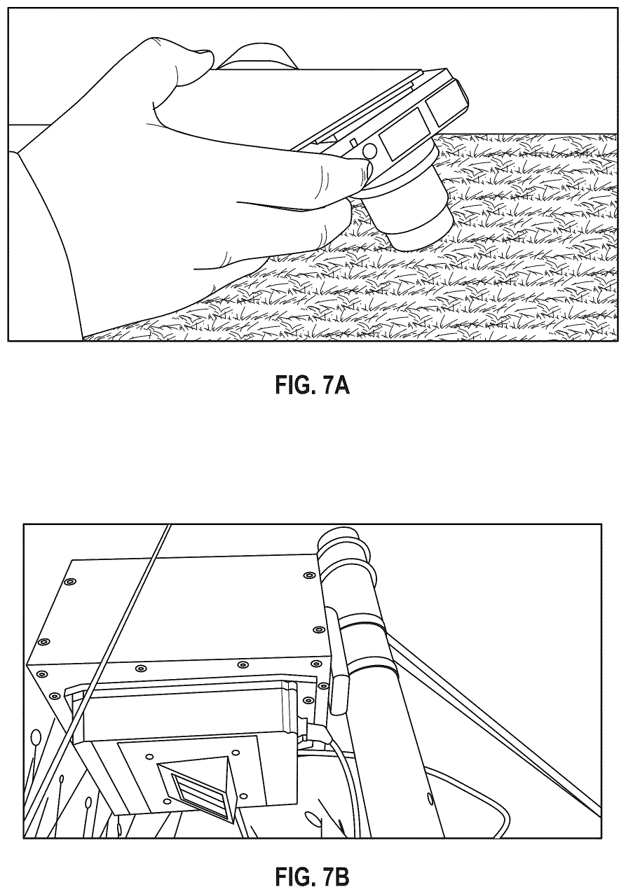

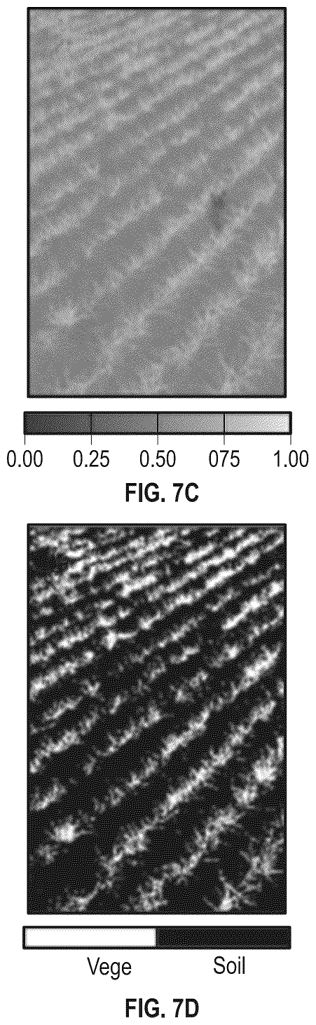

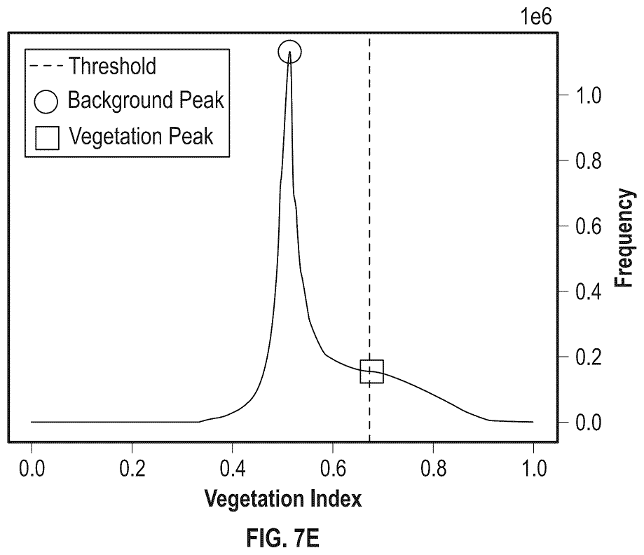

FIGS. 7A and 7B show examples of differing ways in which the one or more images and/or one or more videos can be captured. For example, FIG. 7A shows a user capturing the one or more images and/or one or more videos using a handheld camera. As is shown in FIG. 7A, a leveling device can be used in conjunction with the camera to perform the geometric calibration feature wherein the camera is properly tilted such that it captures image(s) and/or video(s) wherein multi-angular information can be obtained from each image. Additionally, FIG. 7B shows an in-situ installed camera being used to capture the one or more images and/or one or more videos. The camera portion of the device shown in FIG. 7B is seen toward the bottom of the device and is tilted to perform the geometric calibration procedure wherein the camera is properly tilted such that it captures image(s) and/or video(s) wherein multi-angular information can be obtained from each image. While, according to some embodiments, this geometric calibration is manually performed by a user at the time image(s) and/or video(s) are captured, the geometric calibration can also be performed automatically by the method(s), system(s), and/or apparatus(es) disclosed herein without user intervention and/or effort.

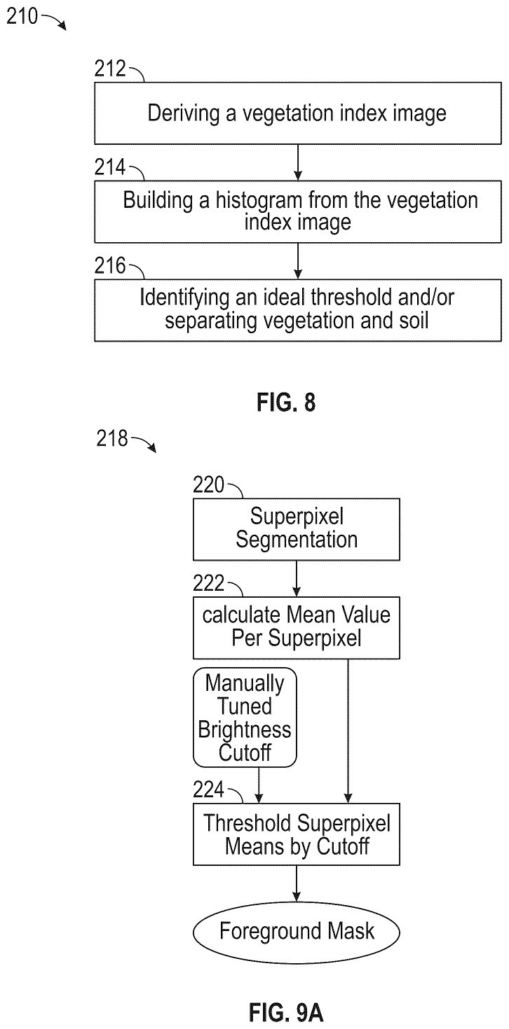

Referring back to FIG. 6, according to some embodiments, the second step 204 can also include using a cover crop image segmentation algorithm 210 to process the one or more images and/or one or more videos in order to estimate and/or derive cover crop traits such as cover crop biomass, cover crop height, cover crop density, cover crop leaf-area-index, and the like. An example cover crop image segmentation algorithm 210 is shown in FIG. 8. According to some embodiments, computer vision can be used to process the one or more images and/or one or more videos. According to some embodiments, proprietary intellectual property known as the CropEye theory and/or as CropEyes can be used to process the one or more images and/or one or more videos in order to estimate and/or derive cover crop traits such as cover crop biomass, cover crop height, cover crop density, cover crop leaf-area-index, and the like. The CropEye theory and/or CropEyes is disclosed in U.S. Patent Application No. 63/262,273, which is hereby incorporated by reference in its entirety. According to some embodiments, empirical estimated relationships can be used to process the one or more images and/or one or more videos in order to estimate and/or derive cover crop traits such as cover crop biomass, cover crop height, cover crop density, cover crop leaf-area-index, and the like. According to some embodiments, any combination of the cover crop image segmentation algorithm 210, computer vision, CropEyes, and/or empirical estimated relationships can be used to process the one or more images and/or one or more videos and to estimate and/or derive cover crop traits such as cover crop biomass, cover crop height, cover crop density, cover crop leaf-area-index, and the like.

The cover crop image segmentation algorithm 210 can have three steps. As shown in FIG. 8, the first step 212 of the cover crop image segmentation algorithm 210 can include deriving a vegetation index image from the one or more images and/or one or more videos that were originally captured. In the derived vegetation index image, vegetation (i.e., foreground) has high values and background (i.e., soil) has low values. An example of a vegetation index image can be seen in FIG. 7C which shows vegetation having higher values and background having lower values. The vegetation index image can be illustrated, colored, and/or color coded according to the values of the content of the vegetation index image. For example, as shown in FIG. 7C, vegetation in the image is shown as being more lightly shaded which corresponds to a relatively high value (in this case 1.0), and the background is shown as being more darkly shaded which corresponds with relatively lower values (in this case 0.00-0.75). While FIG. 7C is shown via a grey scale, according to some embodiments a vegetation index image can include color and/or can be color coded. For example, provisional patent application U.S. Ser. No. 63/369,198 filed Jul. 22, 2022, which is incorporated herein in its entirety, includes a colored vegetation index image. Therefore, based on the differentiation of shading in the vegetation index image, it can be seen which aspects of the image are vegetation and which are background. While a 0.00-1.00 scale is used to show value in the example vegetation index image shown in FIG. 7C, any suitable scale could be used. For example, the scale could range from 0-50, 0-100, or 0-1000 just to provide some examples. Additionally, any other color scheme could be used. The grey-scale color scheme and/or shading of FIG. 7C is provided simply as an example.

As shown in FIG. 8, the second step 214 of the cover crop image segmentation algorithm 210 can include building a histogram, and/or any other suitable type of graphical representation, based on the vegetation index image. An example of such a histogram according to some embodiments is shown in FIG. 7E. As is shown in FIG. 7E, the histogram can plot vegetation index, from the vegetation index image, on one axis and frequency on the other axis. Thereby, one or more peaks can be detected. As shown in FIG. 7E, the one or more peaks can include one or more background peaks and/or one or more vegetation peaks. For example, the circular datapoint in FIG. 7E represents the background peak and the square datapoint in FIG. 7E represents the vegetation peak. While only one background peak and one vegetation peak are shown in FIG. 7E, more than one of each type of peak can be identified.

As shown in FIG. 8, the third step 216 of the cover crop image segmentation algorithm 210 can include identifying an ideal threshold value and/or separating vegetation (i.e., foreground) and background (i.e., soil) according to that threshold value. The cover crop image segmentation algorithm 210 can automatically identify an ideal threshold value based on the vegetation index image and/or the histogram and underlying data. Additionally, according to some embodiments a threshold value can be manually set by a user. As shown in FIG. 7E, a threshold value is identified. The dotted line in FIG. 7E represents the threshold value. FIG. 7D provides an example of an image showing vegetation and background being separated according to the threshold value. FIG. 7D colors vegetation as white and colors background and/or soil as black. While white and black are used in FIG. 7D, any other colors could be used. Additionally, any other suitable method other than colored images and/or videos can be used to represent separation of vegetation and background. Once the cover crop image segmentation algorithm 210 has been performed on the one or more images and/or one or more videos that were originally captured, the one or more images and/or one or more videos can be referred to as the one or more segmented images and/or one or more segmented videos. After the cover crop image segmentation algorithm 210 has been performed, a radiative transfer algorithm can be used to quantify canopy structure of vegetation and/or cover crops.

Referring back to FIG. 6, according to some embodiments, the second step 204 can further include estimating canopy gap fractions for different view zenith angles using the one or more segmented images and/or one or more segmented videos. A canopy gap fraction is the ratio of background (soil) pixel number to total pixel number. The measurement approaches for analysis of a canopy gap fraction and/or canopy structure can be based on the Beer-Lamber Law. Assuming that the plant leaves are randomly distributed, the attenuation of beam light by vegetation canopy in a specific direction is represented by the following equation:

$${P}_{0} ( θ ) = {e}^{- k ( θ ) {L}_{e}} = {e}^{- \frac{G ( θ ) {L}_{e}}{cos cos θ}}$$

The above equation can be referred to throughout the present disclosure as Equation 2. P₀(θ) is the probability that the light has 0 contact with the vegetation canopy, i.e., gap fraction, at the view zenith angle (VZA) θ, k(θ) is the light extinction coefficient, G(θ) is the ratio of the projected leaf area on a plane perpendicular to the view direction to the leaf area, Lₑ is the effective leaf area index.

Effective leaf area index Lₑ can then be represented by the following equation:

$${L}_{e} = 2 {{\int }_{0}}^{π / 2} - ln {P}_{0} ( θ ) cos θ sin θ d θ$$

The above equation can be referred to throughout the present disclosure as Equation 3. Symbols present in Equation 3 that are also present in Equation 2 represent the same values as in Equation 2. P₀(θ) is the probability that the light has 0 contact with the vegetation canopy, i.e., gap fraction, at the VZA θ.

With spatial sampling, true leaf area index is represented by the following equation:

$$L = 2 {{\int }_{0}}^{π / 2} - \overline{ln {P}_{0} ( θ )} cos θ sin θ d θ$$

The above equation can be referred to throughout the present disclosure as Equation 4. Symbols present in Equation 4 that are also present in Equation 2-3 represent the same values as in those equations. P₀(θ) is the probability that the light has 0 contact with the vegetation canopy, i.e., gap fraction, at the VZA θ.

Leaf projection function (G(θ)) is represented by the following equation:

$$G ( θ ) \frac{\overline{- ln {P}_{0} ( θ ) cos θ}}{L}$$

The above equation can be referred to throughout the present disclosure as Equation 5. Symbols present in Equation 5 that are also present in any of Equations 2-4 represent the same values as in those equations. P(θ), as shown in Equation 5 is equivalent to P₀(θ) as shown in equations 2-4. P(θ) and/or P₀(θ) is the probability that the light has 0 contact with the vegetation canopy, i.e., gap fraction, at the VZA θ. L is true leaf area index.

### Average Leaf Area Index α is Represented by the Following Equation:

$$α = {C}_{0} + {C}_{1} \frac{\partial G}{\partial θ} + {{C}_{2} ( \frac{\partial G}{\partial θ} )}^{2} + {{C}_{3} ( \frac{\partial G}{\partial θ} )}^{3} + {{C}_{4} ( \frac{\partial G}{\partial θ} )}^{4} + {{C}_{5} ( \frac{\partial G}{\partial θ} )}^{5}$$

The above equation can be referred to throughout the present disclosure as Equation 6. Symbols present in Equation 6 that are also present in any of Equations 2-5 represent the same values as in those equations. G(θ) is the ratio of the projected leaf area on a plane perpendicular to the view direction θ to the leaf area. C0-C5 are six constant values calculated by fitting leaf projection function (G(θ)) as a function of θ using different 0 range.

### Apparent Clumping Index Ω is Represented by the Following Equation:

$$Ω = \frac{{{\int }_{0}}^{π / 2} - ln \overline{{P}_{0} ( θ )} cos θ sin θ d θ}{{{\int }_{0}}^{π / 2} - \overline{ln {P}_{0} ( θ )} cos θ sin θ d θ}$$

The above equation can be referred to throughout the present disclosure as Equation 7. Symbols present in Equation 7 that are also present in any of Equations 2-6 represent the same values as in those equations. P₀(θ) is the probability that the light has 0 contact with the vegetation canopy, i.e., gap fraction, at the VZA θ.

From images captured via cameras, a per-pixel binary classification is conducted in which foreground is vegetation and background is sky or soil. The gap fraction P(θ) can therefore be calculated as the ratio of the number of vegetation pixels to the number of total vegetation pixels. Subsequently, leaf area index L, average leaf angle α, and apparent clumping index Ω are calculated using Equations 4, 6 and 7, respectively.

Based on the above equations and/or calculations, the method 200 of FIG. 6 can estimate and/or derive cover crop traits such as cover crop biomass, cover crop height, cover crop density, cover crop leaf-area-index, and the like.

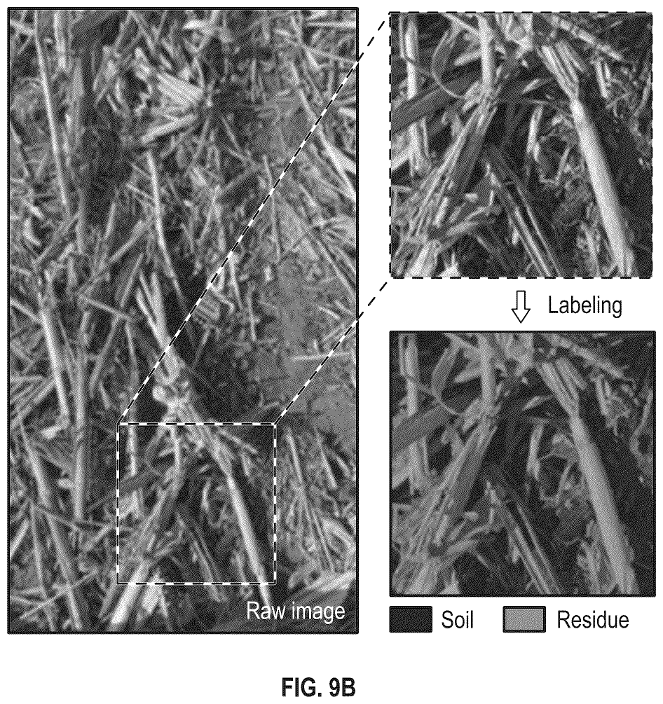

In addition to estimating and/or deriving cover crop traits, the second step 204 of the method of FIG. 6 can also include estimating and/or deriving tillage conditions, traits, and/or practices such as crop residue coverage on the field, crop tillage types, and the like. Throughout the present disclosure the terms “tillage conditions”, “tillage traits”, and/or “tillage practices” can be used interchangeably. Additionally, the term “tillage practices” is meant to encompass “tillage traits, tillage conditions, and/or tillage practices” throughout the present disclosure. Just as described above in reference to image/video processing related to cover crop traits, the one or more images and/or one or more videos can be processed to estimate tillage conditions, traits, and/or practices. Just as above, CropEyes, computer vision technology and/or methodologies, empirical estimated relationships, any or all aspects of the method 218 of FIG. 9A, and/or any combination thereof can be used to process the one or more images and/or one or more videos that were originally captured to estimate and/or derive tillage conditions, traits, and/or practices. While any suitable approach to processing the one or more images and/or one or more videos can be used, an example of an approach according to some aspects and/or embodiments is shown in FIG. 9A.

FIG. 9A shows a flow chart of an example of an approach 218 to derive a crop residue fraction and/or to derive tillage condition, traits, and/or practices such as tillage time, according to at least one aspect and/or embodiment disclosed herein. The approach can include three steps according to some embodiments. The first step 220 of the approach 218 can include the use of a superpixel segmentation algorithm. This superpixel segmentation algorithm can be Felzenszwalb's method and/or any other suitable segmentation method. The superpixel segmentation algorithm can be used to partition pixels of the one or more images and/or one or more videos into superpixels. Superpixels are units that only cover a single object in the one or more images and/or one or more videos, however, a single object can contain one or more superpixels. The second step 222 of the approach 218 can include calculating the mean RGB (red, green, and blue value) of each superpixel. An RGB value defines the red, green, and blue intensity of an image, a portion of an image, a pixel, and/or in some embodiments a superpixel. The third step 224 of the approach 218 can include selecting a boundary threshold that separates the average values of background (e.g., soil) and foreground (e.g., residue) superpixels. As shown in FIG. 9A, the boundary threshold can manually be selected by a user. Additionally, according to some embodiments, the threshold boundary can be automatically selected by the approach 218. Further, as shown in FIG. 9A, a final residue mask is generated by the approach 218 by selecting and/or labeling superpixels that are on the appropriate side of the threshold boundary, either background (soil) or foreground (residue).

As compared to simple thresholding, the above approach 218 significantly reduces noise by incorporating object structure by using superpixels. Additionally, the approach 218 significantly increases the speed of labeling compared to other manual marking approaches in the art such as marking every foreground pixel and/or drawing a foreground boundary. The massive increase in the volume of labeled data is sufficient to compensate for the loss of detailed structures as compared with pixel-wise labeling techniques.

FIG. 9B shows a group of photographs illustrating at least a portion of the method of FIG. 9A according to at least one aspect and/or embodiment disclosed herein. For example, FIG. 9B shows a raw image, i.e., one of the one or more images and/or one or more videos originally captured. FIG. 9B then shows how the originally captured raw image is processed to result in labeling soil (background) versus residue (foreground). In the labeled image shown in the bottom right portion of FIG. 9B, background (soil) is colored as a darker shade of grey and/or as black and foreground (residue) is colored as a lighter shade of grey and/or as white. However, any color scheme may be used. Additionally, any form of labeling and/or visualization may be used. In this way, the method of FIG. 6 can estimate and/or derive tillage conditions, traits, and/or practices such as crop residue coverage on the field, crop tillage types, and the like.

Referring back to FIG. 6, the third step 206 of the method 200 can include using empirical relationships to quantify soil, crop and/or agroecosystem outcomes. According to some embodiments, this step 206 can include making measurements and applying those measurements. According to some embodiments, this step 206 can include developing and/or applying one or more process-based models and/or empirical, statistical, and/or machine learning models. The term “process-based models” can include process-based models, empirical models, statistical models, and/or machine learning models throughout the present disclosure.

The third step 206 of the method 200 can involve using cover crop traits, such as cover crop biomass, to estimate and/or quantify soil, crop, and/or agroecosystem outcomes such as soil carbon sequestration, nutrient loss reduction, and/or crop yield just to name a couple examples. One or more process-based models can be used to convert cover crop traits, such as cover crop biomass information, to soil, crop, and/or agroecosystem outcomes. These one or more process-based models can be referred to as cover crop process-based model(s). Simulations can be performed using the one or more process-based models based on cover crop traits. One such process-based model that can be used is the ecosys model. The ecosys model is known in the art and has been intensively validated for carbon, nutrient, and water cycles at many different types of sites having differing soil and weather conditions. The ecosys model uses well-tested algorithms for carbon cycle processing that are highly consistent across wide ranging weather conditions.

Validation of cover crop biomass can help to assure accuracy in outcome estimation and largely reduces the uncertainty in simulating soil outcomes from cover crops because carbon benefits due to the use of cover crops are highly correlated with cover crop biomass. Thus, cover crop biomass can be further calibrated for accurate field level simulation. According to some embodiments, cover crop plant function types can be further calibrated for accurate field level simulation.

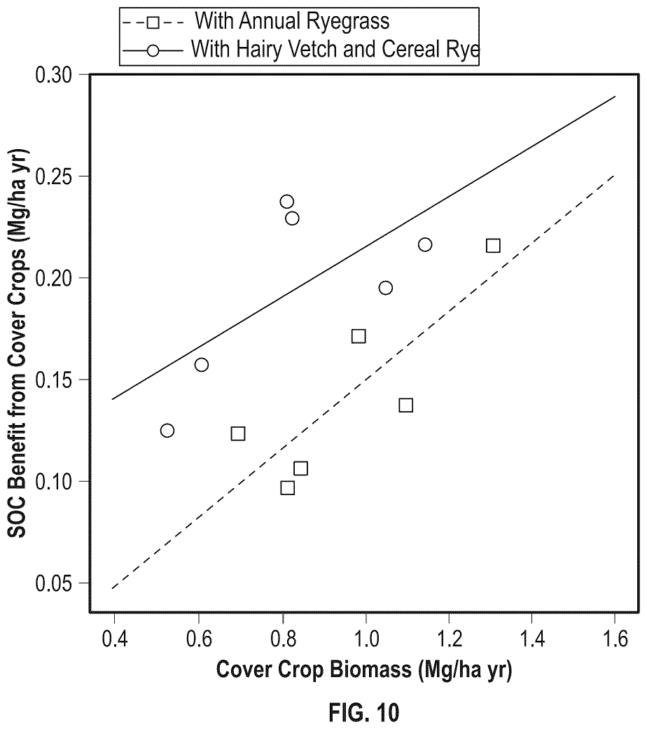

FIG. 10 provides a graphical representation illustrating an example of the correlation between cover crop biomass and SOC benefits from cover crops. The graphical representation of FIG. 10 shows a simulation performed by ecosys at six cover crop field experiment sites in Illinois, USA from 2013-2018. The SOC benefits plotted along the vertical axis represent the difference of SOC stock between cover crop rotations and no cover crop rotations. The square dots and dotted line represent the scenario wherein annual ryegrass is used as a cover crop. The circular dots and solid line represent the scenario wherein hairy vetch and cereal rye is used as a cover crop.

Referring back to FIG. 6, according to some embodiments, the third step 206 of the method 200 can include providing input to drive a process-based model such as the ecosys model. This input to the ecosys model can include soil properties, weather data, and/or management information. Soil properties can be obtained via the Gridded Soil Survey Geographic Database (gSSURGO database) which provides detailed geographic soil data and is available on the website of the United States Department of Agriculture (USDA). Weather data can be obtained via the North American Land Data Assimilation System Phase 2 (NLDAS-2) which provides land-surface model datasets and is available on the website of the National Aeronautics and Space Administration (NASA). Management data can be obtained according to aspects of the disclosure above related to estimating tillage conditions, traits, and/or practices according to at least the second step 204 of the method 200 as well as at least FIGS. 6, 9A, and 9B.

According to some embodiments, the third step 206 of the method 200 can include validating the ecosys model using observed cover crop biomass data by calibrating cover crop plant function types such as maturity group, photosynthetic capacity, and the like. The observed cover crop biomass data can be obtained according to aspects of the disclosure above related to estimating cover crop traits according to at least the second step 204 of the method 200 as well as at least FIGS. 6, 7A-E, and 8. The third step 206 can also include assessing outcomes of cover crops with the ecosys model, and/or a similar model, by comparing a simulation of cover crop scenarios with a baseline scenario using the calibrated crop plant function types wherein the baseline scenario is and/or includes a hypothesized, expected, and/or business-as-usual scenario.

According to some embodiments, the third step 206 can include developing a cover crop surrogate model for the ecosys model through an AI, machine learning, and/or deep learning approach by building a relationship between cover crop biomass information and soil organic carbon (SOC) benefits from cover crop adoption with other environmental and/or agricultural, management, and/or conservation factors serving as input into the cover crop surrogate model. Agricultural, management, and/or conservation factors can include but are not limited to cover crop types, cover crop growth period, weather information, initial soil conditions, and the like. The cover crop surrogate model can be trained and/or validated with observed cover crop biomass information and simulated soil, crop, and/or agroecosystem outcomes performed by the ecosys model in different locations, with varying soil conditions, weather conditions, and/or agricultural, management, and/or conservation practices. After the cover crop surrogate model is trained and/or validated, the cover crop surrogate model can be used to assess cover crop outcomes such as soil, crop, and/or agroecosystem outcomes. These outcomes can be crop and/or species dependent. These outcomes can include but are not limited to soil carbon sequestration, nitrogen uptake by cover crop, nutrient loss reduction, cash crop yield, and/or other outcomes related to carbon, water, and/or nutrient variables. Additional data can be continuously input into the cover crop surrogate model wherein the surrogate model can continuously learn and/or train, which will continue to improve the accuracy and effectiveness of the model. For example, farmers and any other users of the cover crop surrogate model can continually train the model by capturing additional images and/or videos of agricultural fields and inputting them into the model to quantify outcomes.

By using the cover crop surrogate model, the computational costs of assessing and/or quantifying outcomes is reduced in comparison to other approaches known in the art. Therefore, the cover crop surrogate model and/or the method 200 can be up-scaled much faster and easier than approaches known in the art such that the cover crop surrogate model and/or the method 200 can assess and/or quantify cover crop outcomes on a large scale such as at a pixel-level, field-level, county-level, state-level, region-level, and/or nation-level scale.

According to some embodiments, the third step 206 can include estimating and/or quantifying outcomes such as soil carbon and yield based on derived tillage conditions, traits, and/or practices as well as derived crop residue information such as crop residue fraction and/or tillage residue coverage.

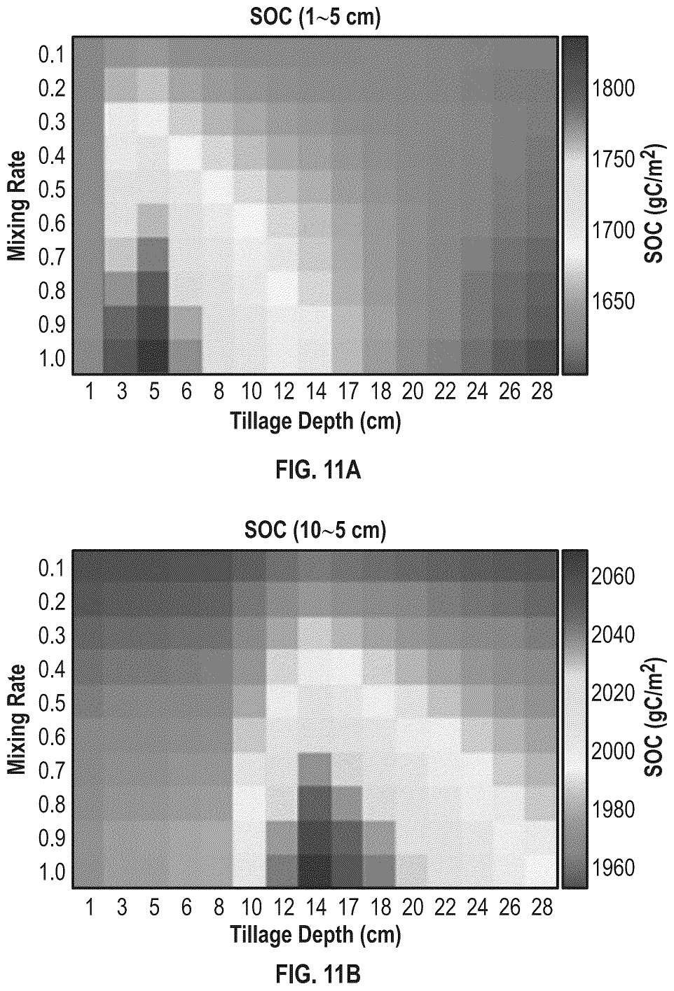

The crop residue fraction, also referred to as the residual fraction and/or tillage intensity herein, in an agricultural field can affect the energy and water balance processes within the bare soil surface and surface residuals, the gas exchange between soil layers and atmosphere, the biogeochemical processes in the soil, and/or the effects of precipitation or wind on soil detachment. The residual fraction can have other effects on the soil. For example, the effects of the residual fraction on soil biogeophysical and/or biogeographical processes will affect the soil warming up and/or the nitrogen and/or phosphorous availability in the soil at early stages in the growing season, which will ultimately affect crop production and other outcomes. The residual fraction and/or tillage time traits derived from the one or more images and/or one or more videos during the second step 204 of the method 200 of FIG. 6 can be used as inputs to train one or more process-based tillage models. The process-based tillage model(s) and process-based cover crop model(s) can be incorporated into one model and/or can be separate models. According to some embodiments, the process-based tillage model(s) can be an ecosys model. This process-based tillage model(s) can mix soil conditions, residual fractions, and/or surface residuals within a tillage zone. The process-based tillage model(s) can perform simulations to quantify the impact of the residual fraction on crop production, soil organic carbon vertical distribution and dynamics, soil erosion, nitrogen leaching, phosphorous leaching, and the like. For example, FIGS. 11A and 11B show graphical representations illustrating simulated SOC based on ecosys process-based model simulation(s) under different tillage depths and mixing rates for fields in Illinois, USA. For both of FIGS. 11A and 11B, data from 1979-1999 is used for developing the model and data from 2000-2018 is used for sensitivity analysis. The graphical representation of FIG. 11A shows data for a soil depth of 1-5 cm, and the graphical representation of FIG. 11B shows data for a soil depth of 10-15 cm.

Referring back to FIG. 6, according to some embodiments, the third step 206 of the method 200 of FIG. 6 can also include developing and/or training a surrogate model for tillage-related outcomes in a similar manner as the surrogate model for cover crop related outcomes is developed. The tillage-related surrogate model and the cover crop surrogate model can be incorporated into one model and/or can be separate models. This tillage-related surrogate model can be developed via AI, machine learning, and/or deep learning by building a relationship between tillage conditions and soil, plant, and/or agroecosystem outcomes with other environmental and/or agricultural, management, and/or conservation practices as input. The tillage-related surrogate model can be used to assess cover crop outcomes such as soil, crop, and/or agroecosystem outcomes. These outcomes can be crop and/or species dependent. The agricultural, management, and/or conservation practices can include cover crop types, cover crop growth period, weather conditions, initial soil conditions, and the like. Additional data can be continuously input into the tillage-related surrogate model wherein the surrogate model can continuously learn and/or train, which will continue to improve the accuracy and effectiveness of the model. For example, farmers and any other users of the tillage-related surrogate model can continually train the model by capturing additional images and/or videos of agricultural fields and inputting them into the model to quantify outcomes.

Additionally, just as the cover crop-related surrogate model allows for less computational costs and the ability to be scaled-up and applied on a large scale, the tillage-related surrogate model allows for the same and can be applied on a large scale such as a pixel-level, field-level, county-level, state-level, region-level, and/or nation-level scale.

Any of the techniques and/or methodologies described herein related to cover crop modeling and/or tillage practice modeling and outcome quantification can be applied to the other. For example, any techniques and/or methodologies mentioned for use with cover crop modeling can also be used with tillage practice modeling and vice versa.

The fourth step 208 of the method 200 of FIG. 6 can include calculating and/or visualizing soil, crop, agroecosystem outcomes, and/or predicted outcomes, on-the-fly using a software application. These on-the-fly calculations, visualizations, and/or quantifications can be used to estimate soil carbon benefits and/or soil carbon credits. In a sense, the method 200 can act as an on-the-fly calculator. The fourth step 208 can include allowing a user, such as a farmer, to capture image(s) and/or video(s) and enter said image(s) and/or video(s) as input into the software application. Said image(s) and/or video(s) can be input via uploading onto the software application, copying, emailing, direct link (wired and/or wireless), and/or any other suitable approach known in the art to input image(s) and/or video(s) into a software application. The software application can then manipulate the image(s) and/or video(s) according to the steps of the method 200 described herein. This can include processing the image(s) and/or video(s) to estimate cover crop traits and/or tillage conditions, traits, and/or practices. This can further include applying the cover crop surrogate model and/or the tillage-related surrogate to quantify outcomes. The software application can then communicate those outcomes to the user in any suitable manner such as but not limited to text, numerical, graphical, mapping, illustrative, and/or audio output. The output of the software program can include numerical data and/or graphing data regarding particular outcomes based on the image(s) and/or video(s) that were input into the software program. Additionally, mapping information can be output by the software program detailing the location(s) of particular outcomes. Additionally, the cover crop surrogate model and/or the tillage-related surrogate model can use the data input by a user, such as the image(s) and/or video(s) with and/or without corresponding GPS information, to continue to develop, train, learn, and/or improve the models. In this way, each time data, such as image(s) and/or video(s), are input into the software program and/or surrogate models, the models continue to develop, learn, train, and/or improve. Additionally, according to some embodiments, any model(s) used in conjunction with the method 200 of FIG. 6, and/or any other model(s) described herein, can be developed, trained, taught, improved, and/or optimized using field image data wherein such field image data can include, but is not limited to, any image(s) and/or video(s) related to an agricultural field, rangeland, pastureland, an area, and/or a region.

Additionally, the method 200 of FIG. 6 can be applied to other agricultural fields and/or regions to predict, estimate, and/or quantify outcomes in those fields and/or regions. Remotes sensing and/or satellite data obtained via airborne vehicle(s) and/or satellite(s) can be used when applying the method 200 to other fields and/or regions.

The outcomes, and/or predicted outcomes, that are calculated, quantified, and/or visualized via the method 200 of FIG. 6, and/or any other outcomes and/or predicted outcomes described herein, can include, but are not limited to, sustainability metrics and/or economic metrics. Sustainability metrics can comprise, but are not limited to, information and/or data related to greenhouse gas emissions, soil carbon sequestration, water use, and/or resource use efficiency. Economic metrics can comprise, but are not limited to, information and/or data related to projected revenue from crop(s) and/or livestock, projected revenue and/or compensation from ecosystem service market(s) (such as carbon credit market(s)), and/or a market-driven premium (such as gains from sustainable labeling).

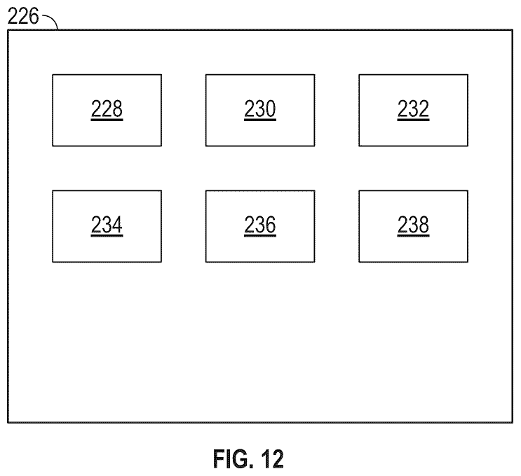

Various embodiments of the disclosure described herein include a cyberinfrastructure that can facilitate the modeling, calculations, quantifications, predictions, and/or visualizations described herein, including but not limited to any aspects of the method 200 of FIG. 6, via a software application. FIG. 12 shows an example of a cyberinfrastructure 226 according to some aspects and/or some embodiments. The cyberinfrastructure 226 may comprise a database 228, at least one processing system 230, a visualization portal 232, a memory unit 234, and/or a tangible computer-readable storage medium 236. The cyberinfrastructure 226 may include a set of instructions 238 that, when executed, may cause the cyberinfrastructure 226 to perform any of the methods and/or methodologies discussed above.

According to some embodiments, the cyberinfrastructure 226 can also include an intelligent control. The intelligent control can control and/or manipulate data stored in the database 228 such that the at least one processing system 230 can operate quickly, efficiently, and/or effectively. Additionally, the intelligent control can perform and/or execute the instructions 238 to cause the cyberinfrastructure 226 to perform any of the methods and/or methodologies discussed above. Examples of such an intelligent control may be processing units alone or other subcomponents of computing devices. The intelligent control can also include other components and can be implemented partially or entirely on a semiconductor (e.g., a field-programmable gate array (“FPGA”)) chip, such as a chip developed through a register transfer level (“RTL”) design process.

The database 228 may be a comprehensive computer database. The database 228 may be used to store and/or archive all observations and/or data or information obtained and/or generated via captured images(s) and/or video(s); soil, crop, and/or agroecosystem outcomes; environmental factors and/or agricultural, management, and/or conservation practices; and/or any other suitable information and/or data.

The database 228 can include any type of data storage cache and/or server and can refer to any kind of memory components, any kind of entities embodied in a memory component, and/or any kind of components comprising memory. It is appreciated that the database 228 can include volatile memory and/or nonvolatile memory. The database 228 can be a structured set of data typically held in a computer. The database 228, as well as data and information contained therein, need not reside in a single physical or electronic location. For example, the database 228 may reside, at least in part, on a local storage device, in an external hard drive, on a database server connected to a network, on a cloud-based storage system, in a distributed ledger (such as those commonly used with blockchain technology), or the like.

The database 228 can include the use of read-only memory (“ROM”, an example of non-volatile memory, meaning it does not lose data when it is not connected to a power source) or random access memory (“RAM”, an example of volatile memory, meaning it will lose its data when not connected to a power source). Nonlimiting examples of volatile memory include static RAM (“SRAM”), dynamic RAM (“DRAM”), synchronous DRAM (“SDRAM”), etc. Examples of non-volatile memory include electrically erasable programmable read only memory (“EEPROM”), flash memory, hard disks, SD cards, etc. In some embodiments, the processing unit, such as a processor, a microprocessor, or a microcontroller, is connected to the memory and executes software instructions that are capable of being stored in a RAM of the memory (e.g., during execution), a ROM of the memory (e.g., on a generally permanent basis), or another non-transitory computer readable medium such as another memory or a disc.

The at least one processing system 230 can include a number of processing units ranging from zero to N where N is any number greater than zero. The at least one processing system 230 can include any number of processing units such as one or more CPUs and/or GPUs and can utilize parallel computing and/or GPU-based computing as described above. With proper configurations, the cyberinfrastructure 226 can operate as a one-stop solution to perform the entire process of calculation(s), quantification(s), and/or visualization(s). By utilizing the architecture and/or computing techniques described herein, the cyberinfrastructure 226 allows for speedy, effective, and/or efficient data processing and computation.

A processing unit, also called a processor, is an electronic circuit which performs operations on some external data source, usually memory or some other data stream. Non-limiting examples of processors include a microprocessor, a microcontroller, an arithmetic logic unit (“ALU”), and most notably, a graphics processing unit (GPU), a central processing unit (“CPU”). A CPU, also called a central processor or main processor, is the electronic circuitry within a computer that carries out the instructions of a computer program by performing the basic arithmetic, logic, controlling, and input/output (“I/O”) operations specified by the instructions. Processing units are common in tablets, telephones, handheld devices, laptops, user displays, smart devices (TV, speaker, watch, etc.), and other computing devices.

The visualization portal 232 allows a user to enter inputs and/or can communicate inputs and/or outputs to a user. According to some embodiments, a user can enter inputs which can include but are not limited to identifying information of the user and/or the user's organization and/or company, location and/or name of an agricultural field, observational data with and/or without corresponding GPS information, and/or captured image(s), video(s) of an agricultural field with and/or without corresponding GPS information, and/or information related to soil, crop, and/or agroecosystem outcomes with and/or without corresponding GPS information. According to other embodiments this information and/or data can be input to the visualization portal 232 and/or other aspects of the cyberinfrastructure 226 automatically upon sensing, acquiring, and/or obtaining the data.

According to some aspects and/or embodiments, the visualization portal 232 can be physically manifested, be viewable, and/or be accessible in any suitable manner including as a smart device including but not limited to a mobile phone, tablet, computer, and the like. The visualization portal 232, physically manifested as a smart device, can include a user interface wherein a user can enter inputs, such as captured image(s) and/or video(s) of an agricultural field, and/or the visualization portal 232 can display and/or communicate outputs including but not limited to intermediate and/or final results as well as soil, crop, and/or agroecosystem outcomes that are based on the inputs. According to some embodiments, the visualization portal 232 can be implemented as a computer program and/or as a software program wherein it can be accessible by any means mentioned in this paragraph and/or by any other suitable means.

In accordance with various aspects of the embodiments of the disclosure, aspects of the methods described herein are intended for operation as software programs running on a computer processor and/or processing unit. Furthermore, software implementations can include, but are not limited to, distributed processing and/or component/object distributed processing, parallel processing, and/or virtual machine processing can also be constructed to implement aspects of the methods described herein.

A user interface is how the user interacts with a machine. The user interface can be a digital interface, a command-line interface, a graphical user interface (“GUI”), oral interface, virtual reality interface, or any other way a user can interact with a machine (user-machine interface). For example, the user interface (“UI”) can include a combination of digital and analog input and/or output devices or any other type of UI input/output device required to achieve a desired level of control and monitoring for a device. Nonlimiting examples of input and/or output devices include computer mice, keyboards, touchscreens, knobs, dials, switches, buttons, speakers, microphones, printers, LIDAR, RADAR, etc. Input(s) received by the UI can then be sent to a microcontroller and/or any type of controller to control operational aspects of a device and/or method such as the disclosed methods.

The user interface of the visualization portal 232 can include any of the above-described input/output devices and/or methods to input data and/or information into the visualization portal and/or any other aspect of the cyberinfrastructure 226. For example, methods of inputting data and/or information can include entering the data and/or information via touchscreen, via keyboard typing, via click of a computer mouse, via voice command, uploading, copying, emailing, direct link (wired and/or wireless), and/or any other suitable method disclosed herein and/or known in the prior art. Furthermore, the user interface of the visualization portal 232 can include any of the above-described input/output devices and/or methods to communicate outputs, data, and/or information such as intermediate and/or final results to the user. For example, methods of communicating output to a user can include displaying via a screen, producing audio communication, printing, and/or any other suitable method disclosed herein and/or known in the prior art.

Output data and/or information could be communicated in any form such as but not limited to text, numerical, graphical, mapping, illustrative, audio, and/or any other suitable form disclosed herein and/or known in the prior art.

The user interface can include a display, which can act as an input and/or output device. More particularly, the display can be a liquid crystal display (“LCD”), a light-emitting diode (“LED”) display, an organic LED (“OLED”) display, an electroluminescent display (“ELD”), a surface-conduction electron emitter display (“SED”), a field-emission display (“FED”), a thin-film transistor (“TFT”) LCD, a bistable cholesteric reflective display (i.e., e-paper), etc. The user interface also can be configured with a microcontroller to display conditions or data associated with the main device in real-time or substantially real-time.

According to some embodiments, the visualization portal 232 can be an online web-based portal. According to some embodiments, the portal can function as a mobile website capable of being accessed via a mobile device such as a smartphone, tablet, smart device, and the like. According to other embodiments, the visualization portal 232 can function as a traditional and/or desktop website capable of being accessed via a desktop computer, laptop computer, and the like.

The visualization portal 232 can include cloud computing. Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. A cloud computing environment is service oriented with a focus on statelessness, low coupling, modularity, and semantic interoperability. At the heart of cloud computing is an infrastructure comprising a network of interconnected nodes.

Some common characteristics of cloud computing include its on-demand self-service nature, its broad network access, resource pooling, rapid elasticity, and the ability to measure service. For example, the on-demand self-service nature of cloud computing allows a cloud consumer to unilaterally provision computing capabilities, such as server time and network storage, as needed automatically without requiring human interaction with the service's provider.

The broad network access allows for capabilities to be available over a network and accessed through standard mechanisms that promote use by heterogeneous thin or thick client platforms (e.g., mobile phones, laptops, and PDAs).

Resource pooling allows the provider's computing resources to be pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity allows for capabilities to be rapidly and elastically provisioned, in some cases automatically, to quickly scale out and rapidly released to quickly scale in. To the consumer, the capabilities available for provisioning often appear to be unlimited and can be purchased in any quantity at any time.

The measured service nature of cloud computing systems allows cloud systems to automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Additionally, according to embodiments wherein the visualization portal and/or other aspects of the cyberinfrastructure include cloud computing, those aspects may utilize cloud computing in any suitable model such as but not limited to Software as a Service (SaaS), Platform as a Service (PaaS), and/or Infrastructure as a Service (IaaS).

When utilizing the SaaS model, the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

When utilizing the PaaS model, the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

When utilizing the IaaS model, the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Additionally, according to embodiments wherein the visualization portal 232 and/or other aspects of the cyberinfrastructure 226 include cloud computing, any suitable deployment model may be used including but not limited to a private cloud, a community cloud, a public cloud, and/or a hybrid cloud.

For embodiments using a private cloud, the cloud infrastructure is operated solely for an organization. It may be managed by the organization or a third party and may exist on-premises or off-premises.

For embodiments using a community cloud, the cloud infrastructure is shared by several organizations and supports a specific community that has shared concerns (e.g., mission, security requirements, policy, and compliance considerations). It may be managed by the organizations or a third party and may exist on-premises or off-premises.

For embodiments using a public cloud, the cloud infrastructure is made available to the general public or a large industry group and is owned by an organization selling cloud services.

For embodiments using a hybrid cloud, the cloud infrastructure is a composition of two or more clouds (private, community, or public) that remain unique entities but are bound together by standardized or proprietary technology that enables data and application portability (e.g., cloud bursting for load balancing between clouds).

Additionally, according to other embodiments, the visualization portal can be a mobile application and/or a desktop application that is installed and/or downloaded on a computing device such as a smartphone, desktop computer, laptop computer, smart device, and the like.

The cyberinfrastructure 226 may also include a memory unit 234. According to some embodiments, the memory unit 234 can store the instructions 238 that, when executed, may cause the cyberinfrastructure 226 to perform any of the methods and/or methodologies discussed above. The instructions 238 can also be stored, completely or at least partially, within the tangible computer-readable medium 236 and/or any other aspect of the cyberinfrastructure 226. The at least one processing system 230 and/or other aspects of the cyberinfrastructure 226 may be operationally connected to the memory unit 234 and/or to the tangible computer-readable storage medium 236 so that the processing system 230 can execute and/or perform the instructions 238.

The memory unit 234 includes, in some embodiments, a program storage area and/or data storage area. The memory unit 234 can comprise read-only memory (“ROM”, an example of non-volatile memory, meaning it does not lose data when it is not connected to a power source) or random access memory (“RAM”, an example of volatile memory, meaning it will lose its data when not connected to a power source). Nonlimiting examples of volatile memory include static RAM (“SRAM”), dynamic RAM (“DRAM”), synchronous DRAM (“SDRAM”), etc. Examples of non-volatile memory include electrically erasable programmable read only memory (“EEPROM”), flash memory, hard disks, SD cards, etc. In some embodiments, a processing unit, such as a processor, a microprocessor, or a microcontroller, is connected to the memory unit 234 and executes software instructions that are capable of being stored in a RAM of the memory unit 234 (e.g., during execution), a ROM of the memory unit 234 (e.g., on a generally permanent basis), or another non-transitory computer readable medium such as another memory or a disc.

The cyberinfrastructure 226 may also include a tangible computer-readable storage medium 236. According to some embodiments, the tangible computer-readable storage medium 236 can store the instructions 238 that, when executed, may cause the cyberinfrastructure 226 to perform any of the methods and/or methodologies discussed above. The instructions 238 can also be stored, completely or at least partially, within the memory unit 234 and/or any other aspect of the cyberinfrastructure 226. The at least one processing system 230 and/or other aspects of the cyberinfrastructure 226 may be operationally connected to the tangible computer-readable storage medium 236 so that the at least one processing system 230 can execute and/or perform the instructions 238. The memory unit 234 and/or the at least one processing system 230 can also constitute tangible computer-readable storage media.

In communications and computing, a computer readable medium is a medium capable of storing data in a format readable by a mechanical device. The term “non-transitory” is used herein to refer to computer readable media (“CRM”) that store data for short periods or in the presence of power such as a memory device.

One or more embodiments described herein can be implemented using programmatic modules, engines, or components. A programmatic module, engine, or component can include a program, a sub-routine, a portion of a program, or a software component or a hardware component capable of performing one or more stated tasks or functions. A module or component can exist on a hardware component independently of other modules or components. Alternatively, a module or component can be a shared element or process of other modules, programs, or machines.

Generally, a non-transitory computer readable medium operates under control of an operating system stored in memory. The non-transitory computer readable medium implements a compiler which allows a software application written in a programming language such as COBOL, C++, FORTRAN, or any other known programming language to be translated into code readable by the central processing unit. After completion, the central processing unit accesses and manipulates data stored in the memory of the non-transitory computer readable medium using the relationships and logic dictated by the software application and generated using a compiler.

In at least one embodiment, the software application and the compiler are tangibly embodied in the computer-readable medium 236. When the instructions are read and executed by the non-transitory computer readable medium, the non-transitory computer readable medium performs the steps necessary to implement and/or use the present disclosure. A software application, operating instructions, and/or firmware (semi-permanent software programmed into read-only memory) may also be tangibly embodied in the memory unit 236 and/or data communication devices, thereby making the software application a product or article of manufacture according to the present disclosure.

Dedicated hardware implementations including, but not limited to, application specific integrated circuits, programmable logic arrays, and/or other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

While the tangible computer-readable storage medium 236 is shown in the embodiment of FIG. 12 to be a single medium, the term “tangible computer-readable storage medium” should be taken to include a single medium or multiple media (e.g., a centralized or distributed database, and/or associated caches and servers) that can store the one or more sets of instructions 238. The term “tangible computer-readable storage medium” shall also be taken to include any non-transitory medium that is capable of storing or encoding a set of instructions for execution by the cyberinfrastructure 226 and that cause the cyberinfrastructure 226 to perform any one or more of the methods of the present disclosure.

In some embodiments, artificial intelligence can be used in one or more aspects. The cover crop surrogate model and/or tillage-related surrogate model can include and/or be trained using artificial intelligence (AI). AI is intelligence embodied by machines, such as computers and/or processors. While AI has many definitions, AI can be defined as utilizing machines and/or systems to mimic human cognitive ability such as decision-making and/or problem solving. AI has additionally been described as machines and/or systems that are capable of acting rationally such that they can discern their environment and efficiently and effectively take the necessary steps to maximize the opportunity to achieve a desired outcome. Goals of AI can include but are not limited to reasoning, problem-solving, knowledge representation, planning, learning, natural language processing, perception, motion and manipulation, social intelligence, and general intelligence. AI tools used to achieve these goals can include but are not limited to searching and optimization, logic, probabilistic methods, classification, statistical learning methods, artificial neural networks, machine learning, and deep learning.

In some embodiments, machine learning can be used in one or more aspects. The cover crop surrogate model and/or tillage-related surrogate model can include and/or be trained using machine learning. Machine learning is a subset of artificial intelligence. Machine learning aims to learn or train via training data in order to improve performance of a task or set of tasks. A machine learning algorithm and/or model can be developed such that it can be trained using training data to ultimately make predictions and/or decisions. Machine learning can include different approaches such as supervised learning, unsupervised learning, semi-supervised learning, reinforcement learning, and dimensionality reduction as well as other types. Supervised learning models are trained using a training data that includes inputs and the desired output. This type of training data can be referred to as labeled data wherein the output provides a label for the input. The supervised learning model will be able to develop, through optimization or other techniques, a method and/or function that is used to predict the outcome of new inputs. Unsupervised learning models take in data that only includes inputs and engage in finding commonalities in the inputs such as grouping or clustering of aspects of the inputs. Thus, the training data for unsupervised learning does not include labeling and/or classification. Unsupervised learning models can make decisions for new data based on how alike or similar it is to existing data and/or to a desired goal. Examples of machine learning models include but are not limited to artificial neural networks, decision trees, support-vector machines, regression analysis, Bayesian networks, and genetic algorithms. Examples of potential applications of machine learning include but are not limited to image segmentation and classification, ranking, recommendation systems, visual identity tracking, face verification, and speaker verification.

In some embodiments, deep learning can be used in one or more aspects. The cover crop surrogate model and/or tillage-related surrogate model can include and/or be trained using deep learning. Deep learning is a subset of machine learning that utilizes a multi-layered approach. Examples of deep learning architectures include but are not limited to deep neural networks, deep belief networks, deep reinforcement learning, recurrent neural networks, and convolutional neural networks. Examples of fields wherein deep learning can be successfully applied include but are not limited to computer vision, speech recognition, natural language processing, machine translation, bioinformatics, medical image analysis, and climate science. Deep learning models are commonly implemented as multi-layered artificial neural networks wherein each layer can be trained and/or can learn to transform particular aspects of input data into some sort of desired output.

In some embodiments, parallel computing can be used in one or more aspects. Parallel computing (or “parallelism”) refers to the practice of executing multiple computations, calculations, processes, applications, and/or processors simultaneously. Parallel computing can increase the speed and efficiency of performing computational tasks and can increase the power efficiency of computers and/or systems. Examples of forms of parallel computing include but are not limited to bit-level parallelism, instruction-level parallelism, data parallelism, and task parallelism.

In some embodiments, GPU-based computing can be used in one or more aspects. GPU-based computing refers to the practice of using a graphics processing unit (GPU) simultaneously with one or more central processing units (CPUs) and/or GPUs. GPU-based computing allows for a sort of parallel processing between the GPU and the one or more CPUs and/or GPUs such that the GPU can take on some of the computational load to increase speed and efficiency. Additionally, GPUs commonly have a much higher number of processing cores that a traditional CPU, which allows a GPU to be able to process pictures, images, and/or graphical data faster than a traditional CPU.

Therefore, as understood from the present disclosure, the methodology disclosed herein provides for the ability to quickly, effectively, efficiently, and cost-effectively predict and/or quantify the cover crop traits, tillage practices, and/or their outcomes (actual and/or predicted) on a large scale. By utilizing AI, machine learning, and/or deep learning, the disclosed methodology is able to predict and/or quantify outcomes on a large scale based on cover crop traits and/or tillage practices. Additionally, the disclosed methodology allows for an individual, such as a farmer, to quickly and easily in an on-the-fly manner predict, calculate, and/or quantify cover crop traits, tillage practices, and/or their outcomes. Additionally, the disclosed methodology allows for monitoring and verification of agricultural, management, and/or conservation practice adoption.

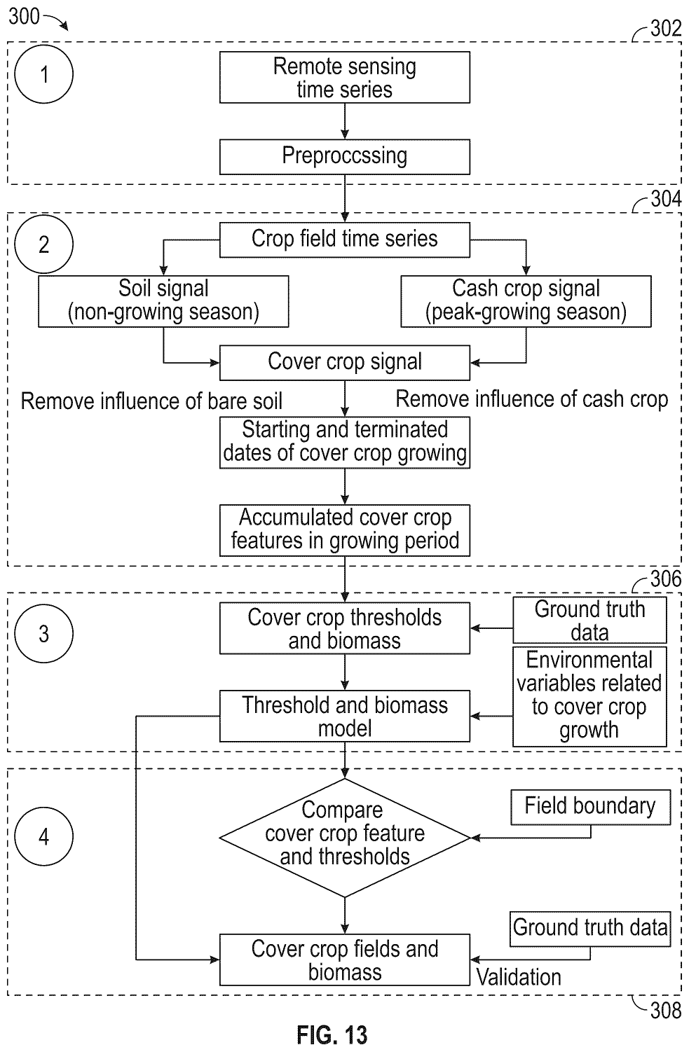

FIG. 13 shows a flow chart of an example of a method 300 for assessing, deriving, and/or detecting cover crop adoption and/or cover crop biomass according to at least one aspect and/or embodiment disclosed herein. The method 300 can include assessing and/or deriving large-scale, long-term, and field-level cover crop adoption and/or cover crop biomass using one or more remote sensing time series. The method 300 is capable of producing highly accurate results in a safe, cost-effective, efficient, and speedy manner.

The first step 302 of the method 300 shown in FIG. 13 can include generating a high-quality remote sensing time series. According to some embodiments, this step 302 can include obtaining low-quality remote sensing data. The low-quality remote sensing data can be obtained via any kind of airborne vehicle(s) including but not limited to drone(s), unmanned aerial vehicle(s) (UAV(s)), airplane(s), helicopter(s), and/or any combination thereof. According to some embodiments, the low-quality remote sensing data can also be obtained via satellite sensing.

Thus, according to some embodiments, the low-quality remote sensing data can be and/or comprise satellite data. The satellite data can be synthesized from one or more satellite data sources. Any spatial and/or temporal gaps in a dataset can be filled and/or inferred using a multi-sensor satellite data fusion model. According to some embodiments, the low-quality remote sensing data can also be obtained via existing data maintained in a database and/or any other type of data cache.

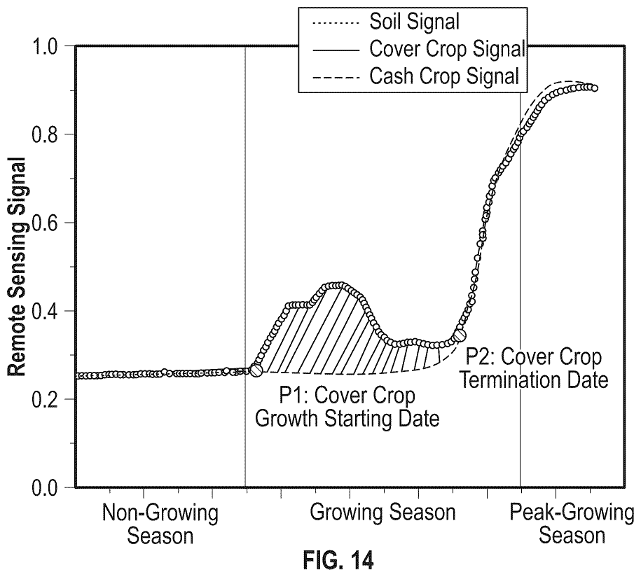

As shown in FIG. 13, the first step 302 can include preprocessing of the low-quality remote sensing data such that the result is a high-quality, high-resolution, high-frequency, and cloud-free remote sensing time series. This preprocessing portion of the first step 302 can be fully automated. Additionally, the preprocessing can include the use of the STAIR (Satellite dAta IntegRation) algorithm and/or system to generate the high-quality, high-frequency, high-resolution, and cloud-free remote sensing time series. For example, this high-quality remote sensing time series can be a 30-mile, and/or 30 meter, daily, and cloud-free remote sensing time series meaning that data is collected in a 30-mile, and/or 30 meter, swath daily and is preprocessed to remove cloud cover and other extraneous data such that the result is the high-quality remote sensing time series. Additionally, this high-quality remote sensing time series outperforms high-frequency but low-resolution remote sensing time series (e.g., MODIS observations) and outperforms low-frequency, high-resolution remote sensing time series (e.g., Landsat observations). The method 300 can use the STAIR system and/or STAIR fusion algorithm to merge Landsat and MODIS data and methodologies to generate the high-quality remote sensing time series. This high-quality remote sensing time series can include daily normalized difference vegetation index (NDVI) data. The high-quality remote sensing time series (also referred to herein as the remote sensing time series) can be represented by the bubbles and/or circular datapoints shown in FIG. 14.

Referring back to FIG. 13, the second step 304 of the method 300 shown in FIG. 13 can include extracting cover crop signals from the high-quality remote sensing time series. This extraction can include dividing the remote sensing time series into soil, cover crop, and main and/or cash crop components as shown in FIG. 14. Remote sensing data at a particular agricultural field or fields can be represented by the following equation:

$$R {S}_{d} = {sRS}_{d} + {mRS}_{d} + {cRS}_{d}$$

The above equation can be referred to throughout the present disclosure as Equation 8. The symbol “RS” can refer to total remote sensing signals of a remote sensing time series, the symbol “sRS” can refer to remote sensing signal(s) related to soil (which can also be referred to as “soil signal(s)” throughout the present disclosure), the symbol “mRS” can represent remote sensing signal(s) related to main and/or cash crop components (which can also be referred to as “main and/or cash crop signal(s)” throughout this disclosure), and the symbol “cRS” can represent remote sensing signal(s) related to cover crops (which can also be referred to as “cover crop signal(s)” throughout the present disclosure) wherein the symbol “d” can represent the d^{th} day of a year.

According to some embodiments, a methodology can be used to determine the soil signal(s) from the remote sensing time series. During the non-growing season, cash crops and cover crops have weak and/or negligible signals. Thus, bare soil contributes to all and/or nearly all of the remote sensing signal(s) during the non-growing season. The remote sensing time series in the non-growing season is useful to detect the value of soil's impacts on the remote sensing data. The soil signal(s) can be represented by the following equation:

sRS_{d}=Function{RS_{d},d∈T₁}

The above equation can be referred to throughout the present disclosure as Equation 9. Symbols present in Equation 9 that are also present in Equation 8 represent the same values as in Equation 8. Additionally, the symbol “T₁” refers to the non-growing season. For example, the minimum value of the remote sensing time series can be used to represent soil signal(s). This can be represented by the following equation:

sRS_{d}=min{RS_{d},d∈T₁}

The above equation can be referred to throughout the present disclosure as Equation 10. Symbols present in Equation 10 that are also present in either of Equations 8 and/or 9 represent the same values as in any of those equations. The minimum value of the remote sensing time series, which can be represented by Equation 10, is also represented by the dotted soil signal line appearing in the non-growing season shown in FIG. 14. The soil signal(s) can be removed and/or extracted from the remote sensing time series.

According to some embodiments, a methodology can be used to determine the main crop and/or cash crop signal(s) from the remote sensing time series. After removing the soil signal(s), the remote sensing time series includes main crop and/or cash crop signal(s) and/or cover crop signal(s). It is customary for cover crops to be terminated before the harvest of cash crops. Therefore, at peak growing season, the signal(s) that are captured via remote sensing are generally only related to the cash crop(s). Based on crop vegetation phenology, the remote sensing time series during peak growing season can be used to fit a cash crop curve to determine main crop and/or cash crop signal(s). The main crop and/or cash crop signal(s) can be represented by the following equation:

mRS_{d}=Function{RS_{d},d∈T₂∈T₂}

The above equation can be referred to throughout the present disclosure as Equation 11. Symbols present in Equation 11 that are also present in any of Equations 8-10 represent the same values as in those equations. Additionally, the symbol “T₂” refers to the peak growing season. For example, a logistic crop growth curve can be used to obtain main crop and/or cash crop signal(s). This can be represented by the following equation:

$${mRS}_{d} = \frac{R {S}_{p} - sRS}{1 + {e}^{( a - b * d )}} , d ∈ {T}_{2}$$

The above equation can be referred to throughout the present disclosure as Equation 12. Symbols present in Equation 12 that are also present in any of Equations 8-11 represent the same values as in those equations. The symbol “RSₚ” refers to the remote sensing signal(s) during peak growing season. The symbol “a” refers to the starting growth day. The symbol “b” refers to the maximum growing rate of the cash crops. The logistic crop growth curve of the remote sensing time series, which can be represented by Equation 12, is also represented by the dashed cash crop signal line appearing in the growing season and peak growing season shown in FIG. 14. Equation 12 can be used to obtain main crop and/or cash crop signal(s) from the remote sensing time series. The main crop and/or cash crop signal(s) can be removed and/or extracted from the remote sensing time series. Additionally, according to some embodiments, RSₚ is equal to the following term which can be referred to throughout the present disclosure as Term 1:

max{RS_{d},d∈T₂}

Symbols present in Term 1 that are also present in any of Equations 8-12 represent the same values as in those equations.

According to some embodiments, a methodology can be used to the determine the cover crop signal(s) from the remote sensing time series. Cover crop signal(s) can then be used to define a feature and/or characteristic of cover crops from the remote sensing time series. After removing the soil signal(s) and main crop and/or cash crop signal(s), the cover crop signal(s) can be extracted from the remote sensing time series. The cover crop signal(s) can be represented by the shaded area between P1 and P2 of FIG. 14. Referring back to Equation 8, Equation 8 can be re-written as shown below. The below equation can be referred to throughout the present disclosure as Equation 13 and symbols present in Equation 13 that are also present in any of Equations 8-12 represent the same values as in those equations:

$${cRS}_{d} = R {S}_{d} - {mRS}_{d} - {sRS}_{d}$$

The cover crop feature and/or characteristic can be defined based on the remote cover crop signal(s) extracted from the remote sensing time series. The cover crop feature and/or characteristic can be represented with the following equation:

cFeature=Function(cRS_{d}),d∈T₃

The above equation can be referred to throughout the present disclosure as Equation 14. Symbols present in Equation 14 that are also present in any of Equations 8-13 represent the same values as in those equations. The symbol “T₃” in Equation 13 refers to the growing season.

According to some embodiments, the accumulated cover crop signal(s) (graphically viewable as the shaded area between P1 and P2 of FIG. 14) can be used as the cover crop feature and or characteristic and can be defined by the following equation:

$$cFeature = {\sum }_{i = P 1}^{P 2} {cRS}_{d}$$

The above equation can be referred to throughout the present disclosure as Equation 15. Symbols present in Equation 15 that are also present in any of Equations 8-14 represent the same values as in those equations. The symbol “P1” can refer to a cover crop growth start date. The symbol “P2” can refer to a cover crop growth terminated date. The cover crop growth start date (P1) can occur on the last day when the remote sensing signal(s) (RS_{d}) is equal to the soil signal(s) (sRS_{d}). The cover crop growth start date (P1) is shown in FIG. 14 as the left-most dot labeled as P1. This left-most dot (P1) represents the last day the soil signal(s) (sRS_{d}), which is represented by the dotted line in FIG. 14, is equal to the remote sensing signal(s) (RS_{d}), which is represented by the bubbles and/or circular datapoints in FIG. 14. The cover crop growth terminated date (P2) can occur on the first day when the remote sensing signal(s) (RS_{d}) is equal to the main crop and/or cash crop signal(s) (mRS_{d}). The cover crop growth terminated date (P2) is shown in FIG. 14 as the right-most dot labeled as P2. This right-most dot (P2) represents the first day the main crop and/or cash crop signal(s) (mRS_{d}), which is represented by the dashed line in FIG. 14, is equal to the remote sensing signal(s) and/or remote sensing time series (RS_{d}), which is represented by the bubbles and/or circular datapoints in FIG. 14. By accumulating the cover crop signal(s) for the entire period from the cover crop growth start date (P1) to the cover crop growth terminated date (P2), the result is the cover crop feature and/or characteristic as shown by the shaded area between P1 and P2 in FIG. 14.

Referring back to FIG. 13, according to some embodiments, the third step 306 of the method 300 can include modeling thresholds, and/or criteria, and/or determining one or more thresholds, and/or criteria, of cover crop features wherein impacts based on environmental factors/conditions and/or ground truth data can be considered. To accomplish this, one or more cover crop models can be developed. The one or more cover crop models can be AI-based, machine learning, and/or deep learning models. The one or more cover crop models can predict cover crop feature thresholds over space and time. These thresholds can also be criteria wherein the criteria can be used in substantially the same manner as the thresholds.

Cover crop growth can vary dynamically across different regions and time periods.

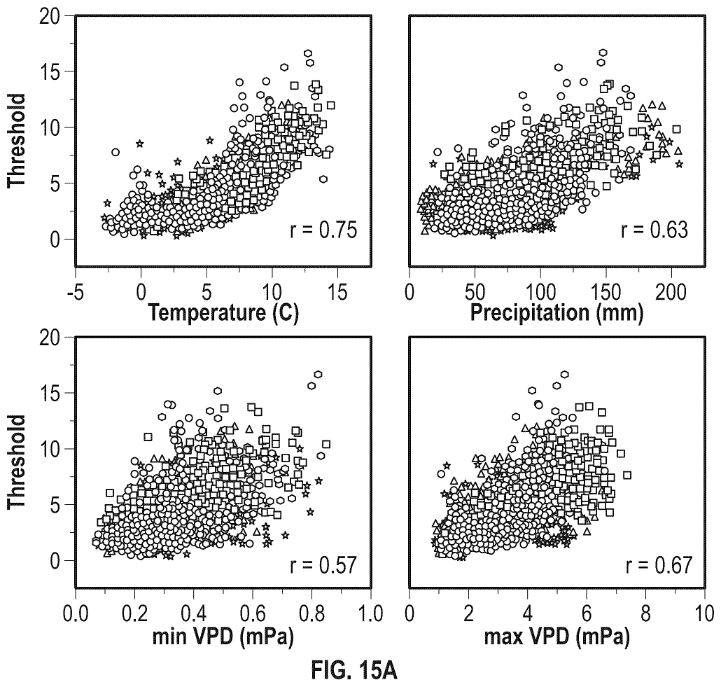

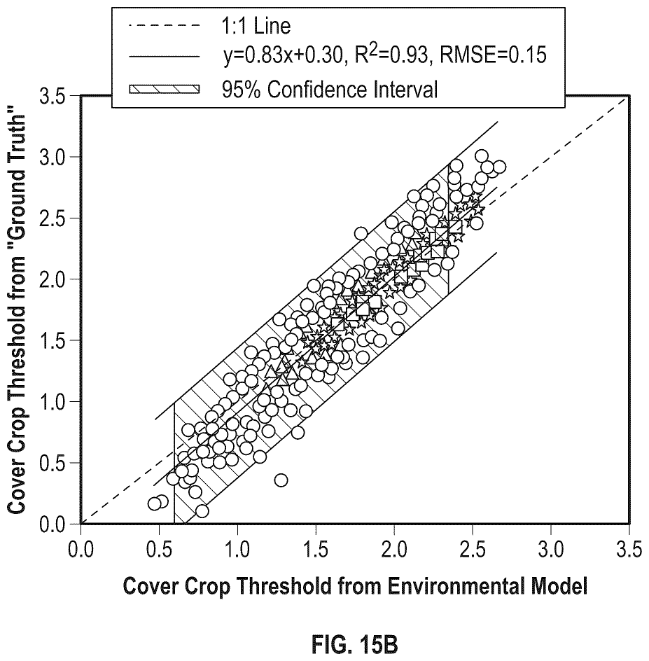

Additionally, cover crop growth can be affected by environmental factors/conditions such as weather, location, soil characteristics, and/or any combination thereof. These factors can include but are not limited to climate variables (e.g., temperature, humidity, precipitation, vapor pressure deficit (VPD)), soil variables (e.g., clay, sand, silt, SOC, soil type), and/or geographical variables (e.g., latitude, longitude), and/or any combination thereof. For example, FIG. 15A shows examples of the variance of cover crop growth and/or derived cover crop thresholds based on differing environmental factors. The one or more cover crop models can be and/or can use a Random Forest model and/or algorithm. Criteria indicating cover crop adoption, growth, and/or features can be defined as a function of environmental factors/conditions wherein the criteria can vary based on the environmental factors/conditions. The criteria being defined as a function of environmental factors/conditions can be reflected in the one or more cover crop models.

The one or more cover crop models can derive cover crop thresholds from ground truth data obtained via the United States Department of Agriculture (USDA) National Agricultural Statistics Service (NASS) Census of Agriculture. Inputs into the one or more cover crop models can include any and/or all of the environmental factors noted above as well as any other suitable environmental factors. Thus, the one or more cover crop models can be trained and/or can learn based on the USDA NASS Census of Agriculture ground truth data and the environmental factors.

FIG. 15B shows an example of a relationship between cover crop threshold values based on ground truth and cover crop threshold values based on a model that considers the impact of environmental factors. The one or more thresholds and/or one or more cover crop models can be represented by the following equation:

cThreshold=Function(environmental variables),d∈T₃

The above equation can be referred to throughout the present disclosure as Equation 16. Symbols present in Equation 16 that are also present in any of Equations 8-15 represent the same values as in those equations. As seen in Equation 16, the approach to predicting and/or determining thresholds takes into account the environmental factors listed above as well as any other suitable environmental factors. By accounting for environmental factors and by incorporating AI, machine learning, and/or deep learning, the one or more models and/or the disclosed method 300 is able to be applied at large-scale and in a long-term capacity with high accuracy and at field-level to determine proper thresholds. Thus, the one or more cover crop models can be used to determine thresholds wherein said thresholds are used to determine if a particular field and/or region has adopted the use of cover crops.

Additionally, according to some embodiments, one or more biomass models can be developed and used to estimate biomass from cover crop features wherein environmental factors are considered. The one or more biomass models can utilize AI, machine learning, and/or deep learning to be developed and/or trained. The one or more biomass models can be and/or can use a Random Forest model and/or algorithm. Estimation of biomass from cover crop features is represented by the following equation:

cBiomass=Function(environmental variables,cFeature),d∈T₃

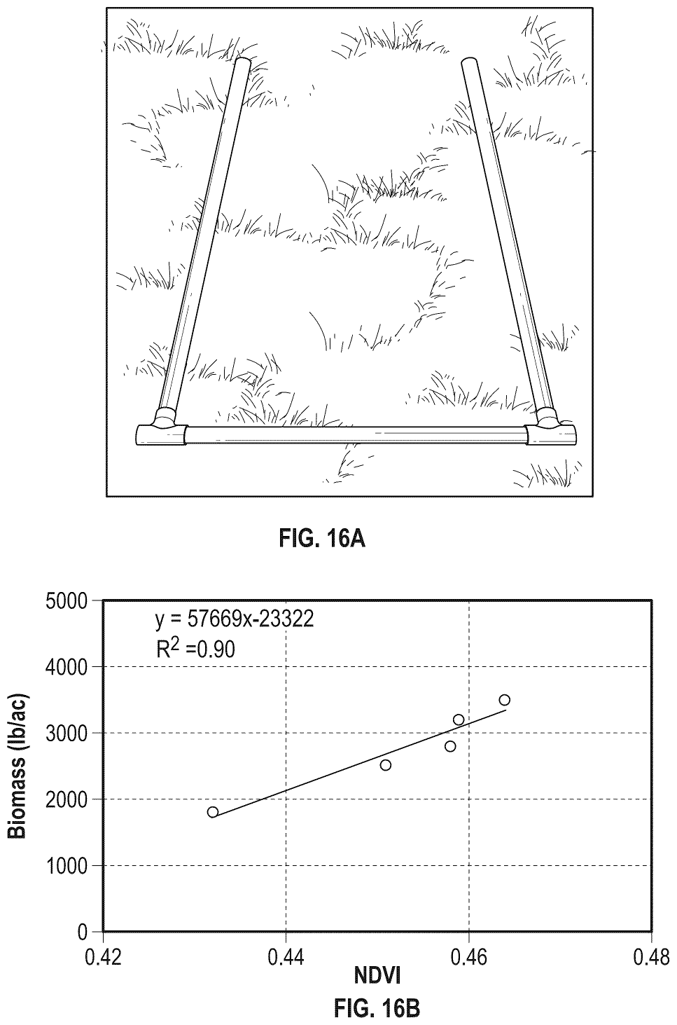

The above equation can be referred to throughout the present disclosure as Equation 17. Symbols present in Equation 17 that are also present in any of Equations 8-16 represent the same values as in those equations. As shown by Equation 17, the approach to estimating biomass of cover crops accounts for both environmental factors and/or crop cover feature(s). Cover crop biomass is highly correlated to cover crop growth, which can be quantified as NDVI as shown in FIG. 16B. This correlation makes it possible to estimate cover crop biomass of cover crops in a particular field and/or region from the remote sensing time series and/or based on cover crop feature(s) and/or environmental factors. FIG. 16A provides an example of a technique used to measure cover crop biomass. FIG. 16B provides a graphical representation showing an example of the correlation between NDVI and cover crop biomass.

The one or more cover crop models and the one or more biomass models can be incorporated into one model and/or can be separate models. Any of the techniques and/or methodologies described herein relate to the one or more cover crop models and/or the one or more biomass models can be applied to the other. For example, any techniques and/or methodologies mentioned for use with the one or more cover crop models can also be used with the one or more biomass models and vice versa.

Referring back to FIG. 13, the fourth step 308 of the method 300 shown in FIG. 13 can include applying the one or more cover crop models and the one or more biomass models (which can include threshold modeling, cover crop feature modeling, and/or cover crop biomass modeling) to derive, estimate, and/or predict cover crop adoption and/or cover crop biomass at large-scale, long-term, and/or field-level. The remote sensing time series can obtain spatial-specific and/or temporal-specific cover crop feature(s). The one or more cover crop models can provide spatial-specific and/or temporal-specific cover crop thresholds. By comparing cover crop feature(s) and cover crop thresholds, cover crop fields (those fields that contain, use, and/or have adopted cover crops) can be derived, estimated, and/or predicted. This relationship is represented by the following equation:

cField=Function(cFeature,cThreshold)

The above equation can be referred to throughout the present disclosure as Equation 18. Symbols present in Equation 18 that are also present in any of Equations 8-17 represent the same values as in those equations. Cover crop feature(s) can be defined as a value and/or characteristic such that it can be compared to cover crop thresholds. Thus, comparison of the cover crop feature(s) and the cover crop thresholds can determine whether a particular agricultural field has adopted the use of cover crop or not. In this way, the cover crop feature(s) can represent the difference of a remote sensing time series with cover crop and one without cover crop. As an example, the remote sensing time series can provide cover crop features for each captured pixel of remote sensing data obtained via airborne vehicle(s) and/or satellite(s) for a particular field. The one or more cover crop models can provide thresholds for cover crop determination. The cover crop feature of each pixel can be compared to the thresholds. If 40% or more of the pixels are predicted as cover crops, the targeted field can be considered, or predicted to be, a cover crop field. While 40% of pixels is used as an example, that percentage can vary. For instance, any suitable percentage range could be used including but not limited to any range falling between 1-100%. Further, the biomass of a cover crop field can be derived, estimated, and/or predicted using the one or more biomass models. Maps can be generated at pixel-level, field-level, county-level, state-level, region-level, nation-level, and/or at any suitable level showing cover crop fields and/or biomass information related to cover crop fields.

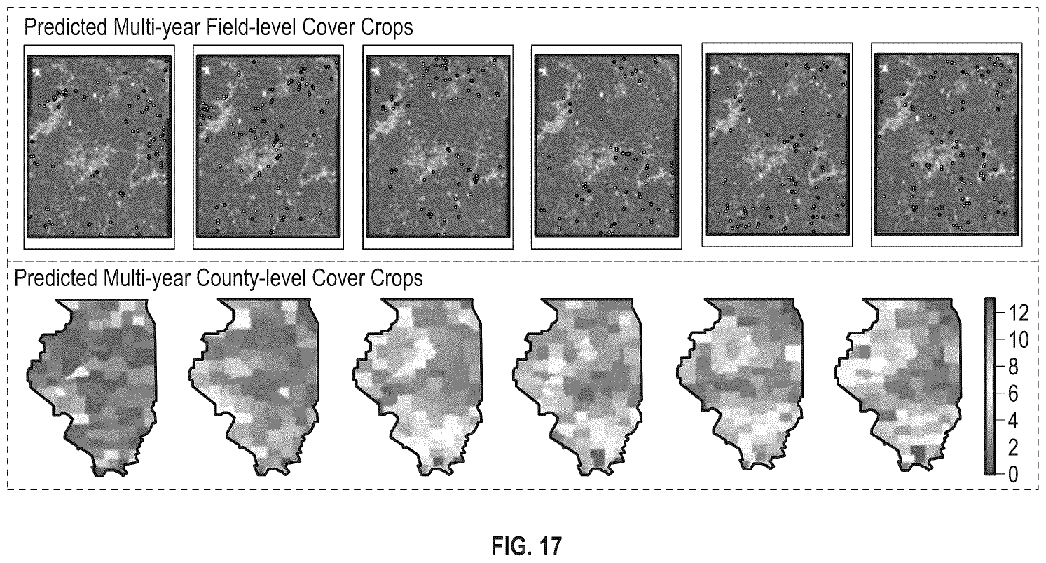

The fourth step 308 can also include evaluating and/or validating derived, estimated, and/or predicted cover crop fields. Evaluating and/or validating can include any aspects mentioned in the previous paragraph related to applying the one or more cover crop models and/or the one or more biomass models. This validation can be comprehensive. Pixel-level, field-level, county-level, state-level, nation-level, and/or any other suitable level of cover crop data can be used to evaluate and/or validate the accuracy of the derived, predicted, and/or estimated cover crop fields. Ground truth data can be obtained via farmer reports and/or visually interpreting cover crop fields via image(s) and/or video(s) captured via airborne vehicles and/or satellites. This ground truth data can be compared to the derived, estimated, and/or predicted cover crop fields and/or biomass information in order to evaluate and/or validate the derived, estimated, and/or predicted cover crop fields and/or biomass information. The one or more cover crop models and/or the one or more biomass models can continue to be trained based on the evaluation and/or validation. The derived, estimated, and/or predicted cover crop fields and/or biomass information can be evaluated and/or validated at the county, state, region, nation, and/or any other suitable level by comparing the derived, estimated, and/or predicted cover crop fields and/or biomass information with USDA NASS statistics such as USDA NASS Census of Agriculture. FIG. 17 provides an example of mapping of derived, estimated, and/or predicted cover crop fields at the field-level and also at the county-level.

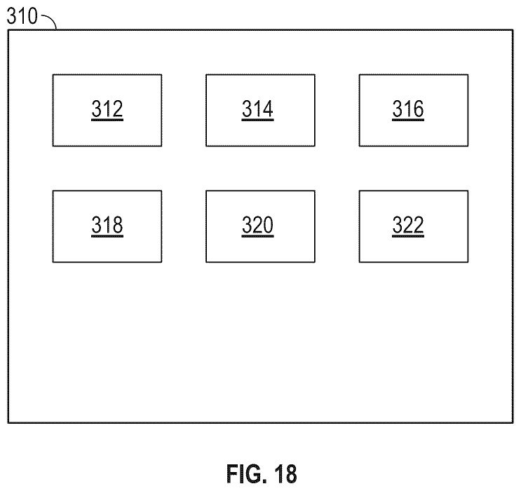

Various embodiments of the disclosure described herein include a cyberinfrastructure that can facilitate the modeling, calculations, and/or visualizations disclosed herein via a software application. FIG. 18 shows an example of a cyberinfrastructure 310 according to some aspects and/or some embodiments. The cyberinfrastructure 310 may comprise a database 312, at least one processing system 314, a visualization portal 316, a memory unit 318, and/or a tangible computer-readable storage medium 320. The cyberinfrastructure 310 may include a set of instructions 322 that, when executed, may cause the cyberinfrastructure 310 to perform any of the methods and/or methodologies discussed above.

According to some embodiments, the cyberinfrastructure 310 can also include an intelligent control. The intelligent control can control and/or manipulate data stored in the database 312 such that the at least one processing system 314 can operate quickly, efficiently, and/or effectively. Additionally, the intelligent control can perform and/or execute the instructions 322 to cause the cyberinfrastructure 310 to perform any of the methods and/or methodologies discussed above. Examples of such an intelligent control may be processing units alone or other subcomponents of computing devices. The intelligent control can also include other components and can be implemented partially or entirely on a semiconductor (e.g., a field-programmable gate array (“FPGA”)) chip, such as a chip developed through a register transfer level (“RTL”) design process.

The database 312 may be a comprehensive computer database. The database 312 may be used to store and/or archive all observations and/or data or information related to, obtained via, and/or generated via the remote sensing time series, the one or more models (including the one or more cover crop models and/or the one or more biomass models), environmental factors, ground truth data, USDA data, biomass data, and/or any other suitable information and/or data.

The database 312 can include any type of data storage cache and/or server and can refer to any kind of memory components, any kind of entities embodied in a memory component, and/or any kind of components comprising memory. It is appreciated that the database 312 can include volatile memory and/or nonvolatile memory. The database 312 can be a structured set of data typically held in a computer. The database 312, as well as data and information contained therein, need not reside in a single physical or electronic location. For example, the database 312 may reside, at least in part, on a local storage device, in an external hard drive, on a database server connected to a network, on a cloud-based storage system, in a distributed ledger (such as those commonly used with blockchain technology), or the like.

The database 312 can include the use of read-only memory (“ROM”, an example of non-volatile memory, meaning it does not lose data when it is not connected to a power source) or random access memory (“RAM”, an example of volatile memory, meaning it will lose its data when not connected to a power source). Nonlimiting examples of volatile memory include static RAM (“SRAM”), dynamic RAM (“DRAM”), synchronous DRAM (“SDRAM”), etc. Examples of non-volatile memory include electrically erasable programmable read only memory (“EEPROM”), flash memory, hard disks, SD cards, etc. In some embodiments, the processing unit, such as a processor, a microprocessor, or a microcontroller, is connected to the memory and executes software instructions that are capable of being stored in a RAM of the memory (e.g., during execution), a ROM of the memory (e.g., on a generally permanent basis), or another non-transitory computer readable medium such as another memory or a disc.

The at least one processing system 314 can include a number of processing units ranging from zero to N where N is any number greater than zero. The at least one processing system 314 can include any number of processing units such as one or more CPUs and/or GPUs and can utilize parallel computing and/or GPU-based computing as described above. With proper configurations, the cyberinfrastructure 310 can operate as a one-stop solution to perform the entire process of modeling, calculation(s), mapping, and/or visualization(s). By utilizing the architecture and/or computing techniques described herein, the cyberinfrastructure 310 allows for speedy, effective, and/or efficient data processing and computation.

A processing unit, also called a processor, is an electronic circuit which performs operations on some external data source, usually memory or some other data stream. Non-limiting examples of processors include a microprocessor, a microcontroller, an arithmetic logic unit (“ALU”), and most notably, a graphics processing unit (GPU), a central processing unit (“CPU”). A CPU, also called a central processor or main processor, is the electronic circuitry within a computer that carries out the instructions of a computer program by performing the basic arithmetic, logic, controlling, and input/output (“I/O”) operations specified by the instructions. Processing units are common in tablets, telephones, handheld devices, laptops, user displays, smart devices (TV, speaker, watch, etc.), and other computing devices.

The visualization portal 316 allows a user to enter inputs and/or can communicate inputs and/or outputs to a user. According to some embodiments, a user can enter inputs which can include but are not limited to identifying information of the user or the user's organization and/or company, location and/or name of an agricultural field, observational data with and/or without corresponding GPS information, USDA data with and/or without corresponding GPS information, data related to environmental factors with and/or without corresponding GPS information, ground truth data with and/or without corresponding GPS information, farmer reports with and/or without corresponding GPS information, airborne and/or satellite imaging and/or video with and/or without corresponding GPS information, remote sensing data corresponding to one or more agricultural fields with and/or without corresponding GPS information, information related to cover crop feature(s) with and/or without corresponding GPS information, information related to the model(s) and/or thresholds with and/or without corresponding GPS information, and/or information related to cover crop adoption and/or cover crop biomass with and/or without corresponding GPS information. According to other embodiments this information and/or data can be input to the visualization portal 316 and/or other aspects of the cyberinfrastructure 310 automatically upon sensing, acquiring, and/or obtaining the data.

According to some aspects and/or embodiments, the visualization portal 316 can be physically manifested, be viewable, and/or be accessible in any suitable manner including as a smart device including but not limited to a mobile phone, tablet, computer, and the like. The visualization portal 316, physically manifested as a smart device, can include a user interface wherein a user can enter inputs, such as captured image(s) and/or video(s) of an agricultural field, and/or the visualization portal 316 can display and/or communicate outputs including but not limited to intermediate and/or final results as well as cover crop adoption information, cover crop field information, cover crop biomass information, and/or mapping data related to cover crop adoption, cover crop field information, and/or cover crop biomass information. The outputs can include identification of fields that have adopted cover crops and/or identification of cover crop biomass information. According to some embodiments, the visualization portal 316 can be implemented as a computer program and/or as a software program wherein it can be accessible by any means mentioned in this paragraph and/or by any other suitable means.

In accordance with various aspects of the embodiments of the disclosure, aspects of the methods described herein are intended for operation as software programs running on a computer processor and/or processing unit. Furthermore, software implementations can include, but are not limited to, distributed processing and/or component/object distributed processing, parallel processing, and/or virtual machine processing can also be constructed to implement aspects of the methods described herein.

A user interface is how the user interacts with a machine. The user interface can be a digital interface, a command-line interface, a graphical user interface (“GUI”), oral interface, virtual reality interface, or any other way a user can interact with a machine (user-machine interface). For example, the user interface (“UI”) can include a combination of digital and analog input and/or output devices or any other type of UI input/output device required to achieve a desired level of control and monitoring for a device. Nonlimiting examples of input and/or output devices include computer mice, keyboards, touchscreens, knobs, dials, switches, buttons, speakers, microphones, printers, LIDAR, RADAR, etc. Input(s) received by the UI can then be sent to a microcontroller and/or any type of controller to control operational aspects of a device and/or method such as the disclosed methods.

The user interface of the visualization portal 316 can include any of the above-described input/output devices and/or methods to input data and/or information into the visualization portal and/or any other aspect of the cyberinfrastructure 310. For example, methods of inputting data and/or information can include entering the data and/or information via touchscreen, via keyboard typing, via click of a computer mouse, via voice command, uploading, copying, emailing, direct link (wired and/or wireless), and/or any other suitable method disclosed herein and/or known in the prior art. Furthermore, the user interface of the visualization portal 316 can include any of the above-described input/output devices and/or methods to communicate outputs, data, and/or information such as intermediate and/or final results to the user. For example, methods of communicating output to a user can include displaying via a screen, producing audio communication, printing, and/or any other suitable method disclosed herein and/or known in the prior art.

Output data and/or information could be communicated in any form such as but not limited to text, numerical, graphical, mapping, illustrative, audio, and/or any other suitable form disclosed herein and/or known in the prior art.

The user interface can include a display, which can act as an input and/or output device. More particularly, the display can be a liquid crystal display (“LCD”), a light-emitting diode (“LED”) display, an organic LED (“OLED”) display, an electroluminescent display (“ELD”), a surface-conduction electron emitter display (“SED”), a field-emission display (“FED”), a thin-film transistor (“TFT”) LCD, a bistable cholesteric reflective display (i.e., e-paper), etc. The user interface also can be configured with a microcontroller to display conditions or data associated with the main device in real-time or substantially real-time.

According to some embodiments, the visualization portal 316 can be an online web-based portal. According to some embodiments, the portal can function as a mobile website capable of being accessed via a mobile device such as a smartphone, tablet, smart device, and the like. According to other embodiments, the visualization portal 316 can function as a traditional and/or desktop website capable of being accessed via a desktop computer, laptop computer, and the like.

The visualization portal 316 can include cloud computing. Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. A cloud computing environment is service oriented with a focus on statelessness, low coupling, modularity, and semantic interoperability. At the heart of cloud computing is an infrastructure comprising a network of interconnected nodes.

Some common characteristics of cloud computing include its on-demand self-service nature, its broad network access, resource pooling, rapid elasticity, and the ability to measure service. For example, the on-demand self-service nature of cloud computing allows a cloud consumer to unilaterally provision computing capabilities, such as server time and network storage, as needed automatically without requiring human interaction with the service's provider.

The broad network access allows for capabilities to be available over a network and accessed through standard mechanisms that promote use by heterogeneous thin or thick client platforms (e.g., mobile phones, laptops, and PDAs).

Resource pooling allows the provider's computing resources to be pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity allows for capabilities to be rapidly and elastically provisioned, in some cases automatically, to quickly scale out and rapidly released to quickly scale in. To the consumer, the capabilities available for provisioning often appear to be unlimited and can be purchased in any quantity at any time.

The measured service nature of cloud computing systems allows cloud systems to automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Additionally, according to embodiments wherein the visualization portal and/or other aspects of the cyberinfrastructure include cloud computing, those aspects may utilize cloud computing in any suitable model such as but not limited to Software as a Service (SaaS), Platform as a Service (PaaS), and/or Infrastructure as a Service (IaaS).

When utilizing the SaaS model, the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

When utilizing the PaaS model, the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

When utilizing the IaaS model, the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Additionally, according to embodiments wherein the visualization portal 316 and/or other aspects of the cyberinfrastructure 310 include cloud computing, any suitable deployment model may be used including but not limited to a private cloud, a community cloud, a public cloud, and/or a hybrid cloud.

For embodiments using a private cloud, the cloud infrastructure is operated solely for an organization. It may be managed by the organization or a third party and may exist on-premises or off-premises.

For embodiments using a community cloud, the cloud infrastructure is shared by several organizations and supports a specific community that has shared concerns (e.g., mission, security requirements, policy, and compliance considerations). It may be managed by the organizations or a third party and may exist on-premises or off-premises.

For embodiments using a public cloud, the cloud infrastructure is made available to the general public or a large industry group and is owned by an organization selling cloud services.

For embodiments using a hybrid cloud, the cloud infrastructure is a composition of two or more clouds (private, community, or public) that remain unique entities but are bound together by standardized or proprietary technology that enables data and application portability (e.g., cloud bursting for load balancing between clouds).

Additionally, according to other embodiments, the visualization portal can be a mobile application and/or a desktop application that is installed and/or downloaded on a computing device such as a smartphone, desktop computer, laptop computer, smart device, and the like.

The cyberinfrastructure 310 may also include a memory unit 318. According to some embodiments, the memory unit 318 can store the instructions 322 that, when executed, may cause the cyberinfrastructure 310 to perform any of the methods and/or methodologies discussed above. The instructions 322 can also be stored, completely or at least partially, within the tangible computer-readable medium 320 and/or any other aspect of the cyberinfrastructure 310. The processing system 314 and/or other aspects of the cyberinfrastructure 310 may be operationally connected to the memory unit 318 and/or to the tangible computer-readable storage medium 320 so that the processing system 314 can execute and/or perform the instructions 322.

The memory unit 318 includes, in some embodiments, a program storage area and/or data storage area. The memory unit 318 can comprise read-only memory (“ROM”, an example of non-volatile memory, meaning it does not lose data when it is not connected to a power source) or random access memory (“RAM”, an example of volatile memory, meaning it will lose its data when not connected to a power source). Nonlimiting examples of volatile memory include static RAM (“SRAM”), dynamic RAM (“DRAM”), synchronous DRAM (“SDRAM”), etc. Examples of non-volatile memory include electrically erasable programmable read only memory (“EEPROM”), flash memory, hard disks, SD cards, etc. In some embodiments, a processing unit, such as a processor, a microprocessor, or a microcontroller, is connected to the memory unit 318 and executes software instructions that are capable of being stored in a RAM of the memory unit 318 (e.g., during execution), a ROM of the memory unit 318 (e.g., on a generally permanent basis), or another non-transitory computer readable medium such as another memory or a disc.

The cyberinfrastructure 310 may also include a tangible computer-readable storage medium 320. According to some embodiments, the tangible computer-readable storage medium 320 can store the instructions 322 that, when executed, may cause the cyberinfrastructure 310 to perform any of the methods and/or methodologies discussed above. The instructions 322 can also be stored, completely or at least partially, within the memory unit 318 and/or any other aspect of the cyberinfrastructure 310. The processing system 314 and/or other aspects of the cyberinfrastructure 310 may be operationally connected to the tangible computer-readable storage medium 320 so that the processing system 314 can execute and/or perform the instructions 322. The memory unit 318 and/or the processing system 314 can also constitute tangible computer-readable storage media.

In communications and computing, a computer readable medium is a medium capable of storing data in a format readable by a mechanical device. The term “non-transitory” is used herein to refer to computer readable media (“CRM”) that store data for short periods or in the presence of power such as a memory device.

One or more embodiments described herein can be implemented using programmatic modules, engines, or components. A programmatic module, engine, or component can include a program, a sub-routine, a portion of a program, or a software component or a hardware component capable of performing one or more stated tasks or functions. A module or component can exist on a hardware component independently of other modules or components. Alternatively, a module or component can be a shared element or process of other modules, programs, or machines.

Generally, a non-transitory computer readable medium operates under control of an operating system stored in memory. The non-transitory computer readable medium implements a compiler which allows a software application written in a programming language such as COBOL, C++, FORTRAN, or any other known programming language to be translated into code readable by the central processing unit. After completion, the central processing unit accesses and manipulates data stored in the memory of the non-transitory computer readable medium using the relationships and logic dictated by the software application and generated using a compiler.

In at least one embodiment, the software application and the compiler are tangibly embodied in the computer-readable medium 320. When the instructions are read and executed by the non-transitory computer readable medium, the non-transitory computer readable medium performs the steps necessary to implement and/or use the present disclosure. A software application, operating instructions, and/or firmware (semi-permanent software programmed into read-only memory) may also be tangibly embodied in the memory unit 318 and/or data communication devices, thereby making the software application a product or article of manufacture according to the present disclosure.

Dedicated hardware implementations including, but not limited to, application specific integrated circuits, programmable logic arrays, and/or other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

While the tangible computer-readable storage medium 320 is shown in the embodiment of FIG. 18 to be a single medium, the term “tangible computer-readable storage medium” should be taken to include a single medium or multiple media (e.g., a centralized or distributed database, and/or associated caches and servers) that can store the one or more sets of instructions 322. The term “tangible computer-readable storage medium” shall also be taken to include any non-transitory medium that is capable of storing or encoding a set of instructions for execution by the cyberinfrastructure 310 and that cause the cyberinfrastructure 310 to perform any one or more of the methods of the present disclosure.

In some embodiments, artificial intelligence can be used in one or more aspects. The one or more cover crop models and/or the one or more biomass models can include and/or can be trained using artificial intelligence (AI). AI is intelligence embodied by machines, such as computers and/or processors. While AI has many definitions, AI can be defined as utilizing machines and/or systems to mimic human cognitive ability such as decision-making and/or problem solving. AI has additionally been described as machines and/or systems that are capable of acting rationally such that they can discern their environment and efficiently and effectively take the necessary steps to maximize the opportunity to achieve a desired outcome. Goals of AI can include but are not limited to reasoning, problem-solving, knowledge representation, planning, learning, natural language processing, perception, motion and manipulation, social intelligence, and general intelligence. AI tools used to achieve these goals can include but are not limited to searching and optimization, logic, probabilistic methods, classification, statistical learning methods, artificial neural networks, machine learning, and deep learning.

In some embodiments, machine learning can be used in one or more aspects. The one or more cover crop models and/or the one or more biomass models can include and/or can be trained using machine learning. Machine learning is a subset of artificial intelligence. Machine learning aims to learn or train via training data in order to improve performance of a task or set of tasks. A machine learning algorithm and/or model can be developed such that it can be trained using training data to ultimately make predictions and/or decisions. Machine learning can include different approaches such as supervised learning, unsupervised learning, semi-supervised learning, reinforcement learning, and dimensionality reduction as well as other types. Supervised learning models are trained using a training data that includes inputs and the desired output. This type of training data can be referred to as labeled data wherein the output provides a label for the input. The supervised learning model will be able to develop, through optimization or other techniques, a method and/or function that is used to predict the outcome of new inputs. Unsupervised learning models take in data that only includes inputs and engage in finding commonalities in the inputs such as grouping or clustering of aspects of the inputs. Thus, the training data for unsupervised learning does not include labeling and/or classification. Unsupervised learning models can make decisions for new data based on how alike or similar it is to existing data and/or to a desired goal. Examples of machine learning models include but are not limited to artificial neural networks, decision trees, support-vector machines, regression analysis, Bayesian networks, and genetic algorithms. Examples of potential applications of machine learning include but are not limited to image segmentation and classification, ranking, recommendation systems, visual identity tracking, face verification, and speaker verification.

In some embodiments, deep learning can be used in one or more aspects. The one or more cover crop models and/or the one or more biomass models can include and/or can be trained using deep learning. Deep learning is a subset of machine learning that utilizes a multi-layered approach. Examples of deep learning architectures include but are not limited to deep neural networks, deep belief networks, deep reinforcement learning, recurrent neural networks, and convolutional neural networks. Examples of fields wherein deep learning can be successfully applied include but are not limited to computer vision, speech recognition, natural language processing, machine translation, bioinformatics, medical image analysis, and climate science. Deep learning models are commonly implemented as multi-layered artificial neural networks wherein each layer can be trained and/or can learn to transform particular aspects of input data into some sort of desired output.

In some embodiments, parallel computing can be used in one or more aspects. Parallel computing (or “parallelism”) refers to the practice of executing multiple computations, calculations, processes, applications, and/or processors simultaneously. Parallel computing can increase the speed and efficiency of performing computational tasks and can increase the power efficiency of computers and/or systems. Examples of forms of parallel computing include but are not limited to bit-level parallelism, instruction-level parallelism, data parallelism, and task parallelism.

In some embodiments, GPU-based computing can be used in one or more aspects. GPU-based computing refers to the practice of using a graphics processing unit (GPU) simultaneously with one or more central processing units (CPUs) and/or GPUs. GPU-based computing allows for a sort of parallel processing between the GPU and the one or more CPUs and/or GPUs such that the GPU can take on some of the computational load to increase speed and efficiency. Additionally, GPUs commonly have a much higher number of processing cores that a traditional CPU, which allows a GPU to be able to process pictures, images, and/or graphical data faster than a traditional CPU.

Therefore, as understood from the present disclosure, the methodology described herein is used to accurately derive, estimate, and/or predict large-scale, long-term, and field-level cover crop adoption and biomass information using a remote sensing time series. Deriving, estimating, and/or predicting cover crop adoption based on this type of space and time series is previously unprecedented. By using AI, machine learning, and/or deep learning, the disclosed methodology is able to perform accurately, effectively, efficiently, cost-effectively, and quickly. Cover crops vary dynamically at large spatial and temporal scales and also vary based on environmental factors. Therefore, by utilizing the remote sensing time series and by accounting for environmental factors when training the one or more cover crop models and/or the one or more biomass models using AI, machine learning, and/or deep learning, the disclosed methodology is able to be accurately applied on a large scale, over a long period of time, and at field-level. Furthermore, one of the difficulties of assessing cover crop adoption and/or cover crop biomass is distinguishing between differing signals within a remote sensing time series such as soil signals, main/cash crop signals, and cover crop signals. By being able to extract each differing type of signal from the remote sensing time series, the disclosed methodology allows for accurate assessment of cover crop adoption and/or cover crop biomass.

From the foregoing, it can be seen that the invention accomplishes at least all of the stated objectives.

It should be appreciated that one or more alternatives, variations, additions, subtractions, or other changes, which may be obvious to those skilled in the art, to be considered a part of the present disclosure.

What is claimed is:

1. A method to calculate, quantify, and/or visualize one or more outcomes and/or predicted outcomes associated with an agricultural field, rangeland, or pastureland, comprising:
capturing field imagery using a mobile device;
processing the field imagery to produce processed field imagery; and
calculating, quantifying, and/or visualizing one or more outcomes and/or predicted outcomes based on the processed field imagery.

2. The method of claim 1, wherein the outcomes and/or predicted outcomes include sustainability metrics.

3. The method of claim 2, wherein the sustainability metrics comprise information related to greenhouse gas emissions, soil carbon sequestration, water use, and/or resource use efficiency.

4. The method of claim 1, wherein the outcomes and/or predicted outcomes include economic metrics.

5. The method of claim 4, wherein the economic metrics comprise projected revenue from crop(s) and/or livestock.

6. The method of claim 4, wherein the economic metrics comprise projected revenue or compensation from ecosystem service market(s), such as carbon credit market(s).

7. The method of claim 4, wherein the economic metrics comprise a market-driven premium, such as gains from sustainable labeling.

8. The method of claim 1, wherein the calculating, quantifying, and/or visualizing one or more outcomes and/or predicted outcomes comprises using a process-based model.

9. The method of claim 1, wherein the calculating, quantifying, and/or visualizing one or more outcomes and/or predicted outcomes comprises using a statistical or machine learning model.

10. The method of claim 1, wherein the calculating, quantifying, and/or visualizing one or more outcomes and/or predicted outcomes is based on a model that has been optimized based on field image data.

11. The method of claim 1, wherein the mobile device used to capture the field imagery comprises a handheld camera, a camera included as part of a smart device such as a smartphone camera, an Internet-of-Things (IoT) camera, an optical sensor, a sport camera, and/or a camera housed within and/or attached to a vehicle.

12. A device for calculating, quantifying, and/or visualizing one or more soil, crop, and/or agroecosystem outcomes and/or predicted outcomes, comprising:
a processing system;
a memory unit and/or non-transitory computer-readable medium that stores executable instructions that, when executed by the processing system, perform operations, the operations comprising:
obtaining field imagery captured using a mobile device;
processing the field imagery to produce processed field imagery; and
calculating, quantifying, and/or visualizing one or more outcomes and/or predicted outcomes based on the processed field imagery.

13. The device of claim 12, wherein the outcomes and/or predicted outcomes include sustainability metrics.

14. The device of claim 13, wherein the sustainability metrics comprise information related to greenhouse gas emissions, soil carbon sequestration, water use, and/or resource use efficiency.

15. The device of claim 12, wherein the outcomes and/or predicted outcomes include economic metrics.

16. The device of claim 15, wherein the economic metrics comprise projected revenue from crop(s) and/or livestock.

17. The device of claim 15, wherein the economic metrics comprise projected revenue or compensation from ecosystem service market(s), such as carbon credit market(s).

18. The device of claim 15, wherein the economic metrics comprise a market-driven premium, such as gains from sustainable labeling.

19. The device of claim 12, wherein the calculating, quantifying, and/or visualizing one or more outcomes and/or predicted outcomes comprises using a process-based model.

20. The device of claim 12, wherein the calculating, quantifying, and/or visualizing one or more outcomes and/or predicted outcomes comprises using a statistical or machine learning model.

21. The device of claim 12, wherein the calculating, quantifying, and/or visualizing one or more outcomes and/or predicted outcomes is based on a model that has been optimized based on field image data.

22. The device of claim 12, wherein the mobile device used to capture the field imagery comprises a handheld camera, a camera included as part of a smart device such as a smartphone camera, an Internet-of-Things (IoT) camera, an optical sensor, a sport camera, and/or a camera housed within and/or attached to a vehicle.

23. A non-transitory computer readable medium comprising executable instructions that, when executed, perform operations, the operations comprising:
obtaining field imagery captured using a mobile device;
processing the field imagery to produce processed field imagery; and
calculating, quantifying, and/or visualizing one or more outcomes and/or predicted outcomes based on the processed field imagery.

24. The device of claim 23, wherein the outcomes and/or predicted outcomes include sustainability metrics.

25. The device of claim 24, wherein the sustainability metrics comprise information related to greenhouse gas emissions, soil carbon sequestration, water use, and/or resource use efficiency.

26. The device of claim 23, wherein the outcomes and/or predicted outcomes include economic metrics.

27. The device of claim 26, wherein the economic metrics comprise projected revenue from crop(s) and/or livestock.

28. The device of claim 26, wherein the economic metrics comprise projected revenue or compensation from ecosystem service market(s), such as carbon credit market(s).

29. The device of claim 26, wherein the economic metrics comprise a market-driven premium, such as gains from sustainable labeling.

30. The device of claim 23, wherein the calculating, quantifying, and/or visualizing one or more outcomes and/or predicted outcomes comprises using a process-based model.

31. The device of claim 23, wherein the calculating, quantifying, and/or visualizing one or more outcomes and/or predicted outcomes comprises using a statistical or machine learning model.

32. The device of claim 23, wherein the calculating, quantifying, and/or visualizing one or more outcomes and/or predicted outcomes is based on a model that has been optimized based on field image data.

33. The device of claim 23, wherein the mobile device used to capture the field imagery comprises a handheld camera, a camera included as part of a smart device such as a smartphone camera, an Internet-of-Things (IoT) camera, an optical sensor, a sport camera, and/or a camera housed within and/or attached to a vehicle.
